(19) United States
(12) Patent Application Publication
(10) Pub. No.: US 2018/0041161 A1
(43) Pub. Date: Feb. 8, 2018

(54) DIRECT ANCHORING SOLAR MODULE SYSTEM AND INSTALLATION METHOD

(71) Applicant: Smash Solar, Inc., Richmond, CA (US)

(72) Inventors: Neil GOLDBERG, Berkeley, CA (US); Troy Douglas TYLER, El Cerrito, CA (US); David SCHULZ, Berkeley, CA (US); Bron DAVIS, Vacaville, CA (US); Eugene KIM, Orinda, CA (US); John WOLFE, Berkeley, CA (US); Miguel Martinho Lopes PRACA, Kentfield, CA (US)

(21) Appl. No.: 15/555,944

(22) PCT Filed: Mar. 2, 2016
(86) PCT No.: PCT/US16/00019

§ 371 Date: Sep. 5, 2017

Related U.S. Application Data
(63) Continuation-in-part of application No. 14/521,245, filed on Oct. 22, 2014.
Application No. 14/521,245 is a continuation-in-part of application No. 14/054,807, filed on Oct. 15, 2013.
(60) Provisional application No. 62/127,287, filed on Mar. 2, 2015.
(60) Provisional application No. 62/152,938, filed on Apr. 26, 2015.
(60) Provisional application No. 62/197,564, filed on Jul. 27, 2015.
(60) Provisional application No. 62/203,304, filed on Aug. 10, 2015.
(60) Provisional application No. 62/203,902, filed on Aug. 11, 2015.
(60) Provisional application No. 62/209,860, filed on Aug. 25, 2015.
(60) Provisional application No. 62/260,321, filed on Nov. 26, 2015.
(60) Provisional application No. 61/712,878, filed on Oct. 12, 2012.

(51) Int. Cl. H02S 40/36; F24J 2/52; H02S 20/23

(52) U.S. Cl. CPC H02S 40/36; H02S 20/23; F24J 2/5205; F24J 2/5211; F24J 2/5245; F24J 2/5254; F24J 2/5256; F24J 2/5258

(57) ABSTRACT

A mounting system and techniques for securing solar panels to a fixed structure including a plurality of mounting brackets and tracks and a plurality of mounting feet that connect to the tracks and anchor to the fixed structure. Each mounting bracket has a means to interconnect and interlock with the mounting brackets on adjacent solar modules. In addition, the mounting feet have a quick release mechanism to connect and disconnect from the track. The mounting feet are appropriately selected for the given fixed structure or roof type. The solar module system, in accordance with certain embodiments, has toggle anchors to reliably mount into sheathing plywood or OSB material. The solar module system, in accordance with certain embodiments, also describes an electrical conduction and coupling system for solar modules that integrates electrical coupling with mechanical coupling at the point of mechanical attachment.

### PRIORITY AND RELATED APPLICATIONS

This application claims priority to U.S. provisional patent application Ser. Nos. 62/260,321, filed Nov. 26, 2015, 62/209,860, filed Aug. 25, 2015, 62/203,902, filed Aug. 11, 2015, 62/203,304, filed Aug. 10, 2015, 62/197,564, filed Jul. 27, 2015, 62/152,938, filed Apr. 26, 2015, and 62/127,287, filed Mar. 2, 2015.

This application is also a continuation in part (CIP) which claims priority to U.S. patent application Ser. No. 14/521,245, filed Oct. 22, 2014, which is a continuation in part (CIP) which claims priority to U.S. patent application Ser. No. 14/054,807, filed Oct. 15, 2013, which claims priority to U.S. provisional patent application No. 61/712,878, filed Oct. 12, 2012. Each of the above priority and related applications is hereby incorporated by reference.

### STATEMENT REGARDING FEDERALLY SPONSORED RESEARCH OR DEVELOPMENT

This invention was made with Government support under Award No. DE-EE0006457 and Award No. DE-EE0006693 awarded by the United States Department of Energy. The Government has certain rights in this invention.

### BACKGROUND

Solar panels are widely used in the production of electricity with multiple panels typically connected together as panel assemblies. These solar panel assemblies are usually arranged in arrays and mounted on structural racking systems on the roofs of buildings, on the ground or other fixed structures. A fixed structure can include, but is not limited to, existing residential or commercial roof tops, horizontal surfaces or vertical surfaces, existing fences, railings, walls or open ground-mounted areas. In many jurisdictions, these mounting systems pass loading tests to ensure they can withstand static and dynamic loading anticipated during the life of the installation. These solar racking systems are often custom designed for each application and custom installed by contractors and tradespeople using specialty skills and following the approved drawings. This solar module system, in accordance with certain embodiments, includes a flexible, configurable design that allows direct attachment either to the roof sheathing (plywood spanning over structural roof rafters or roof trusses that serves as a foundation for roofing materials) or to the roof rafters or roof trusses themselves. This flexible, configurable solar module system enables a streamlined installation method which eliminates expense of custom design and installation activities. This system reduces work on the roof and reduces the skills and experience potentially necessary on the roof to perform a high quality solar array installation.

In addition, a number of solar panel manufacturers have released new solar panels with integrated micro-inverters to simplify the electrical installation process. But a simple, low skill mechanical installation of a solar array remains unavailable on the market today.

Typical solar mounting or racking systems fail to provide the flexibility and the low skills many believe necessary for large scale adoption of solar power in the United States and around the world.

### BRIEF DESCRIPTION OF THE DRAWINGS

FIG. 1 illustrates a traditional 60 cell photovoltaic (PV) solar module [1] which is a typical size used in residential and commercial solar power applications.

FIG. 2 illustrates a schematic array of traditional 60 cell PV solar modules [1] overlaid on a map showing typical roofing structure: roof rafters or roof trusses spaced at 24″ on center [2].

FIG. 3 illustrates a model of a rectangular direct anchoring solar module [4] compatible with the sheathing and rafter periodicity (a 7 cell×8 cell photovoltaic module [or similar solar collection module] made compatible with the 48″ periodicity on the 7 cell side).

FIG. 4 illustrates a model of a square direct anchoring solar module [5] compatible with the sheathing and rafter periodicity (a 7 cell×7 cell photovoltaic module [or similar] made compatible with the 48″ periodicity on both sides).

FIG. 5 illustrates a schematic of an array of direct anchoring solar modules [4] (with one width of approximately 46 inches) overlaid and anchored to “sheathing strong points” [3] that fall at a periodicity of 48″. The mounting brackets [6] located on the corner of each direct anchoring solar module [4] provide direct roof anchoring on the “sheathing strong points”.

FIG. 6 illustrates a schematic of an array of direct anchoring solar modules [4] (with one width of approximately 46 inches) overlaid and anchored on roof trusses or roof rafters [2] framed with standard 24″ centerlines/allowing for a 48″ periodicity. The mounting brackets [6] located on the corner of each direct anchoring solar module [4] provide direct roof anchoring on roof trusses or roof rafters.

FIG. 7 illustrates a schematic of an array of square direct anchoring solar modules [5] (with a width of approximately 46 inches) overlaid and anchored to “sheathing strong points” [3] that fall at a periodicity of 48″. The mounting brackets [6] located on the corner of each square direct anchoring solar module [5] provide direct roof anchoring on the “sheathing strong points”.

FIG. 8 illustrates a schematic of an array of square direct anchoring solar modules [5] (with one width of approximately 46 inches) overlaid and anchored on roof trusses or roof rafters [2] framed with standard 24″ centerlines/allowing for a 48″ periodicity. The mounting brackets [6] located on the corner of each square direct anchoring solar module [5] provide direct roof anchoring on roof trusses or roof rafters.

FIG. 9A illustrates a mounting bracket [6] with male [7] and female [8] coupling (for securing adjacent modules) and slots [9] for direct mounting to “sheathing strong points” and roof rafter or roof truss locations. Track [10] is shown with a mitered construction under direct anchoring solar module [4] or [5] with the mounting bracket [6] bound to the tracks by the two fasteners [18].

FIG. 9B illustrates a mounting bracket [6] with male [7] and female [8] coupling (for securing adjacent modules) and a hole [9] for direct mounting to “sheathing strong points” and roof rafter or roof truss locations. Track [10] is shown under direct anchoring solar module [4] or [5]. The bracket has extensions that also fit inside the track cavity, which makes it possible to attach multiple parts (2 tracks and 1 bracket) in a single, fastener-less, assembly operation.

FIG. 10 illustrates an installation process Step 1 and Step 2. Starting at a predetermined distance (some embodiments will call to start 24 inches up from the bottom edge of the roof [11] while other embodiments may call for dimensions up from the bottom edge of the roof [11] as 18 inches, 22 inches, 28 inches or 30 inches depending on certain parameters). Then, install the anchor module by drilling pilot holes and setting anchors through the module brackets in four (4) locations and setting through-wall screws into the “sheathing strong points” [3]. Then couple module #2 to the anchor module and a drill and set two (2) additional anchors through the module brackets with a drill, setting through-wall screws into the “sheathing strong points” [3]. Note: may unique embodiments exist than are illustrated here. For example, the installation can proceed in any direction, down the roof slope from the anchor module, up the roof slope from the anchor module, toward the right of the anchor module or toward the left of the anchor module, as long as the bottom edge of the anchor module is set at a predetermined point up from the bottom edge of the roof [11] or the bottom edge of the anchor module is set on a “sheathing strong points” [3] which occur approximately at a pre-determined frequency as you go up the roof slope from the anchor module bottom edge starting point, depending on certain parameters.

FIG. 11 illustrates an installation process Step 3 and Step 4. Then couple module #3 to module #2 and a drill and set two (2) additional anchors through the module brackets with a drill, setting through-wall screws into the “sheathing strong points” [3]. Then couple module #4 with the anchor module and set two (2) additional anchors through the module brackets with a drill, setting through-wall screws into the “sheathing strong points” [3].

FIG. 12 illustrates an installation process Step 5 and Step 6. Then couple module #5 to module #4 and a drill and set one (1) additional anchor through the module bracket with a drill, setting a through-wall screw into the “sheathing strong points” [3]. Couple module #6 to module #5 and a drill and set one (1) additional anchor through the module bracket with a drill, setting a through-wall screw into the “sheathing strong points” [3].

FIG. 13 illustrates an installation process for direct attached solar modules [5] to roof rafters and roof trusses. The process follows a similar process as for anchoring to the “sheathing strong points” except the starting points for the anchor module fall along a roof rafter or truss. Like the process described above, this roof rafter or roof truss installation has many embodiments and unique orders of operation following the convention described.

FIG. 14 illustrates a Toggler Snaptoggle® toggle anchor (reference U.S. Pat. Nos. 6,161,999 and 4,650,386.)

FIG. 15 illustrates an improvement to the Toggler Snaptoggle® toggle anchor that adds barbs or teeth on the plywood side of the toggle. Also, an increase in sheet metal gauge and/or an increase in length of toggle is made to increase pullout strength of toggle.

FIG. 16 illustrates a second embodiment of a sheathing anchor for anchoring to the “sheathing strong points” with a deep toggle with teeth [12] and a direct, pivoting engagement with the threaded bolt [13].

FIG. 17 illustrates a third embodiment of a sheathing anchor showing both exterior elevations of the standard hex bolt [13], rubber stop [14] (used to hold the toggle/bolt assembly while the user is rotating the bolt into the toggle anchor) and the pivoting toggle/threaded collar [15].

FIG. 18 illustrates a rendering of the third embodiment of SMASHtoggle showing different exterior elevations of the hex bolt [13], the rubber or other natural or synthetic compliant material (used for both waterproofing and a stop to hold the bolt/toggle assembly during the user's rotating of the bolt into the toggle anchor) and the toothed toggle sprung to stay a few degrees from in line of the bolt—as in the second image (for entry into the pilot hole) or sprung to stay fully open—as in third image (to become fully lockable after the toggle pushes through the pilot hole).

FIG. 19 illustrates a stacking element for solar power modules built into the mounting bracket [6] snap couplers [7] and [8]. Specifically, the snap locking mechanism [16] may serve as a stacking element for transit of the direct anchoring solar power modules.

FIGS. 20A-20B illustrate a different embodiment of a stacking element for solar power modules built into the mounting bracket [6] at the snap couplers [7] and [8]. Stacking element at the female coupler [17] and another stacking element at the male coupler [18] both support the solar power module when stacking for shipment.

FIG. 21 illustrates an electrical conduction through mounting brackets.

FIG. 22 illustrates an electrical conduction through male [7] and female [8] mechanical couplers to electrically connect with adjacent modules.

FIG. 23 and FIG. 24 illustrates an electrical conduction through male [7] coupler and the snap lock [22] to electrically connect with adjacent modules.

FIG. 25 illustrates a layout of foot anchoring solar modules with modules in portrait orientation.

FIG. 26 illustrates a layout of foot anchoring solar modules with modules in landscape orientation.

FIG. 27 illustrates an embodiment of the mounting foot [23].

FIG. 28 illustrates a second embodiment of the mounting foot [23].

FIG. 29 illustrates an embodiment including a Composite Shingle Roof application including an array of 4 modules, interleafed and interlocked with corresponding adjacent modules at location 1, 2, 3 and 4 with anchoring feet in adjusted position.

FIG. 30 illustrates an embodiment including a Mounting Bracket Assembly.

FIG. 31 illustrates an embodiment including a Side view of solar panel module.

FIG. 32 illustrates an embodiment including a Plan view of solar panel module assembly.

FIG. 33 illustrates an embodiment including a cross section view Section A—Section through Full Assembly.

FIG. 34 illustrates an embodiment including a cross section of a solar panel module, Section B—Section through Full Assembly.

FIG. 35 illustrates an embodiment including an Interlocking Mounting System for Solar Panels (Back View).

FIG. 36 illustrates an embodiment including a cross-sectional view of Panel Track with Mounting Bracket beyond for a solar panel module.

FIG. 37 illustrates an embodiment including a cross-sectional view through Cable Tray hanging on Panel Track for a solar panel module.

FIG. 38 illustrates an embodiment including a Mounting Bracket and adjustable Mounting Foot Assembly of a solar panel module for pitched roof applications.

FIG. 39 illustrates an embodiment including a cross-sectional view of a Mounting Bracket and adjustable Mounting Foot Assembly of a solar panel module for pitched roof applications.

FIG. 40 illustrates an embodiment including an Interlocking Mounting System for Solar Panels with configurable Mounting Brackets (Back View).

FIG. 41 illustrates an embodiment including an Interlocking Mounting System for Solar Panels with configurable Mounting Bracket components in use (Back View).

FIG. 42 illustrates an embodiment including a Configurable Mounting Bracket Assembly for a solar panel module—Exploded Component Diagram.

FIG. 43 illustrates an embodiment including an Adjustable Mounting Foot Assembly for a solar panel module and Flashing for pitched roof applications

FIG. 44 illustrates an embodiment including a Bottom view of adjustable Mounting Foot Assembly for a solar panel module and Flashing for pitched roof applications.

FIG. 45 illustrates an embodiment including Sensors at Mounting Feet for a solar panel module.

FIG. 46 schematically illustrates an embodiment including eight installed solar panels coupled together in 4×2 arrangement.

FIG. 47 schematically illustrates a preassembled solar panel including mounting brackets in accordance with certain embodiments.

FIG. 48 schematically illustrates a mounting foot in accordance with certain embodiments.

FIGS. 49-50 schematically illustrate a method of installing a set of four preassembled solar modules on a roof surface in accordance with certain embodiments.

FIG. 51 schematically illustrates a pair of uncoupled solar panel bracket connectors in accordance with certain embodiments.

FIG. 52 schematically illustrates a pair of coupled and unlocked solar panel bracket connectors in accordance with certain embodiments.

FIG. 53 schematically illustrates a pair of coupled and locked solar panel bracket connectors in accordance with certain embodiments.

FIG. 54 schematically illustrates a pair of adjacent preassembled solar panels including two pairs of complementary bracket connectors that are not yet coupled together.

FIG. 55 schematically illustrates four solar panel corners installed as a 2×2 array or subarray that each include a corner bumper that overlaps in two dimensions.

FIG. 56 schematically illustrates an example solar module in accordance with certain embodiments.

FIG. 57 schematically illustrates an example mounting foot in accordance with certain embodiments.

FIG. 58 schematically illustrates an example solar module, track, mounting foot and sheathing anchor in accordance with certain embodiments.

FIG. 59 schematically illustrates an example solar module layout in accordance with certain embodiments.

FIG. 60 schematically illustrates further examples of solar module layouts in accordance with certain embodiments.

FIG. 61 schematically illustrates further examples of solar module layouts in accordance with certain embodiments.

FIG. 62 schematically illustrates sheathing strong point locations A, B and other sheathing locations C, D within a solar module layout in accordance with certain embodiments.

FIG. 63 is a table that illustrates average ultimate uplift capacities for solar modules coupled to the sheathing strong point locations A, B and the other sheathing locations C, D illustrated in FIG. 62.

FIG. 64 is a bar graph that illustrates ultimate uplift forces for solar modules coupled to the sheathing strong point locations A, B and the other sheathing locations C, D illustrated in FIG. 62.

FIG. 65 schematically illustrates sheathing strong point locations, intermediate sheathing locations and other sheathing locations in accordance with certain embodiments.

FIG. 66 is a graph that schematically illustrates ultimate uplift capacities of solar modules coupled at the sheathing strong point locations, intermediate sheathing locations and other sheathing locations illustrated in FIG. 65.

FIG. 67 is a graph that schematically illustrates percentages of centerline ultimate uplift capacities of solar modules coupled at the sheathing strong point locations, intermediate sheathing locations and other sheathing locations illustrated in FIG. 65.

FIG. 68 schematically illustrates a side view of an example track that is configured for coupling to a solar module and a mounting foot in accordance with certain embodiments.

FIG. 69 schematically illustrates a side view of another example track that is configured for coupling to a solar module and a mounting foot in accordance with certain embodiments.

FIGS. 70A-70F schematically illustrate a process for coupling a mounting foot to the example track of FIG. 69 using a nut and bolt in accordance with certain embodiments.

FIGS. 71A-71B schematically illustrate perspective views of a mounting foot in accordance with certain embodiments.

FIGS. 72A-72B schematically illustrate perspective and side views of the example mounting foot of FIGS. 71A-71B coupled to the example track of FIG. 69 in accordance with certain embodiments.

FIGS. 73A-73B schematically illustrate side and perspective views of the example mounting foot of FIGS. 71A-71B reverse coupled to the example track of FIG. 69 in accordance with certain embodiments.

FIG. 74 schematically illustrates a perspective view of another example mounting foot coupled to the example track of FIG. 68.

FIG. 75 schematically illustrates an exploded view of another example of a mounting foot configured for coupling to a track on a solar panel module in accordance with certain embodiments.

FIG. 76 schematically illustrates a bottom perspective isometric view of a mounting foot coupled to a track on a solar panel module in accordance with certain embodiments.

FIG. 77 schematically illustrates a side view of a mounting foot coupled to a track on a solar panel module in accordance with certain embodiments.

FIG. 78 schematically illustrates a side view of a mounting foot coupled to a track on a solar panel module in accordance with certain embodiments.

FIGS. 79A-79D schematically illustrate solar panel modules including adjustably-coupled mounting feet coupled to one or more tracks on the solar panel modules and at selected roof locations in accordance with certain embodiments.

FIGS. 80A-80D schematically illustrates tracks configured for coupling to solar panel modules that include multiple zones for coupling mounting feet at selected, adjustable locations in accordance with certain embodiments.

FIGS. 81-82 schematically illustrate electrical circuits for transmitting electrical power between adjacent solar panel modules in accordance with certain embodiments.

### DETAILED DESCRIPTIONS OF THE EMBODIMENTS

An integrated preassembled solar panel module is provided that includes a solar panel configured for receiving and converting solar radiation to produce electrical power. The solar panel module includes multiple integrated brackets coupled to the solar panel and configured for coupling to brackets of adjacent solar panel modules of a solar module array. At least one elongated track is coupled in preassembly to the solar panel. Multiple mounting feet are adjustably coupled each to a selected location along the at least one track. One or more sheathing anchors are configured for coupling the mounting feet each within one or more bands each overlapping a centerline of roof sheathing and not overlapping roof rafters.

The at least one track may have a length that is more than half of a dimension of the solar panel such that the selected location is adjustable to be anywhere within an area more than half overlapping an area of the solar panel. The band of sheathing strength may run horizontally across the roof.

The at least one track may have an elongated cavity defined therein for bolting the multiple mounting feet each at a selected location along the at least one track. The at least one track may have a pair of elongated cavities defined therein for bolting the multiple mounting feet each at the selected location along the at least one track and on a selected side of the track. The at least one track may have an elongated cavity defined therein by a flexible material shaped for snap-coupling the multiple mounting feet each at a selected location along the at least one track.

The band of sheathing may be 16″ wide or less. The band of sheathing may be aligned with exposed courses of roof structure. The exposed courses of roof structure may include shingle courses.

The one or more sheathing anchors may include a rotatably-attached, elongated washer for piercing the sheathing in a first position and rotating to a second position securing the sheathing anchor after the piercing of the sheathing. The one or more sheathing anchors may be configured to pierce the sheathing defining a sheathing cavity of first shape and to adjust to a second shape of increased size in at least one dimension for securing the sheathing anchor after the piercing.

The integrated preassembled solar panel module may include a frameless solar panel. The frameless solar panel may be strengthened by the at least one track being configured to stiffen the solar panel.

The integrated preassembled solar panel may include one or more fixed mounting feet coupled in preassembly to the solar panel. Length or width dimensions or a shape of the solar panel, or combinations thereof, may be selected to align the one or more fixed mounting feet with the bands of sheathing strength or locations of roof rafters, or combinations thereof. The one or more fixed mounting feet may be coupled in preassembly into one or more brackets.

The track may include multiple zones of attachment for placement of the adjustably-coupled mounting feet in preassembly for further later adjustment. The adjustably-coupled mounting feet and the track may be configured such that the adjustably-coupled mounting feet are attachable to the track in a standard or reverse orientation on the track, respectively, with the feet pointing away from the module or pointing toward the middle of the module.

A solar panel array is also provided that includes multiple integrated preassembled solar panel modules as described herein, wherein adjacent solar panel modules are coupled together bracket to bracket.

A method of installing a solar panel array is also provided. A location and dimension of the one or more bands is determined. Mounting feet are coupled to locations along the at least one track to overlap the mounting feet with the one or more determined bands.

A mounting system and techniques for securing solar panels to directly to a fixed structure either individually or collectively as an array—without dependence on any separate racking hardware parts or systems. This mounting system has universal mounting brackets attached to the back of each module that connect to one another and can directly attach to a roof structure—particularly at the “sheathing strong points” or at roof rafter or roof trusses. Alternatively, the mounting brackets and tracks have a plurality of mounting feet that connect to the tracks and anchor to the fixed structure. Each mounting bracket has a means to interconnect and interlock with the mounting brackets on adjacent solar modules. In addition, the mounting feet have a quick release mechanism to connect and disconnect from the track. The mounting feet are appropriately selected for the given fixed structure or roof type. The solar module system, in accordance with certain embodiments, has novel toggle anchors to reliably mount into sheathing plywood or OSB material. The solar module system, in accordance with certain embodiments, also describes an electrical conduction and coupling system for solar modules that integrates electrical coupling with mechanical coupling at the point of mechanical attachment.

A solar module system, in accordance with certain embodiments may be designed to anchor through the roofing membrane into roof rafters or roof trusses. Roof rafters or roof trusses may span from a bottom roof edge up to a roof ridgeline. These alternative embodiments include solar panel module arrays configured for mounting to roof rafters and/or roof trusses that may not be visible from the roof. A process for determining the positions and spacings of the rafters and/or trusses is provided in accordance with alternative embodiments. In addition, the process of anchoring of solar mounting components into rafter and/or trusses may include coupling of mounting feet at roof locations where the rafters and/or trusses are determined to be. The mounting feet are advantageously coupled at selected and/or adjustable locations along one or more rails that are coupled to solar panel modules in accordance with certain embodiments. One or more mounting feet may coupled to the roof at sheathing strong point locations while one or more other mounting feet may be coupled to the roof at locations of rafters and/or trusses in certain embodiments. Coupling to rafters and/or trusses may involve coupling lag bolts into rafters and/or trusses close to the centerlines of the rafters and/or trusses.

Rafter or truss center line spacing on pitched rooftops around the world follows a set periodicity. In the United States and in other countries where US standards are followed, the standard centerline to centerline spacing of roof rafters or roof trusses [2] is either 24 inches or 16 inches. This traditional spacing of roof rafters and roof trusses is a consequence of the fact that the most commonly produced size of plywood or oriented strand board (OSB) sheathing is 4 feet by 8 feet. Rafters and trusses therefore may be installed in a framing system spaced so that they support the ends of these plywood or OSB panels (which are typically installed in landscape orientation—that is with their long length installed horizontal to the bottom edge of the roof). Therefore, the most common rafter spacing is four rafters per 8 feet (i.e. 24″) or six rafters per 8 feet (i.e. 16″). Note that roofs are occasionally framed with three rafters per 8 feet (i.e. 32″) and five rafters per 8 feet (i.e. 19B″). Structural engineers estimate that: 65% of rafters or trusses are spaced at 24″, 30% at 16″ and 5% at 32″.

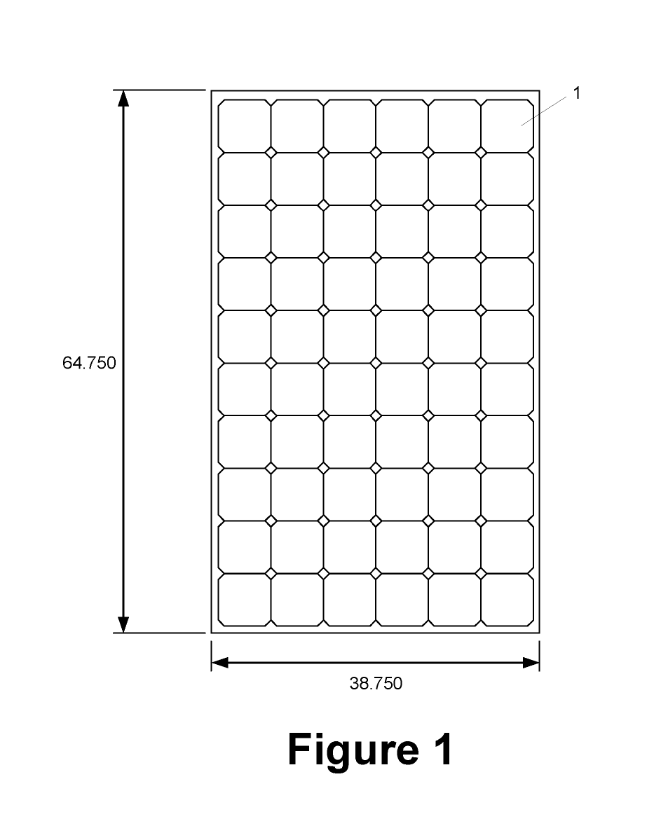

In certain embodiments, solar modules are provided for the pitched roof applications, e.g., small commercial or residential markets, that may have outer dimensions of approximately 40 inches×65 inches and may be constructed of a 6 cell by 10 cell array of photovoltaic cells, as in the example of FIG. 1. In order to mount solar modules on residential rooftops, the mismatch in the periodicity of rooftop structural elements (roof rafters and roof trusses) and the dimensions of solar modules may be resolved in certain embodiments using intermediate structural elements to span geometric differences. In certain embodiments, structural tracks may be used that attach to sheathing strong points, rafters or trusses, or combinations thereof, and span gaps between them to offer a contiguous area of attachment for solar modules. In certain embodiments, framed solar panel modules may be used to bridge the geometric difference between solar module size and sheathing strong point, roof rafter or truss periodicity, or combinations thereof.

Solar panel modules in accordance with certain embodiments may be frameless or may include aluminum alloy frames or frames of similarly conductive materials. When frames formed from conductive materials are used, and can be electrically energized, then electrical circuits are employed to ensure that the system is properly grounded. Alternatively, polymers or other electrical insulators may be used to form frames when framed modules are used.

In embodiments employing frameless solar panel modules, tracks for coupling with adjustable mounting feet or other stiffeners or thicker glass may be used to create greater structural rigidity without the frame. Framed solar panel modules of greater mass density may be reduced in geometric area to ease installation. Framed or frameless solar panel modules may also be provided having one or more selected geometric sizes in certain embodiments to match the particular structural architecture of a roof such as a sheathing strong point, rafter, and/or truss spacing.

Solar power systems in accordance with certain embodiments may have many parts including, for example solar panels, structural tracks, mounting feet or roof connection stands to attach the tracks to the roof, mounting brackets for connecting adjacent solar panel modules and/or for conducting electrical current to a central power source, that may be installed and connected together in a preassembly process at the factory or on the ground before taking the solar panel modules to be installed on the roof. Other accessories such as rust resistant metal flashing to ensure water proofing at the point of anchoring through the roofing membrane, electrical grounding conductors, and/or DC or AC electrical conductors and conduit may be preassembled with solar panel modules in certain embodiments and/or in the field.

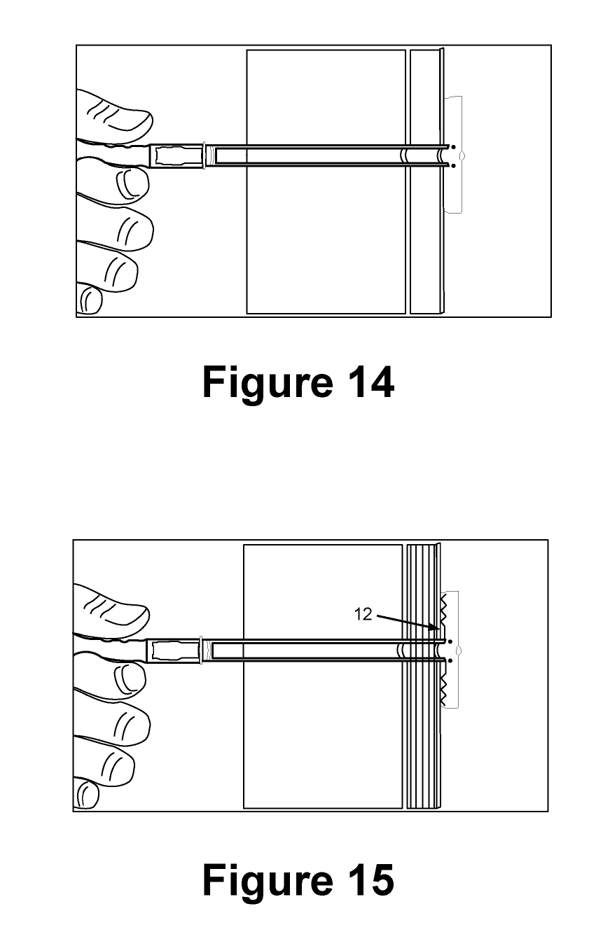

In certain embodiments, mounting feet may be coupled to roof sheathing using threaded anchors, like wood screws or similar anchors, or toggle bolts, e.g., as described in U.S. Pat. Nos. 6,161,999 and 4,650,386, which are incorporated by reference, to hold a solar panel modules to a roof. Installers would be instructed as to how to perform the installations using whichever of these sheathing anchors may be used. The installation process for through-wall anchors [see, e.g., FIG. 14] can be complicated and the instructions would be detailed and specific to avoid a blind nut or a nut located on the back side of the plywood partition from getting bound up when a bolt is being rotated into the blind nut in certain embodiments.

Mounting feet are coupled at selected locations along tracks that are coupled to solar panels such that solar panel modules in accordance with certain embodiments may be installed on roofs that include different composite shingle roofing products having high degrees of variability in course exposure and spacing. Solar panel modules in accordance with certain embodiments are advantageously anchorable to such variable composite roofing systems as the mounting feet may be coupled at selected locations along the elongated tracks to match mounting points for the modules that may not otherwise reliably align with the center of each roofing course where the flashing is located. Such misalignments are avoided in certain embodiments and potential compromises of the waterproofing system involving roof flashing are prevented by placing the mounting feet at selectably adjustable locations on the roof notwithstanding the particularly locations of the solar panels relative to the course exposures and spacings of the roof flashing.

The preassembly of solar panel modules in accordance with certain embodiments advantageously reduces the number of steps and motor actions for installers to perform on the roof. This reduction in process steps of installation processes in accordance with certain embodiments reduces physical strain in workers and time spent on the roof installing the solar panel module array.

Solar panel module arrays with versatile foot positioning along tracks in accordance with certain embodiments may be installed on various types of roofing systems. These systems include composite shingle roofing, flat tile roofing, s-tile roofing, metal roofing and flat roofing that include composite shingle, asphalt, metal, wood shingles/shakes, ceramic or clay tile, concrete tile and/or slate. Solar panel module array may be installed in accordance with certain embodiments on roofs that include any of a wide variety of roofing architectures and materials.

A solar panel module array, in accordance with certain embodiments, may include multiple integrated and preassembled solar panel modules designed to couple to sheathing and/or rafters through an advantageous method of coupling mounting feet anywhere along one or more elongated tracks that are coupled in preassembly to the solar panel module. The solar panel module may include a framed solar panel or a frameless solar panel that is sufficiently stiffened by the one or more elongated tracks.

When a worker wants to understand the specific roof structure periodicity of a specific building (for example, the frequency of roof rafters or roof trusses), that worker could go into the attic or other space to inspect and measure the roof rafters or roof trusses. That worker could also get on a ladder and inspect and measure the roof structure if exposed under the roof eaves. Many workers involved in solar installations use a ladder or other means to get on the roof to inspect the roof structure from above. Using a hammer, the worker would use a process of hitting the roof to locate hollow areas (indicating sheathing) and the firm areas (indicating rafters or trusses). In other cases, a worker may use other tools (like a stud finder or other instrument). Generally, for solar installations, these methods are used to precisely locate rafters or trusses hidden from view by the roofing platform in order to mount mechanical components. On roof structural inspections and/or direct inspection methods may be used to the determined the roof structure. The mounting feet are coupled at particular selected, adjustable locations along one or more elongated tracks that are coupled to the solar panel module in accordance with the roof structural and/or direct inspection of the roof.

Mounting feet may be set to couple with roof sheathing not overlapping rafters in certain embodiments at roof sheathing areas with highest structural capacity to support solar power module attachment. In accordance with certain embodiments, the mounting feet are coupled to the roof at sheathing strong points that include bands of strength overlapping a centerline of roof sheathing and not overlapping roof rafters. The bands of strength may run horizontal along a roof, or in certain embodiments may run vertically up or down along the slope of the roof. At least one elongated track may have a length that is more than half of a dimension of the solar panel such that mounting feet may be coupled to the solar panel module at any selected location that is adjustable to be anywhere within an area more than half overlapping an area of the solar panel so that the mounting feet may be coupled to the roof at sheathing strong points notwithstanding the roof geometry nor structural component spacing nor layout of course exposures for a particular roof.

The strength of the coupling of the mounting feet of solar panel modules using advantageous sheathing anchors at sheathing strong points is enhanced in accordance with certain embodiments by incorporating mounting brackets coupled in preassembly to the solar panel module and configured to mechanically couple adjacent solar panel modules together. The mounting brackets may also be configured for electrical coupling adjacent solar panel modules together.

The bands of sheathing strength that include sheathing strong points at which mounting feet are coupled in certain embodiments are found in locations on the sheathing with a sufficient structural capacity to resist the known uplift demands a solar power system places on a roof structure. These bands of sheathing strong points depend on the sheathing composition, the rafter or truss periodicity and the nail gauge used to secure the sheathing to the roof structure.

Sheathing on an example roof structure may be manufactured in four foot (48″) by eight foot (96″) sheets composed of plywood or orientated strand board (OSB) materials. The sheathing on this example roof may also be manufactured in four foot (48″) by ten foot (120″) sheets of similar composition or another customized geometry depending on the rafter or truss structure of the roof. The installation of roof sheathing begins after the building roof framing is complete. On a pitched roof, sheathing may be installed in a landscape orientation, i.e., parallel to the bottom edge of the roof which is closest to the ground. A first row of sheathing may be aligned with the bottom edge of the roof and the second row of sheathing to be installed up the roof slope next to the first row. Thus the sheathing may be installed row by row up the roof framing structure. The particular sheathing installation process may be used to determine where the bands of sheathing strong points are for selecting in preassembly the locations of the mounting feet along the elongated tracks in accordance with certain embodiments.

Mounting feet coupled to solar panel modules of an array in accordance with certain embodiments may be coupled at sheathing strong points or at rafter/truss locations, or combinations thereof. An advantageous through-wall anchor or sheathing anchor is used in certain embodiments for coupling mounting feet to sheathing.

An electrical connection system is also provided in certain embodiments for electrically connecting solar modules together when they are mechanically coupled together, e.g., at mounting bracket locations. In further embodiments, a shipping stacking feature may be built into a mounting bracket to protect direct anchoring solar modules during shipping and/or installation, and one or more bumpers may be disposed around the edges particularly in embodiments that include frameless solar panel modules.

An integrated, preassembled solar module system, in accordance with certain embodiments, eliminates the time, cost and complexity of anchoring to roof rafters with a mounting foot that can be anchored directly to the roof membrane with standard metal flashing anchored through the roof substrate (plywood or OSB sheeting) at selected points of sheathing strength.

An integrated, preassembled solar module system, in accordance with certain embodiments, significantly reduces the number of loose parts to be installed at a roof location.

An integrated, preassembled solar module system, in accordance with certain embodiments, streamlines the system design and installation process especially for smaller system sizes, giving customers an affordable small solar option through its modular design.

An integrated, preassembled solar module system, in accordance with certain embodiments, may use non-conductive, composite materials to prevent certain electrical grounding issues.

An integrated, preassembled solar module system, in accordance with certain embodiments, may include one or more tracks and/or mounting brackets that are designed to structurally support a frameless solar panel module. Alternatively, special panel designs such as thicker glass and/or stronger polymeric materials may be used to strengthen or stiffen the panel in embodiments wherein no frame is included.

An integrated, preassembled solar module system, in accordance with certain embodiments, may include factory-installed tracks and/or mounting brackets and/or mounting feet that simplify the installation process by reducing in field decision making, eliminating specialty skills and human error potential (which can significantly decrease time to train workers).

An integrated, preassembled solar module system, in accordance with certain embodiments wherein mounting feet are coupled to sheathing strong points not overlapping rafters advantageously avoids precision layout and installation of roof connectors at the roof rafters.

An integrated, preassembled solar module system, in accordance with certain embodiments, may reduce a crew size utilized to install a solar array. The solar module system, in accordance with certain embodiments, can be installed with a minimal number of workers in a short time.

An integrated, preassembled solar module system, in accordance with certain embodiments, advantageously couples at sheathing strong points using a threaded anchor or an anchor installed into a rafter or a special sheathing anchor that includes a rotatably-attached, elongated washer for piercing said sheathing in a first position and rotating to a second position securing the sheathing anchor after the piercing of the sheathing or another special sheathing anchor that is configured to pierce sheathing defining a sheathing cavity of first shape and to adjust to a second shape of increased size in at least one dimension for securing the sheathing anchor after the piercing or a special toggle designed specifically for plywood or OSB applications or combinations thereof.

DIRECT ANCHORING SOLAR MODULE SYSTEM: A solar module system, in accordance with certain embodiments, may include one or more of the following characteristics:

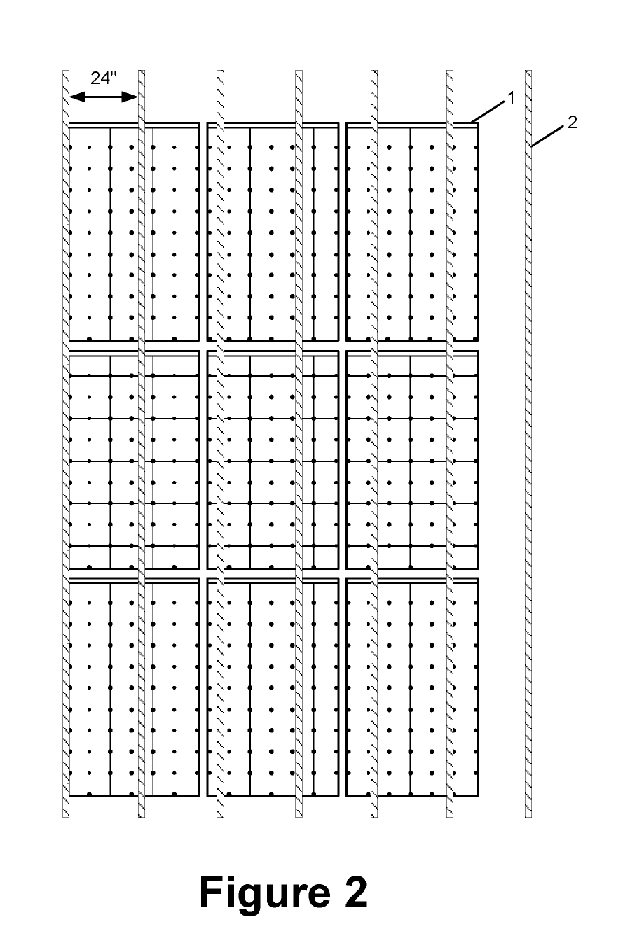

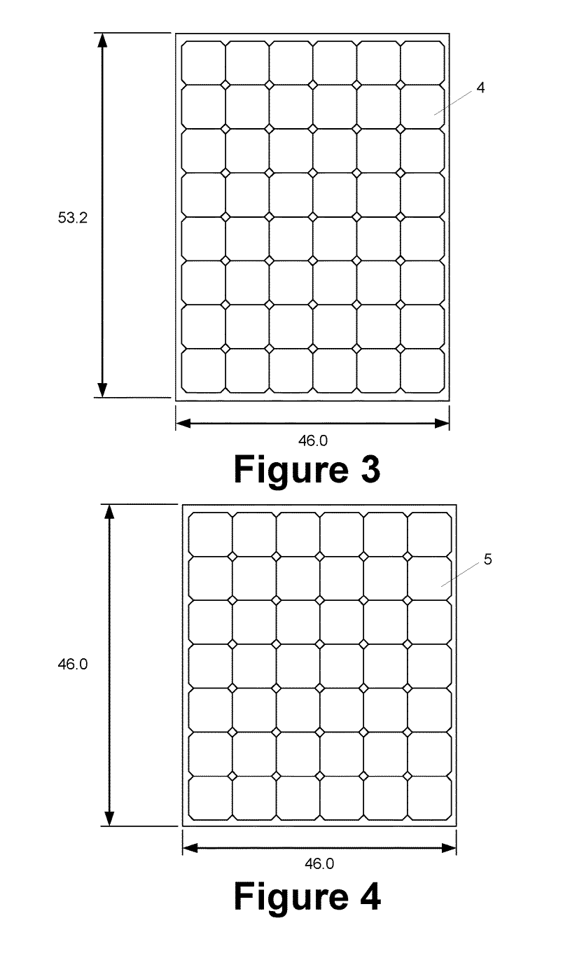

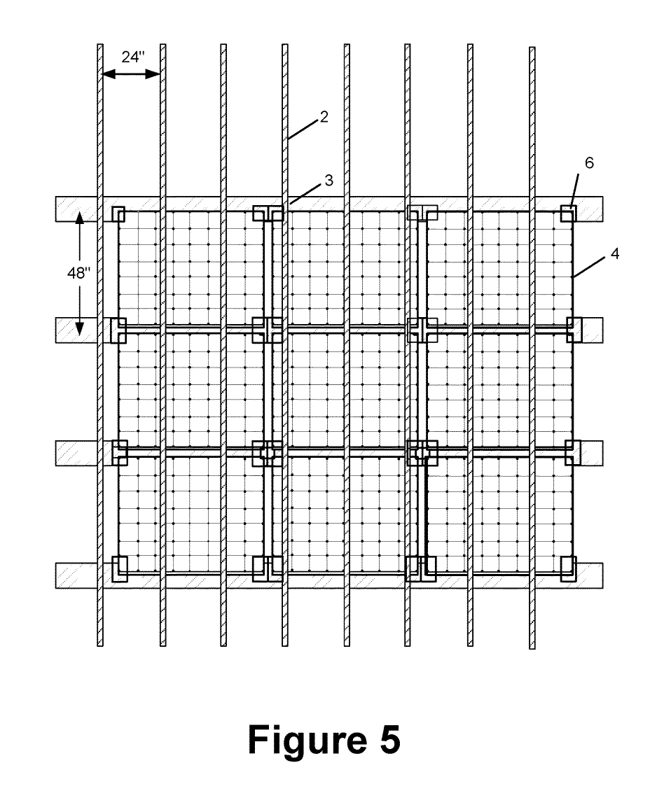

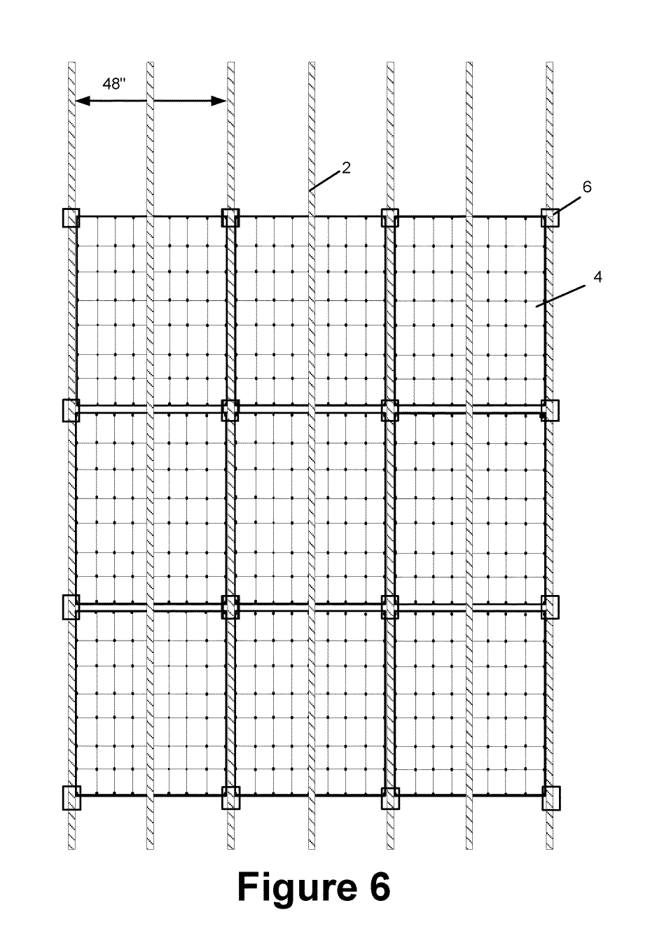

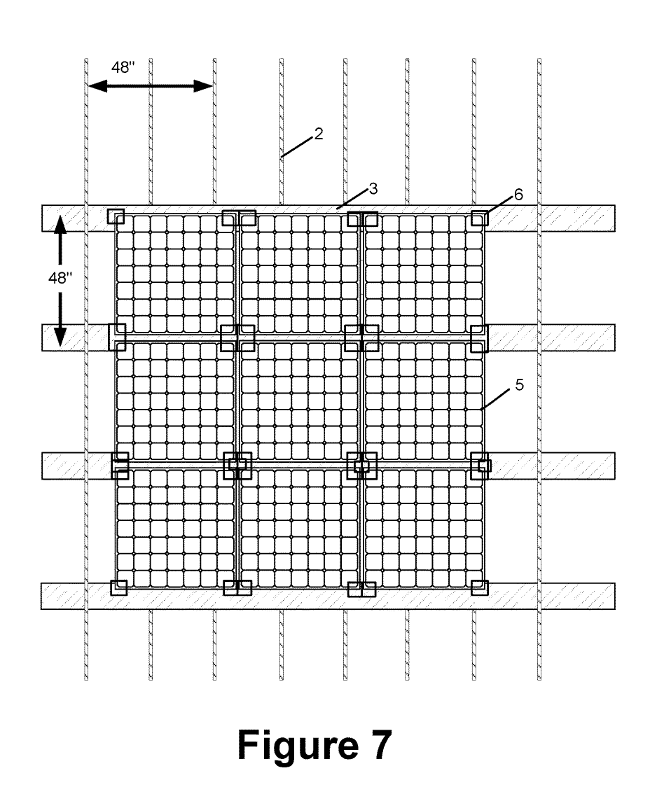

Integrated preassembled solar panel modules may be compatible with the 48″ structural periodicity that exists on the vast majority of rooftops in the United States and other countries [see, e.g., FIG. 2]. For instance, and removing two rows and adding an additional column of photovoltaic cells to the current 60 cell array [1] would create a 7 cell×8 cell (56 cell) module design as illustrated in the example of FIG. 3 that could have dimensions that enable an approximately 48″ periodicity [see, e.g., FIG. 5 and FIG. 6]. Other embodiments of a direct attachment module include a 7 cell by 7 cell module [see FIG. 4] or a 7 cell by 11 cell module (not illustrated). Another embodiment could include a thin film module that has one or more edge dimensions of approximating the 48″ periodicity. Such a module in any embodiment could provide reliable, consistent alignment to the sheathing strong points for mounting solar modules to the roof sheathing. A direct anchoring solar module system in certain embodiments combines a frameless solar panel and four (4) mounting brackets, e.g., one near each corner. The frameless solar module may be constructed to dimensionally align with the periodicity of the roof rafter, roof truss and or the “sheathing strong points”.

The direct anchoring solar module [3, 4] can be any type of flat solar collector (silicon cell, thin film, solar thermal, etc.), constructed using either a frameless or a framed design.

A frameless panel may include a solar panel manufactured with no structural frame. A framed panel may include a solar panel with a structural frame typically made of extruded aluminum or aluminum alloy or another metallic material or an insulating material such as a polymer.

Mounting brackets [6] may include structural members attached to the underside of the solar panel. The mounting brackets assembled in a factory with the solar panel then may be used to directly attach to an adjacent solar module. The direct anchor solar module may couple to the structural roof components, e.g., sheathing strong points, or roof rafters or roof trusses, or combinations thereof, either at the brackets which may be configured to function as or to couple with mounting feet or at mounting feet that are coupled to one or more elongated tracks that are also attached to the underside of the solar panel.

FUNCTION: In certain embodiments, the primary functions of mounting brackets may include the following:

(a) Establish and regulate the spacing between solar modules (holding adjacent panels at constant relative distance when interleaved properly)

(b) Couple with adjacent mounting brackets when two solar modules are placed side by side. Positive [7] and negative [8] bracket connection points may be configured as in the example illustrations.

(c) Support anchors with features [9] to directly secure the integrated module to the structural roof connection points: 1) sheathing strong points and/or 2) roof rafters and/or roof trusses, without additional variable components that adjust, bridge or span to the structural roof connection points.

(d) Create a strong module to module structural connection allowing adjacent modules to share the direct attachment point to the roof. Mounting bracket may employ a coupling system to achieve this strong structural connection such as a male coupler [7] and a female coupler [8].

(e) Stiffen the solar panel with integrated components [10] that may tie brackets together on the back of a module.

COMPOSITION: The mounting bracket can be made from any structurally appropriate material (metal, wood, plastic, composite, concrete, stone, or the like). The result of using a non-conductive, composite material (e.g. non-metal) is the elimination of equipment grounding for conductive materials and increased safety in eliminating the risk of electrical arc flash from the solar panel to an adjacent conductive material.

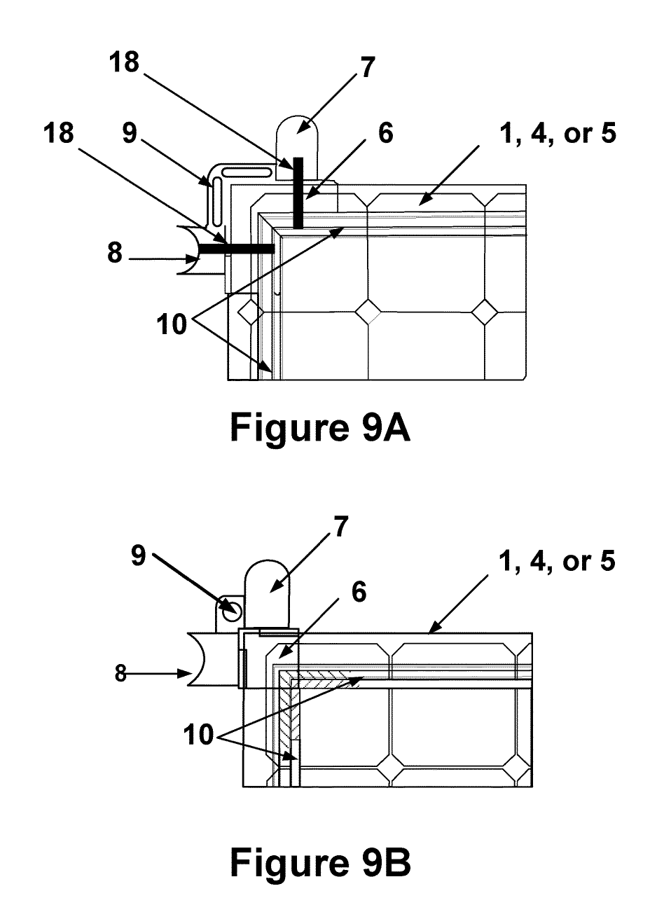

CONFIGURATION: The dimensions of the brackets can vary depending on the specific solar panel's physical characteristics and mechanical requirements. The mounting brackets therefore can take any number of shapes or configurations with different dimensions in the obverse and transverse dimensions. In the FIG. 9A embodiment, the mounting bracket [6] supports anchoring to the roof through two slots [9] allowing for some adjustment due to roof variability. In this embodiment [FIG. 9A] the corners of the track are mitered and bound by a ridged, barbed insert. The mounting bracket profile wraps the corner of the frame and is attached via 2 long fasteners [18] (self-tapping or tapped) that engage with the stiffening components [10]. These fasteners may also serve to attach male [7] and female [8] coupling components. In the FIG. 9B. embodiment, the mounting bracket [6] supports anchoring to the roof through a single hole [9]. In this embodiment [FIG. 9B] the corners of the track are bound by a ridged, barbed insert. The bracket has extensions that also fit inside the extrusion cavity, thus making it possible to attach all 4 frame parts (2 tracks, 1 insert and 1 bracket) in a single, fastener-less, assembly operation.

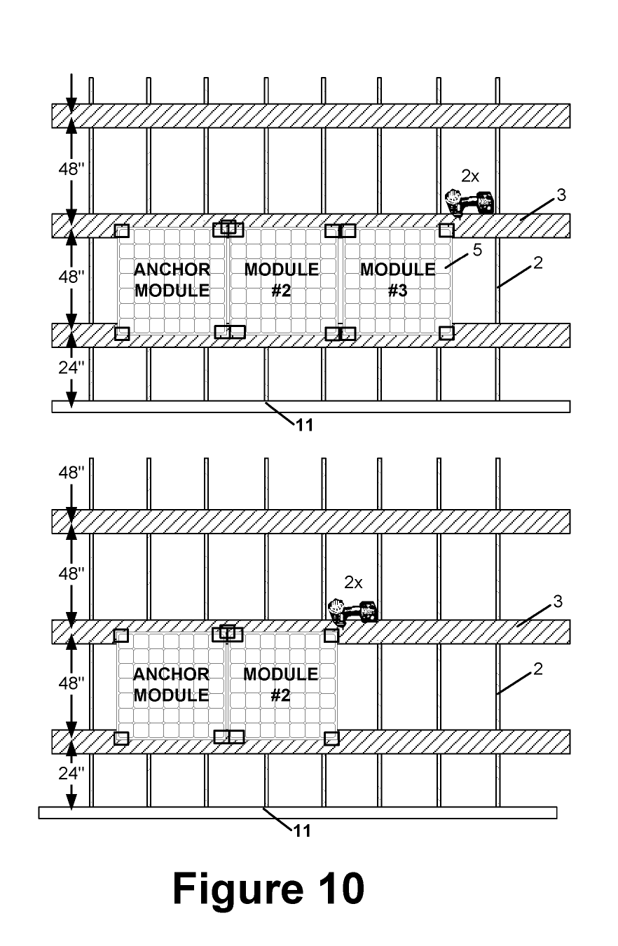

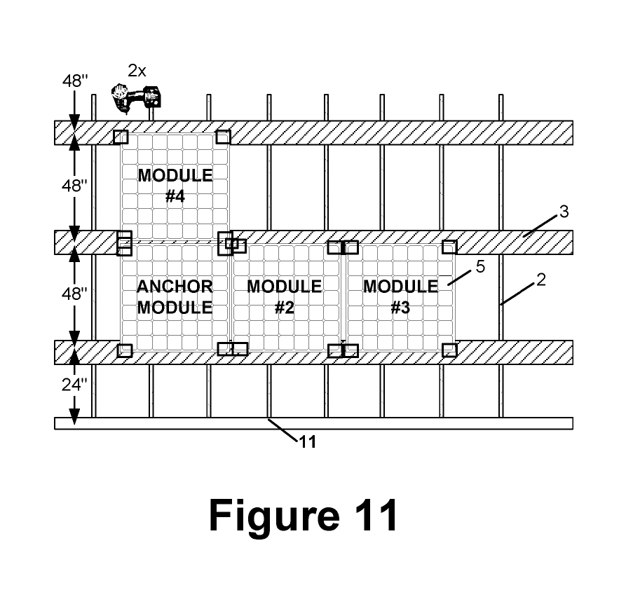

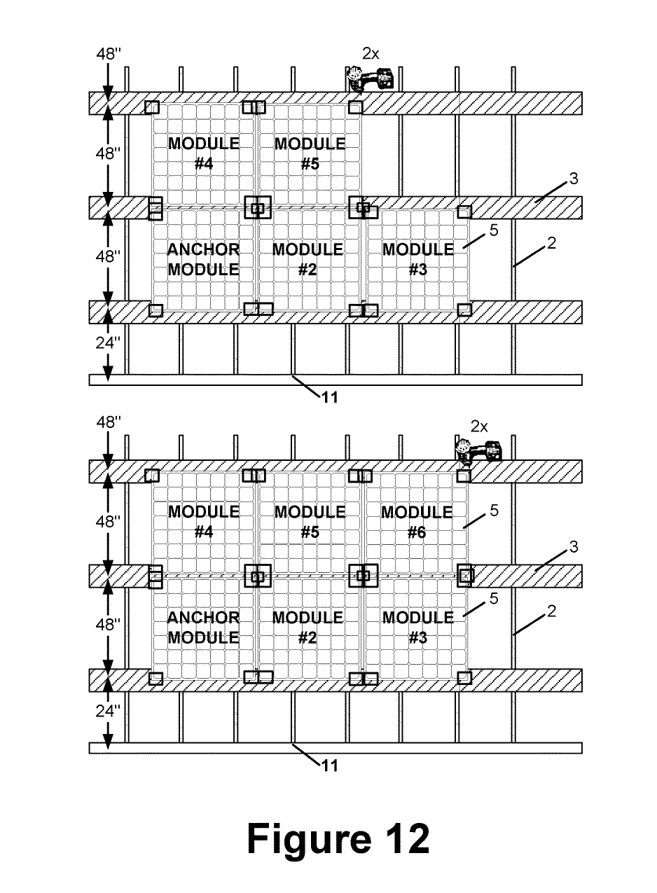

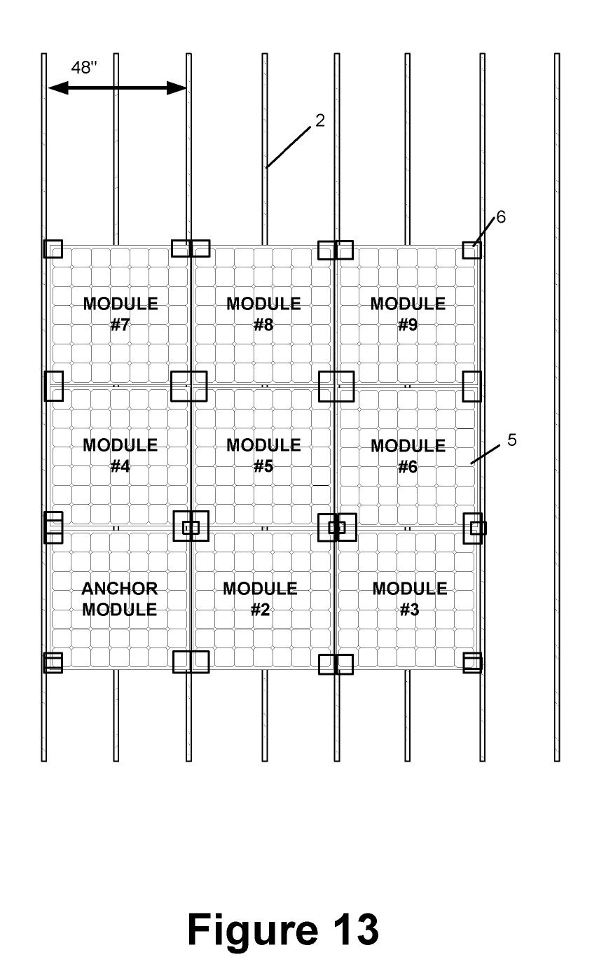

INSTALLATION: The installation method of the direct anchoring solar module system is designed to be performed with minimal roof top decision-making, minimal loose parts, and minimal worker skills for a high quality installation. In FIGS. 10, 11, 12 and 13, the installation method for the direct anchoring solar module system is described. In FIGS. 10 through 12, the installer intends to install the solar module system direct to sheathing, not rafters or trusses. The first step is to install the anchor module [FIG. 10] with its bottom edge at a predetermined point from the bottom edge of the roof [11] (as illustrated, approximately 24 inches from the bottom edge of the roof [11] while other embodiments may call for dimensions up from the bottom edge of the roof [11] as 18 inches, 22 inches, 28 inches or 30 inches depending on certain parameters). The anchor module [FIG. 10] is secured to the roof sheathing strong point at the mounting bracket using four (4) through wall anchors, typically stainless steel toggles with stainless steel bolts. The installer would place the Anchor Module at the proper location sitting on integral flashing components and drill pilot holes through the mounting bracket slot [9] or hole [9] intended to support the structural anchors. The sheathing strong point area may be located every 48″ up the roof slope and is the target for our roof anchors. In other embodiments, the sheathing strong point area may be located every 36″, 40″, 44″ or 46″ up the roof slope depending on certain parameters. The next module (module #2) is coupled to the Anchor Module, the couplers locked and then the module secured to the roof using two (2) through wall anchors at the mounting brackets not adjacent to the Anchor Module. Module #3 [FIG. 11] installs in the same process as Module #2. Module #4 [FIG. 11] installs in the same process as Module #3, except the mounting brackets used for anchoring to the roof are at the top of the module. Module #5 [FIG. 12] installs in the same process as Module #4, except in certain embodiments, only one mounting bracket is secured to the roof with a through wall anchor as the Module #5's other three mounting brackets are already coupled to an adjacent module. Module #6 [FIG. 12] installs in the same process as Module #5. In FIG. 13, the installer intends to install the solar module system direct to roof rafters or trusses, not sheathing. The installation process described in FIG. 13 could follow the same process described above except the alignment of the Anchor Module changes to align with the roof rafters or roof truss locations [FIG. 13]. Note: this direct anchoring solar module system could provide the installer almost unlimited choice in the order in which modules are coupled to their adjacent module and anchored to the sheathing or rafters. In other embodiments of this solar module system, once an Anchor Module is installed, module number 2 could be installed above (upslope), below (down slope), to the right or to the left of the Anchor Module. Likewise, in these other embodiments of this solar module system, module number 3 could also be installed above (upslope), below (down slope), to the right or to the left of module #2, excepting the location of any previously installed solar modules (e.g. the Anchor Module). This flexibility provides installers considerable latitude and freedom to install the system using their preferred order of operation, while following our novel process.

SHEATHING ANCHORS: This solar module system, in accordance with certain embodiments, can, in some cases, benefit from reliable, easy to install through wall anchors or sheathing anchors. Such embodiments can have any one or more characteristics described in various embodiments herein.

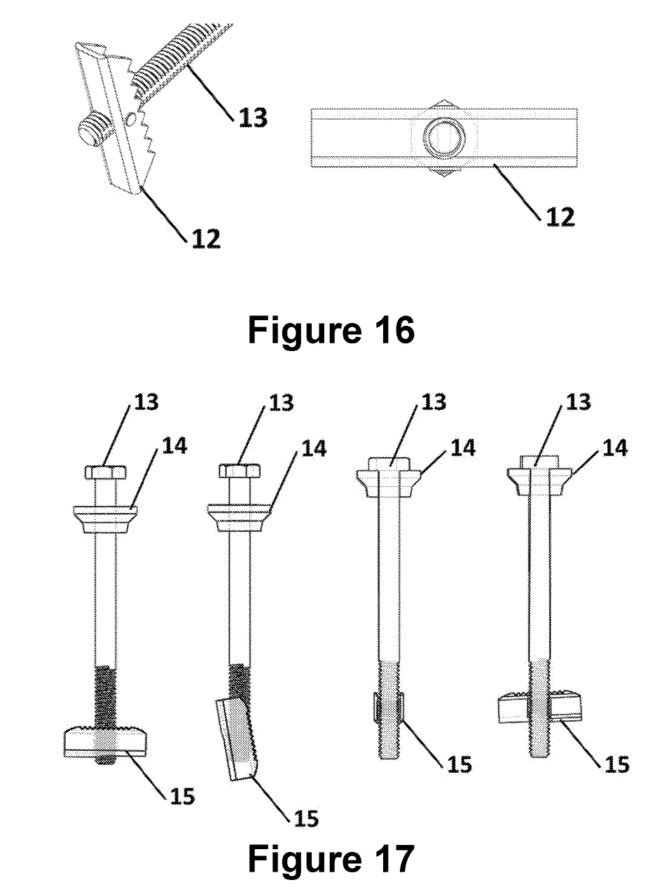

An issue occurs when using the SNAPTOGGLE® brand of toggle bolts (U.S. Pat. Nos. 6,161,999 and 4,650,386) [FIG. 15] through plywood or orientated strand board (OSB) plywood—especially in a roof top application. A sheathing anchor in certain embodiments is modified to avoid spinning in the through-hole when a worker tries to drive the bolt into the toggle to tighten it. In certain embodiments of a modified SnapToggle product [FIG. 16], a catch feature is added to engage with the plywood or OSB sheathing under the roofing material to prevent the anchor from spinning. Some embodiments to achieve this goal are illustrated and some are described including: teeth, barbs or other catch features on the sheathing anchor [12], resizing the sheathing anchor [12] in length, width or thickness or rotating direction or amount or sheathing anchor material. For example, the sheathing anchor may rotate around the long axis of the bolt portion or around an axis that is normal to the long axis after piercing the sheathing to secure the mounting foot to the sheathing. In the embodiment wherein the end portion of the sheathing anchor rotates about the long axis of the bolt portion of the sheathing anchor, the end portion may be shaped such as to not be rotationally symmetric about the long axis and instead has a different diameter for elliptical or otherwise curved embodiments or different edge size for rectangular or otherwise polygonal embodiments in a first direction than in a second direction, wherein the first and second directions define a plane that is normal to the long axis of the bolt portion at least in the second position that the end portion may rotate to after piercing the sheathing. A square shape may be used in a polygonal embodiment wherein the square is rotatable about the long axis by an acute angle less than 90°, e.g., 30° or 45°. The end portion of the sheathing anchor may rotate about an axis normal to the long axis of the bolt portion, or about the long axis, or a combination thereof, to secure the mounting foot to the roof sheathing. This sheathing anchor [12] could be coupled to a threaded bolt [13] using a threaded collar or other means in certain embodiments.

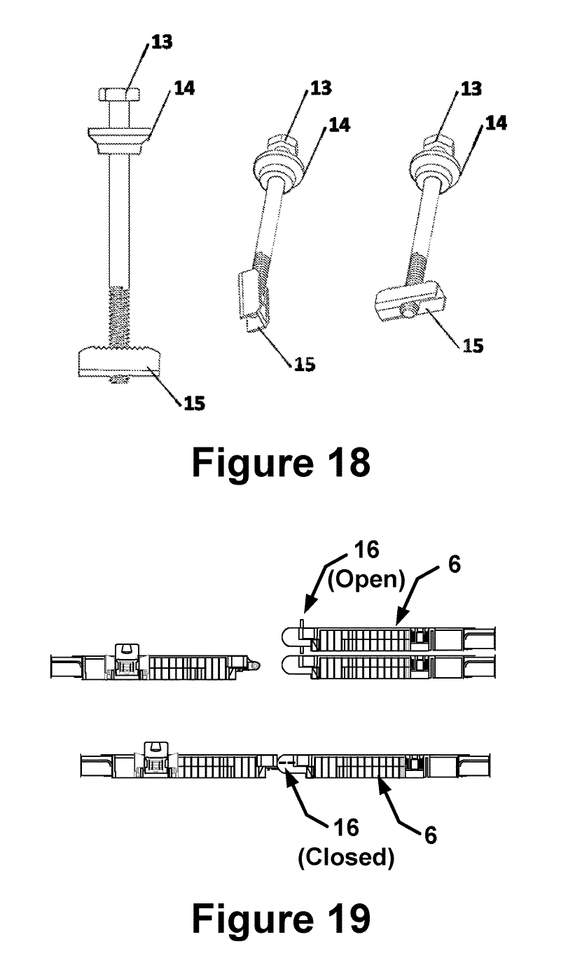

In FIGS. 17 and 18, another embodiment of a sheathing anchor is schematically illustrated.

FUNCTION: Functions of a sheathing anchor in accordance with certain embodiments may include the following:

A sheathing anchor in accordance with certain embodiments may be designed to mount to plywood, wood, fiberboard, drywall or other sheet materials, including those in a wet environments.

The operation of the sheathing anchor may have a minimal number of steps and a low user skill level for successfully securing a mechanical component to a pitched or vertical surface.

A sheathing anchor in certain embodiments may insert into a pilot hole and get tightened with the attached threaded bolt without any interruption in the operation of the anchor and bolt, such as the anchor or end portion spinning uncontrollably about the bolt portion.

The sheathing anchor [15] may be either sprung open or sprung closed depending on the particular application [FIG. 17 and FIG. 18].

COMPOSITION: The sheathing anchor can be made from any mechanically appropriate material that can resist corrosion inherent in an exterior application like a pitched roof or vertical application. Typically materials with such characteristics could be stainless steel or galvanized steel. In certain embodiments, the material composition may form an integral plug [14] which may include a compliant material that could also have material characteristics to deflect, prevent and resist water infiltration. Some materials of the sheathing anchor may include rubber, EPDM and other natural and synthetic materials.

CONFIGURATION: The dimensions of the sheathing anchor can vary depending on the specific solar panel's physical characteristics and mechanical requirements. The sheathing anchor therefore can take any number of sizes (lengths or diameters) or configurations.

The sheathing anchor's toggle [15] may have barbs or teeth or other features to secure it from spinning when the user is driving a bolt into the toggle.

The sheathing anchor's toggle [15] may have an integral threaded barrel or collar to attach to a standard hex bolt (e.g. ⅜″ or ¼″ bolt).

The assembly of the sheathing anchor includes an integral plug [14] to hold the sheathing anchor assembly in place while the user drives the bolt [13] into the toggle [15] (and to provide a secondary waterproofing barrier).

The sheathing anchor's toggle portion [15] or end portion [15] or anchor portion [15] may employ a spring feature to hold the toggle anchor a minimal number of degrees from the centerline of the bolt [13], e.g., for easier inserting through the hole as in the second image of the example of FIG. 18.

The sheathing anchor's toggle, end or anchor portion [15] may employ a spring feature to stay fully open—as in the first and third images of FIG. 18, e.g., to become fully seated against the penetrated material after the toggle pushes through the pilot hole.

STACKING FEATURES: This solar module system, in accordance with certain embodiments, can, in some cases, benefit from modules transported safely and securely with minimal risk of damage during shipping and handling. To that end, the solar module system, in accordance with certain embodiments, can have the following characteristics:

(a) Bumpers and other features to protect the module corners and other exposed edges. In FIG. 9A and FIG. 9B, the mounting bracket [6] has male [7] and female [8] coupling mechanisms and an anchor support system [9]. Each of these elements have components that may have specific features designed to keep the module edge safe from abrasion and damage.

(b) In addition to bumpers, the mounting bracket design provides functional elements to support the stacking of direct anchoring solar modules for shipping.

COMPOSITION: The stacking and protection features of the direct anchoring solar module system may be incorporated into the mounting bracket [6] design and could be composed of the same materials as the mounting bracket [6] (previously defined).

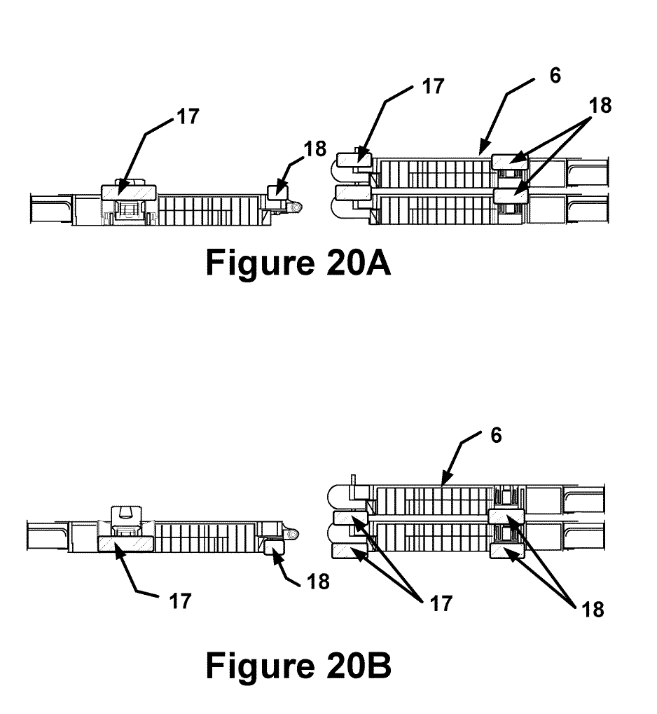

CONFIGURATION: The dimensions of the stacking and protection features of these embodiments may vary depending on the specific solar panel's physical characteristics and mechanical requirements. The stacking and protection features therefore can take any number of sizes or configurations. As illustrated in FIGS. 20A and 20B, the stacking blocks may be configured above or below the mounting bracket. Specifically, the following attributes are known:

At one or more points on the mounting bracket [6] a feature may exist for a second mounting bracket from a module above to rest on the subject mounting bracket.

The stacking and protection feature system may mechanically support the same or greater number of modules per pallet as existing standard modules and their stacking features support per pallet.

The stacking and protection features could be incorporated into the snap lock [16] as shown in FIG. 19 or into the male coupling [18] or female coupling [17] as shown in FIG. 20A and FIG. 20B.

INTEGRATED ELECTRICAL COUPLING: This solar module system, in accordance with certain embodiments, can have the following characteristics:

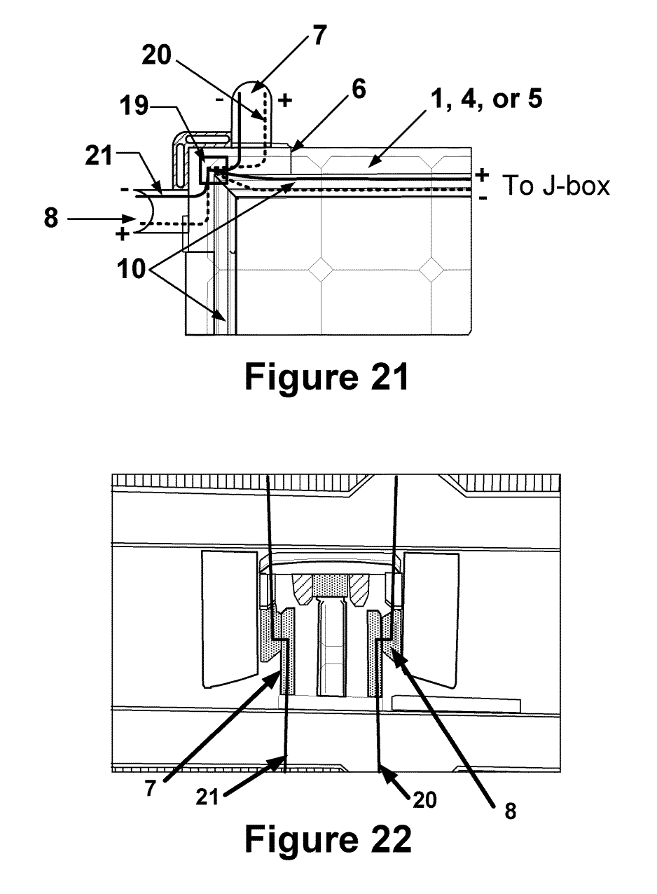

Routing of electricity collected by a solar module [1, 4 or 5] through the track [10] to each corner adjacent to the junction box on each solar module, see FIG. 21.

Per FIG. 21, Distribution of that electricity through positive (“+”) conductors [20] and negative (“−”) or neutral conductors [21] to energize the male [7] and female [8] mechanical couplers for conducting electricity between adjoining solar modules. An electrical control box or junction box [19] may be employed to route electricity to positive (“+”) conductors [20] and negative (“−”) or neutral conductors [21].

Joining electrical conductors [20, 21] from different solar modules through the mechanical couplers [7, 8] inherent in the direct anchoring solar module mounting brackets [6] (in FIG. 21).

COMPOSITION: The integrated electrical coupling features of the direct anchoring solar module system may be incorporated into the mounting bracket [6] design and would be composed copper or other electrically conductive wire or material and integrated into the same materials as the mounting bracket [6] (previously defined).

CONFIGURATION: The dimensions of the integrated electrical coupling features may vary depending on the specific solar panel's electrical and mechanical characteristics. The integrated electrical and/or mechanical coupling features therefore can take any number of sizes or configurations. Specifically, one or more of the following attributes may be included in certain embodiments:

Electricity may be conducted from the electrical junction box on the solar module, through the tracks [10] and mounting brackets [6] to adjacent solar module [1, 4, or 5]. An electrical control box or junction box [19] may employed to join positive (“+”) conductors [20] and negative (“−”) or neutral conductors [21] to energize the male [7] and female [8] mechanical couplers for conducting electricity between adjoining solar modules.

One embodiment illustrated in FIG. 22, is the routing of electricity through the male and female couplers. Both positive (“+”) conductors [20] and negative (“−”) or neutral conductors [21] are integrated into the mechanical couplers [7, 8] and form a positive junction at the intersection of the male [7] and female [8] connectors. In this embodiment, an electrical plug or end cap may be utilized to enclose the ends of the positive (“+”) conductors [20] and negative (“−”) or neutral conductors [21] when an adjacent module is not connected at that mechanical coupler [7 or 8].

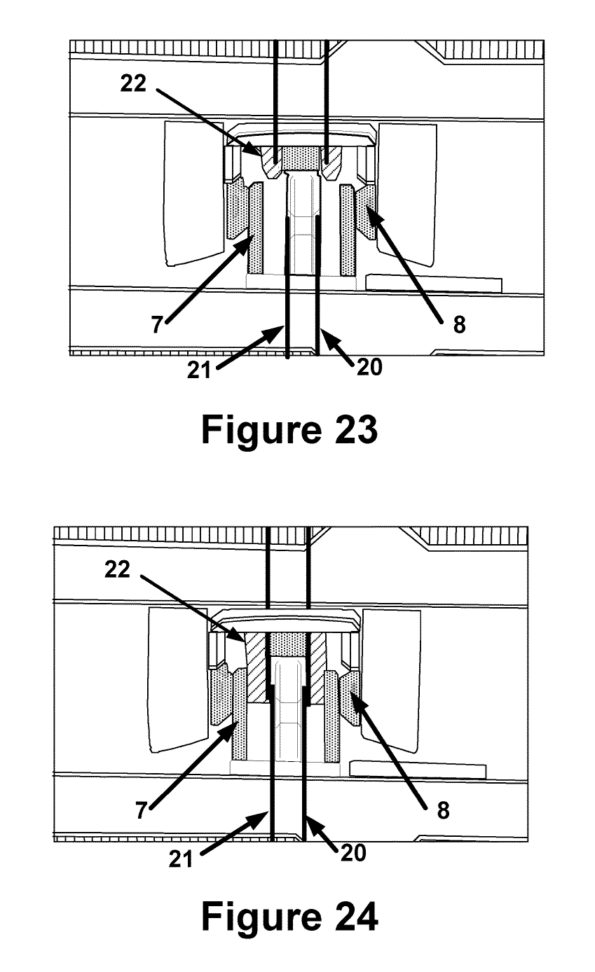

One embodiment illustrated in FIGS. 23 and 24, is the routing of electricity through the snap lock and center bumpers adjacent to both male [7] and female [8] mechanical couplers. These FIGS. 23 and 24 illustrate an electrical conduction through center bumper of the male coupler [7] and the snap lock [22] to electrically connect with adjacent modules. Both positive (“+”) conductors [20] and negative (“−”) or neutral conductors [21] are integrated into the center bumper of the male mechanical coupler [7] and the snap lock [22]. When the snap lock [22] is closed (as in FIG. 24), a positive junction of both the positive (“+”) conductors [20] and negative (“−”) or neutral conductors [21] is achieved. In this embodiment, an electrical plug or end cap may be utilized to enclose the ends of the positive (“+”) conductors [20] and negative (“−”) or neutral conductors [21] when an adjacent module is not connected at the mechanical coupler [7 or 8].

FOOT ANCHORING SOLAR MODULE SYSTEM: This solar module system, in accordance with certain embodiments, can have one or more of the following characteristics:

Anchoring to the “sheathing strong points” and the roof rafters or roof trusses is performed not though the mounting bracket [6] but through mounting feet [23] that are attached to the tracks [10].

Mounting feet have considerable versatility in certain embodiment for adjustment along the length of the module to couple to sheathing strong points and/or roof rafters and/or roof trusses.

Mounting feet [23] may have a locking mechanism in certain embodiments to permanently or temporarily secure the mounting foot [23] to the track [10]. This mechanism may offer a quick release feature to rapidly connect and disconnect the mounting foot [23] from the track.

COMPOSITION: A foot anchoring solar module system in accordance with certain embodiments may incorporate a mounting bracket [6], tracks [10] and mounting feet [23] and may be composed of similar materials as the direct anchoring solar module system.

CONFIGURATION: The dimensions of the foot anchoring solar module system may vary depending on the specific solar panel's physical characteristics and mechanical requirements. The foot anchoring solar module system, therefore can take any number of sizes or configurations.

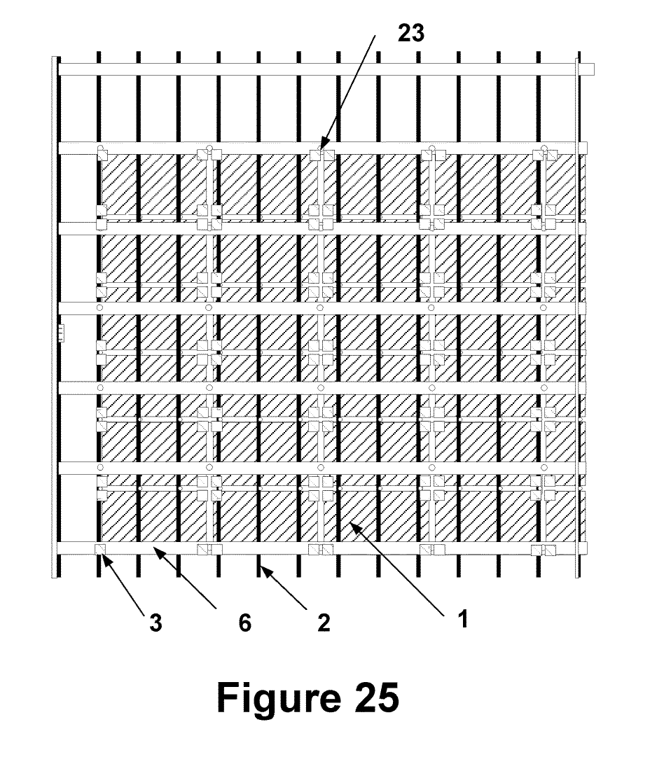

As schematically illustrated in the example of FIG. 25, a foot anchoring solar module system may attach to a sheathing strong point [3] using an assembly of mounting brackets [6], stiffening components (“tracks”) [10] and mounting feet [23] integrated in preassembly with solar power modules [1] in portrait orientation as in FIG. 25 or alternatively in landscape orientation, or at some acute angle therebetween.

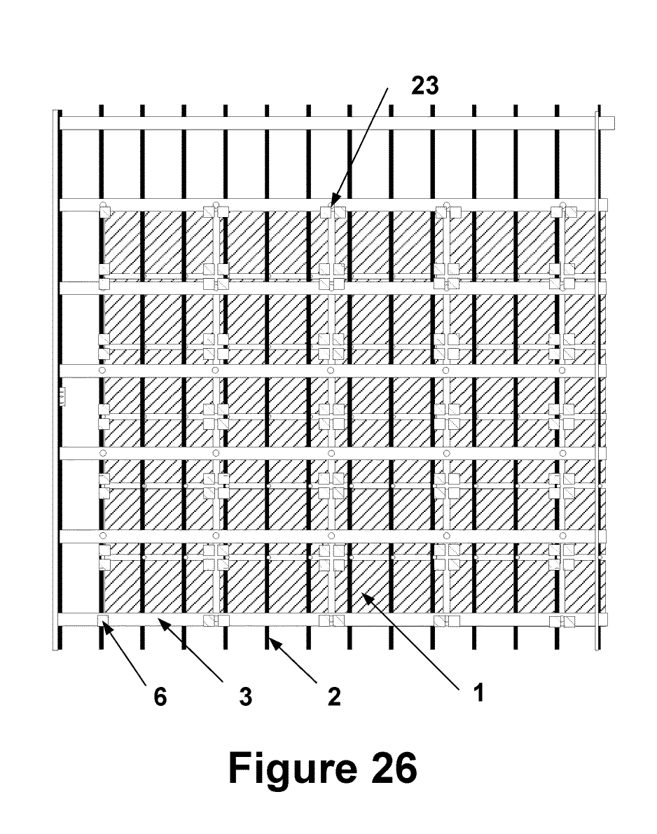

As described in FIG. 26, a foot anchoring solar module system may attach to sheathing strong points [3] using an assembly of mounting brackets [6], stiffening components (“tracks”) [10] and mounting feet [23] integrated with standard solar power modules [1] in, e.g., landscape orientation.

INSTALLATION: The installation of a foot anchoring solar module in accordance with certain embodiments may be similar to the direct anchoring solar module system and/or may include one or more differences.

An installation process may use standard solar power modules [1] or customized solar power modules with preassembled tracks, brackets and/or mounting feet that may be of a standard or selected geometry.

An attachment point for the sheathing anchor or other fastener may be through a mounting foot [23] or through a mounting bracket [6] or through a combined mounting foot/bracket.

An installation process of a solar panel module array may include a reduced number of steps, particularly when integrated, preassembled solar panel modules are used. A sample process may include:

i) attaching a mounting foot to a track coupled to a solar panel in its approximate location with the module on the ground, or

ii) adjusting the mounting foot in preassembly or on the roof or both to align with the flashing location, or

iii) adjusting the mounting foot for optimal or preferred height of the module off the roof (optional), or combinations of i), ii) and/or iii).

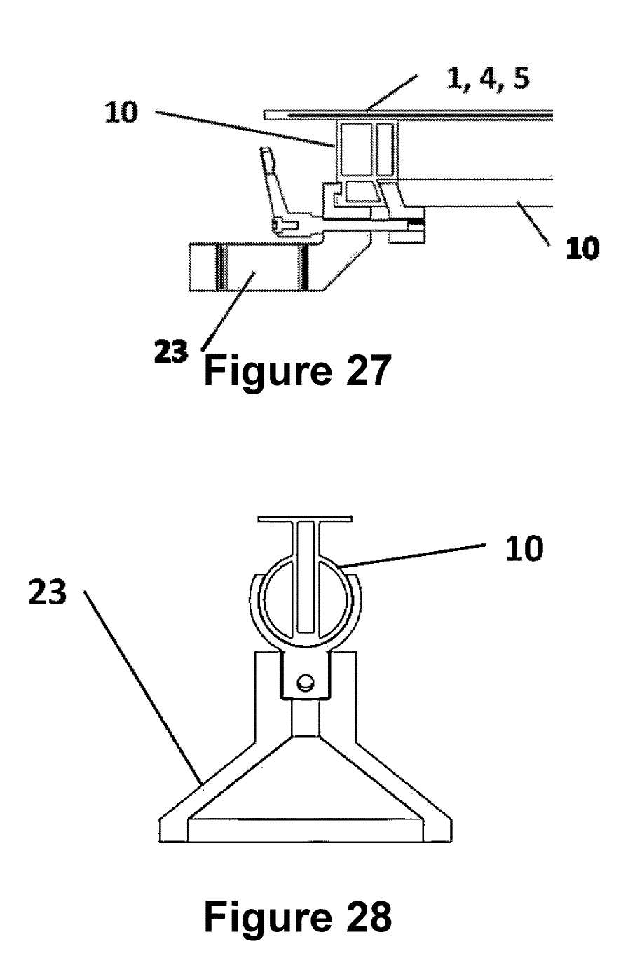

FIG. 27 schematically illustrates an example embodiment of the mounting foot [23].

FIG. 28 schematically illustrates another example embodiment of the mounting foot [23].

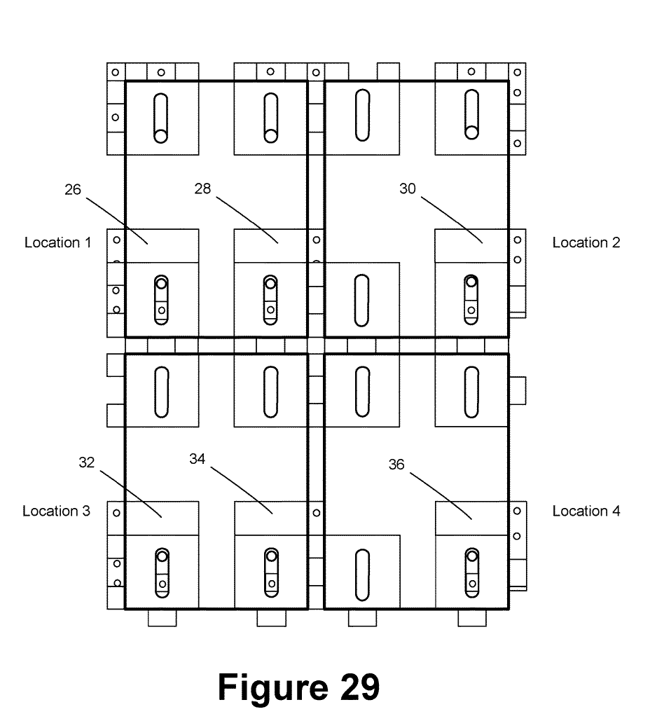

FIG. 29 schematically illustrates a composite shingle roof application. An array of four (4) modules is illustrated in FIG. 29. The modules are interleafed and/or otherwise interlocked with corresponding adjacent modules at location 1, 2, 3 and 4 with anchoring feet in adjusted position.

FIG. 29 schematically shows a composite shingle roof application with an example array of 4 modules, interleafed or otherwise interlocked with corresponding adjacent modules at locations 1, 2, 3 and 4, with anchoring feet in adjusted positions to align with variations in dimensions of exposed shingle courses of composite shingle type roofing materials.

In this example, anchoring mounting feet disposed in standard positions do not align well with the exposed shingle courses. The example embodiments illustrated in FIG. 29 include adjustments of the relative positions of the mounting brackets and the mounting feet in the plane of the solar panel in the obverse dimension to align with the roof coursing 26, 28, 30, 32, 34, 36. Different manufacturers or different models of coursed roofing systems, including composite shingle roofs, shake roofing, and flat tile roofing, e.g., offer a variability in the size of their exposed courses. This adjustment in the up slope and down slope dimension allows the mounting feet to sit in the center of the exposed roofing course. This mounting foot adjustment in the up slope and down slope dimension may be utilized in certain embodiments to fit the mounting foot in the center or within a band that straddles a centerline of a roof sheathing architecture and/or an exposed roof course to increase the reliability of the waterproofing between the mounting foot and the flashing or roofing system. This ability to adjust the mounting foot positioning along an elongated track or a slot in a mounting bracket or otherwise relative to the solar panel permits adjustment depending on a variability of the roof structural component architecture and exposed coursing to ensure that the mounting feet overlap sheathing strong points between trusses or rafters or overlap trusses or rafters or combinations thereof and/or to lay evenly on the roof flashing for a secure waterproofing seal under each mounting foot.

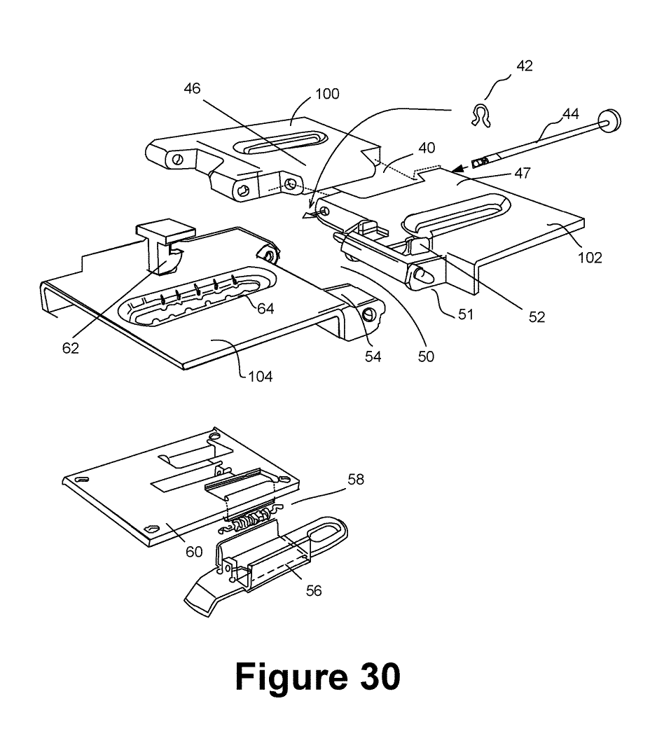

FIG. 30 schematically illustrates a mounting bracket assembly in accordance with certain embodiments.

FIG. 30 illustrates a mounting bracket assembly that includes a number of specific components, including three mounting brackets 100, 102 and 104, and connection mechanisms A40 and B 50, among other features that will be described. Mounting Brackets 100 and 102 are configured to connect using connection mechanism A [40] which employs a hinged mechanism with an external locking pin [42] and connecting pin [44] which feeds through the positive or protruding connector feature [46] in mounting bracket 100 and negative or recess connector feature [47] in mounting bracket 102 to secure both brackets together.

Mounting bracket connection mechanism B [50] includes a hinged mechanism with connecting pins [51] internally housed in the positive or protruding connector feature. The connecting pin is spring loaded to remain in the closed position shown [50]. These connecting pins can be opened using the pull tabs [52] at the top of the positive or protruding connector feature of mounting bracket 102. In operation, the connecting pins may be fed through the negative or recessed connector feature [54] in mounting bracket 104 to create a secure connection between the adjacent mounting brackets.

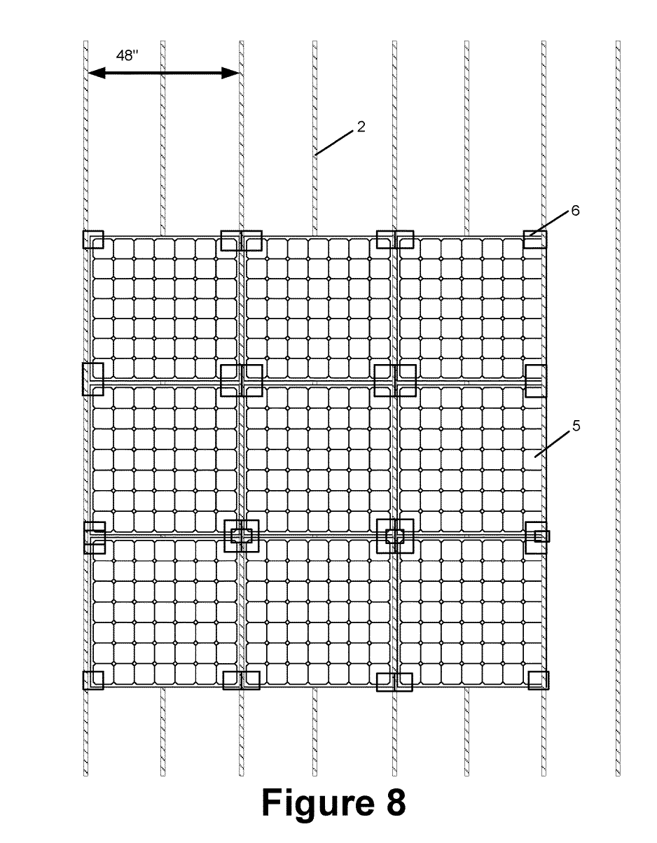

A quick release mechanism in accordance with certain embodiments as illustrated in FIG. 8 includes a quick release adjustment lever [56], an adjustment lever spring [58], a quick release plate [60], and a quick release latch [62]. This mechanism makes it possible for the mounting foot to adjust with respect to the mounting bracket and to release during installation or during operations for maintenance. The ability for the Mounting Bracket to Mounting Foot connection to quickly connect and easily release provides an important feature for service workers or facility managers to easily remove a frameless interlocking module without removing or adjusting or compromising an adjacent frameless module. Mounting bracket 104 is shown with a de-tented slot [64] that allows for the quick release latch [62] to precisely adjust the quick release plate [60] (which is attached to a mounting foot). This adjustment enables the mounting feet to align and maintain a specific relationship with the roof or fixed structure.

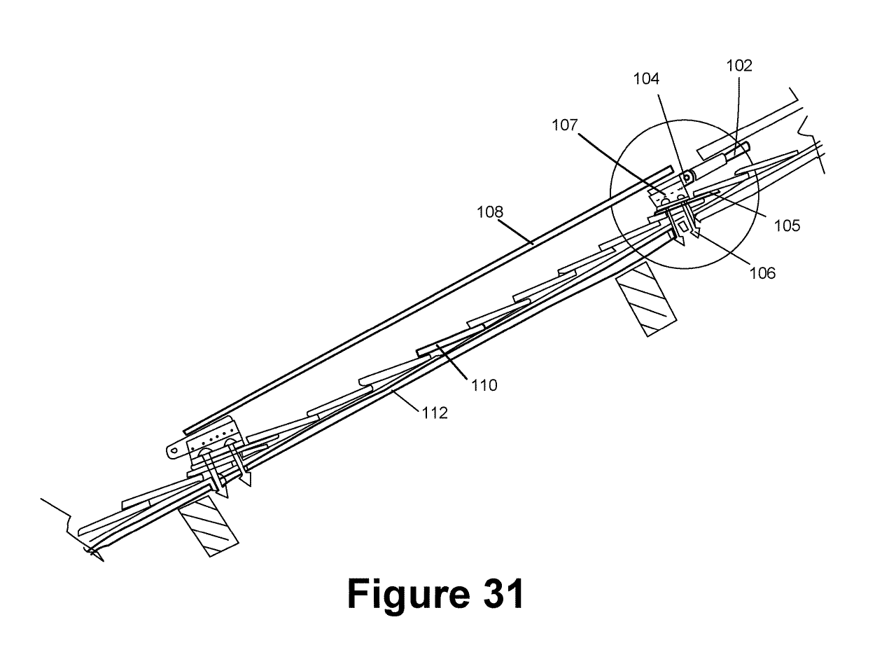

FIG. 31 illustrates a side view of solar panel assembly in accordance with certain embodiments.

FIG. 31 illustrates a side view of a solar panel assembly setting forth an overall environment for a full assembly that is particularly configured for installation on a composite shingle roofing system.

The embodiment of FIG. 31 includes mounting brackets 102 and 104, roof flashing 105, anchors through anchoring mounting feet 106, mounting foot 107, solar panel (typical) 108, roofing material (e.g., composite shingle or shake) 110, and roof sheeting (e.g., plywood or the like) 112. The assembly (in the circle in FIG. 9) is mounted on the roofing material with the flashing [105] serving as a base for the mounting foot [107] and the mounting brackets [102] and [104]. The solar panel [108] is adhered to the top of the mounting bracket [104]. The anchors [106] are securing the mounting foot [107] by penetrating the flashing [105], the roofing material [110] and roof sheeting [112].

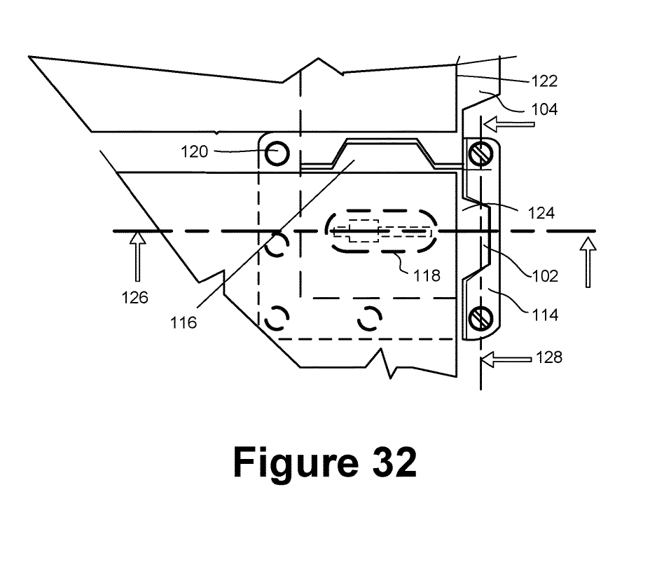

FIG. 32 illustrates a plan view of solar panel assembly in accordance with certain embodiments. FIG. 32 illustrates a mounting bracket and a mounting foot assembled under a solar panel in accordance with certain embodiments.

The mounting bracket and mounting foot assembly illustrated in FIG. 32 include a solar panel [122] and adjacent solar panel [124], and mounting brackets [104 and 102] that are interlocked at bracket connection point [116].

Mounting foot [114] is shown in FIG. 32 under solar panel [124] with dashed lines indicating shape and features of mounting foot not otherwise visible from above the solar panel.

Quick release assembly [118] is shown under solar panel [124] with dashed lines indicating shape and features of a mounting foot not otherwise visible from above the solar panel.

An example through hole anchor point [120] is shown visible between the solar panels 122 and 124.

SECTION A [126] cuts through the assembly in the midpoint.

SECTION B [128] cuts through the assembly through the anchor points of mounting foot [114].

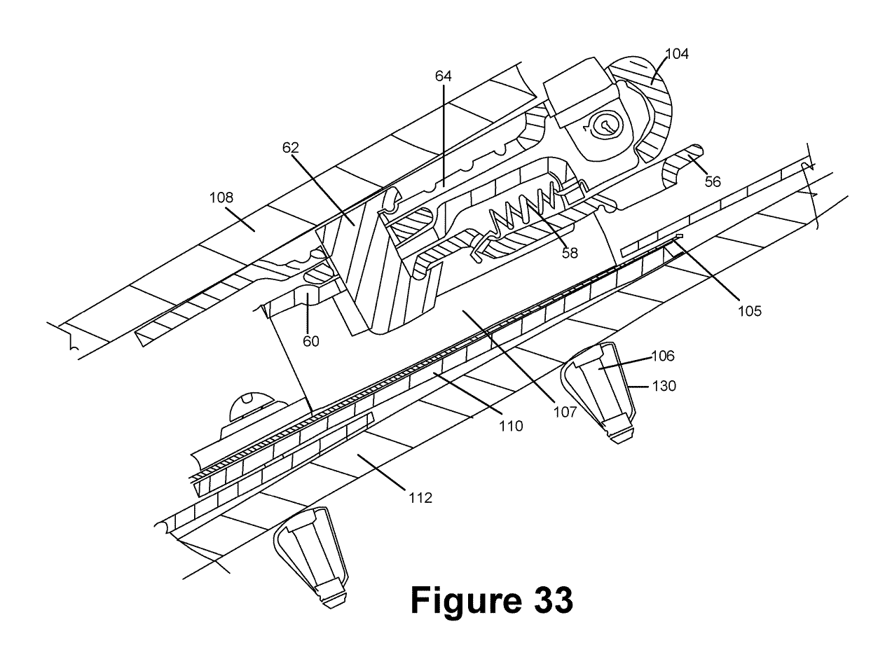

FIG. 33 illustrates a cross-sectional view along section A of FIG. 32. FIG. 33 Illustrates mounting bracket 104, roof flashing 105, anchors through anchoring mounting feet 106, mounting foot 107, solar panel 108, roofing material (e.g., composite shingle or shake) 110, and roof sheeting (e.g., plywood or the like) 112, The assembly is mounted on the roofing material [110] with the flashing [105] serving as a base for the mounting foot [107] and the mounting bracket [104]. The solar panel [108] is adhered to the top of the mounting bracket [104]. The anchors [106] are securing the mounting foot [107] by penetrating the flashing [105], the roofing material [110] and roof sheeting [112].

The anchors [106] may be uniquely designed to provide strong pull out resistance by employing hollow wall anchor features [130] in which the anchor expands due to force exerted on the head of the anchor by the installation tool (e.g. a drill, screwdriver or other such device). The anchors [106] may also have features on the tip of the anchor to automatically drill a starter or pilot hole as the anchor is being rotated by the installation tool.

The section illustrated by FIG. 33 also includes a quick release mechanism including the quick release adjustment lever [56], the adjustment lever spring [58], the quick release plate [60], and the quick release latch [62]. This mechanism makes it possible for the mounting foot to adjust with respect to the mounting bracket and to optionally release during installation or during operations for maintenance.

The mounting bracket 104 in this example includes a de-tented slot [64] that allows for the quick release latch [62] to precisely adjust the quick release plate [60] (which is attached to a mounting foot). This adjustment enables the mounting foot to align and maintain a specific relationship with the roof or fixed structure.

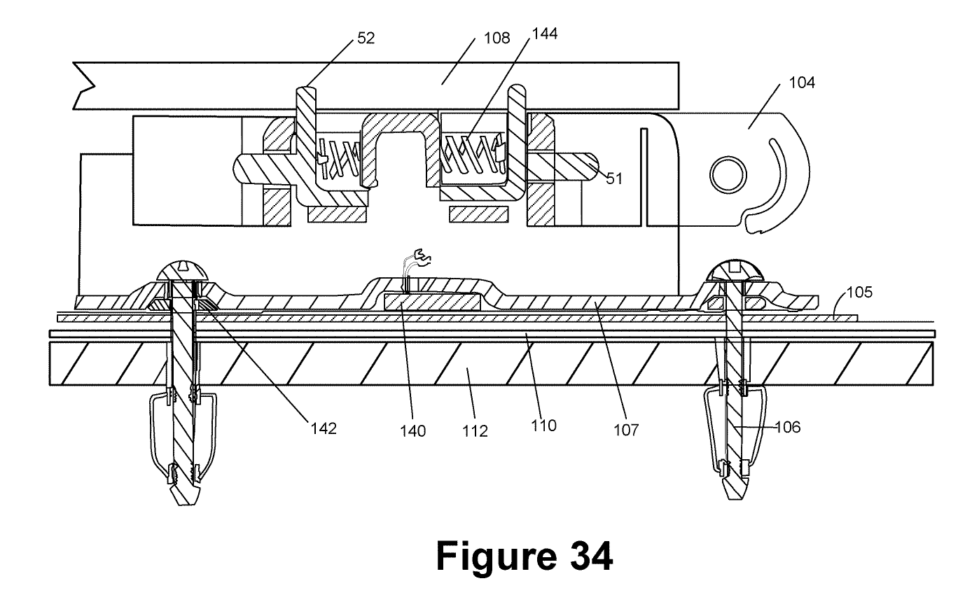

FIG. 34 illustrates a cross sectional view through Section B of FIG. 32. FIG. 34 includes mounting bracket 104, roof flashing 105, anchors through anchoring mounting feet 106, mounting foot 107, solar panel 108, roofing material (e.g., composite shingle or shake) 110, and roof sheeting (e.g., plywood or the like) 112.

A solar panel module assembly is shown in FIG. 34 in accordance with certain embodiments mounted on the roofing material [110] with the flashing [105] serving as a base for the mounting foot [107] and the mounting bracket [104] in this example. The solar panel [108] is adhered to the top of the mounting bracket [104]. The anchors [106] are securing the mounting foot [107] by penetrating the flashing [105], the roofing material [110] and roof sheeting [112].

The section illustrated in FIG. 34 includes mounting connection B (from FIG. 30) which is a hinged mechanism with connecting pins [51] internally housed in the positive or protruding connector feature. The connecting pin is spring loaded [144] to remain in the closed position shown. These connecting pins [51] can be opened using the pull tabs [52] at the top of the positive or protruding connector feature of mounting bracket 102. In operation, the connecting pins will feed through the negative or recessed connector feature in an adjacent mounting bracket to create a secure connection between adjacent mounting brackets.

FIG. 34 also details the waterproofing material [142] that protects the holes penetrating the flashing [105] and the roofing material [110] from water infiltration. The waterproofing material is installed or adhered under each attachment point on the mounting foot [107] in the factory as a gasket or ring or reservoir of sealing material. Sealing material may be EPDM, butyl, butyl rubber, neoprene or the like formed into a geometry that seals around the hole in the flashing created by the anchor.

FIG. 34 also describes an optional mounting foot radio frequency transmitter and sensor assembly [140]. These “mounting sensors” 140 are electronic measuring devices that measure one or more physical characteristics of the bottom surface of the mounting foot (such as compressive pressure) and transmit that information along with other relevant information using wireless radio frequencies to a receiver. These mounting sensors [140] are attached under the mounting feet such that they may read the compressive force between a mounting foot and a roof flashing.

A mounting sensor [140] may be located on the bottom of, or otherwise below, a mounting foot, adjacent to an anchor point holding the mounting foot to the structure. The sensor 140 may be a ring-shaped sensor (e.g., round with an open middle area) that is positioned such that the anchor penetrates through the opening, like a bolt through a washer. The water proofing material sealant gasket (EPDM, butyl or buytl rubber, neoprene) may be disposed interior or exterior to the sensor ring. The mounting foot may be located under the solar panel. Alternatively, the mounting sensor [140] may be located adjacent to the anchor points but not as a ring around each anchor.

Each sensor may be passive, i.e., without an internal power source, e.g., without a battery, or may include a battery-assisted passive circuit, i.e., having a battery to increase the signal strength of the sensors.

The mounting sensors 140 may use advanced radio frequency identification (RFID) technology including but not limited to ultra high frequency (UHF), high frequency, Bluetooth standard or other applicable communications protocol for transmitting their pressure (or other readings) and their unique identifier.

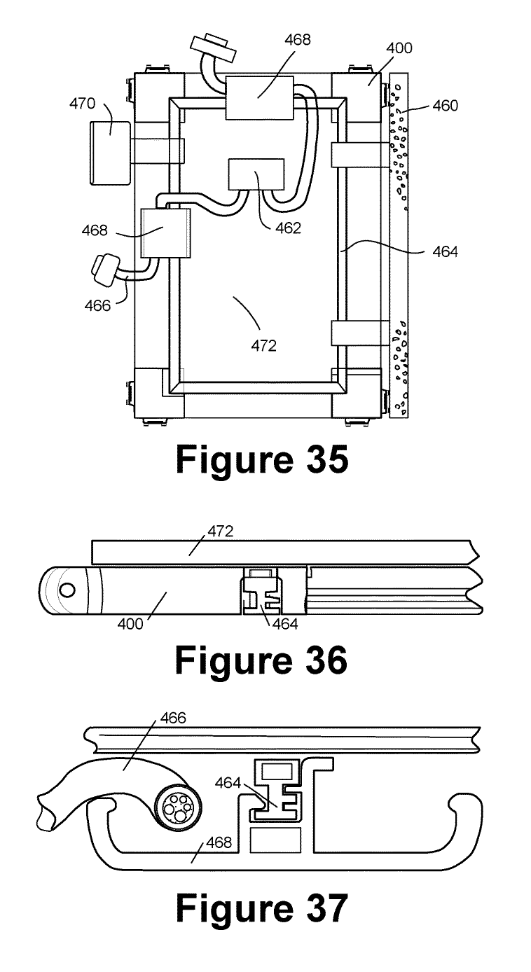

FIG. 35 illustrates a back view or bottom view or view from the other side of a preassembled solar panel than the previously illustrated embodiments in accordance with additional embodiments. An interlocking mounting system for solar panels in accordance with certain embodiments may include a platform to facilitate the reliable and quick installation of integrated solar modules. The interlocking mounting system illustrated in FIG. 35 includes an integrated solar panel [472], four mounting brackets [400], mounting feet (not shown in FIG. 35), panel tracks [464] and various accessories to create an “Interlocking Module.” These accessories may include:

a) Cable Trays [468] designed to secure, hold and convey AC cables [466] running from a panel-mounted inverter [462].

b) Panel-mounted inverter [462] which converts direct current power produced by the Solar Panel to alternating current power.

c) Transition box [470] which connects the AC cables [466] from the panel-mounted inverter to the branch circuit running to an AC disconnect (not shown) and the building's electrical panel (not shown).

d) A set of wind deflectors [460] serves to deflect wind and protect the array from debris buildup under the array and preventing rodent or bird nesting under the array while allowing ventilation under the Solar Panel [472].

Each mounting bracket [400] is attached to a Solar Panel [472] and has a female or recessed connector tab [420] and a male or protruding connector tab [440] that interconnect and interlock with corresponding Connector Tabs on adjacent Mounting Brackets on Interlocking Modules. This interlocking of adjacent Interlocking Modules occurs without separate or additional hardware.

On each module, the Interlocking Mounting System may include an assembly of Mounting Brackets [400], Panel Tracks [464] and/or accessories attached to the Panel Track. Panel Tracks, cable trays and/or transition boxes may be made of extruded or molded non-conductive material.

A preliminary configuration step for this Interlocking Mounting System for Solar Panels will be performed in a controlled, manufacturing environment and involves using a chemical adhesive to attach a set of four (4) Mounting Brackets [400], and Panel Tracks [464] to the back of a Solar Panel [472]. A secondary configuration step may include attaching Mounting Feet to Mounting Bracket [400] and attaching accessories to the Panel Track [464]. This secondary configuration step can be performed in a controlled, manufacturing environment or on the project site or both.

Accessories may include:

a) Cable Trays [468] which can be clipped on to the Panel Tracks and be moved along the Panel Track.

b) Panel-mounted inverter [462] which can be adhered to the backsheet of the Solar Panel (as shown) or attached to the Panel Track (see FIG. 39).

c) Transition box [470] which can be attached to the Panel Track (as shown) or to a Mounting Bracket Male or protruding Connector Tab or Female or recessed Connector Tab.

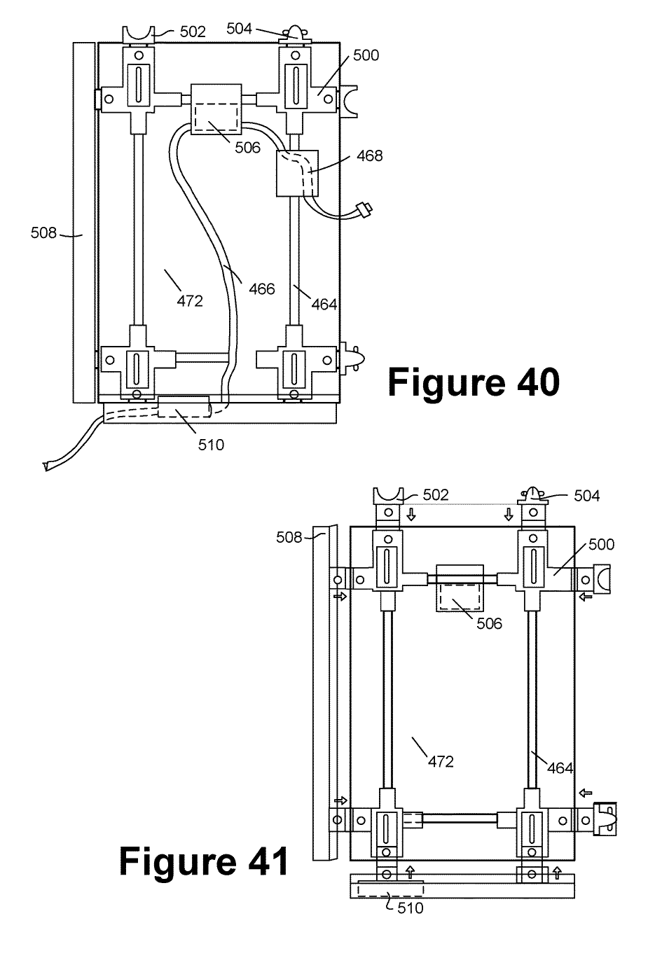

d) A set of wind deflectors [460] along the perimeter of the array can be connected to the Panel Track as shown here, or connected directly to each Mounting Bracket (see FIG. 40) on the perimeter of the array.

FIG. 36 Section of Panel Track with Mounting Bracket beyond

FIG. 36 shows a section through a Panel Track [464]

Panel Tracks [464] may serve to support the Solar Panel [472] between Mounting Brackets [400] in certain embodiments. Panel Tracks also serve as attachment points for accessories as found in FIG. 31.

Panel Tracks [464] may be extruded non-conductive, UV resistant and structural material designed to withstand the dynamic forces on a Solar Panel and the torque exerted by the accessories attached (as shown in FIG. 35).

Each Panel Track [464] may be connected into a Mounting Bracket [400] as illustrated in the example embodiment of FIG. 36. The Panel Track can be isolated or chemically bonded with an adhesive to the solar panel [472] which it supports.

FIG. 37 illustrates a Section through Cable Tray hanging on Panel Track.

FIG. 37 illustrates a section through a Panel Track [464] and a Cable Tray [468].

The Cable Tray [468] serves to guide and manage solar panel cables [466] to keep them organized, secure and off the roof surface.

Cable Tray [468] is manufactured from non-conductive, UV resistant and structural materials extruded into a specific profile to provide the structural and mechanical properties involved in securing cables [466].

Cable Trays [468] may be mounted to the Panel Track [464], held by an interconnecting profile details of the Cable Tray [468] and of the Panel Track [464] to interlock and give the trays a secure connection to the Panel Track [464].

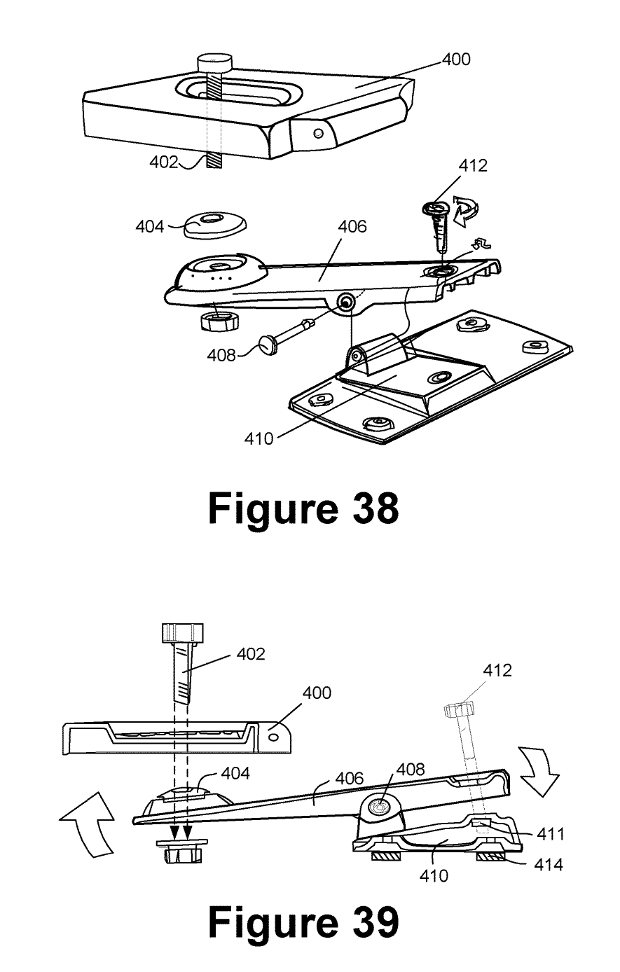

FIG. 38 Mounting Bracket and adjustable Mounting Foot Assembly for pitched roof applications.

In FIG. 38, the Mounting Bracket [400] is shown attaching to an adjustable Mounting Foot Assembly for pitched roof applications.

The function of the Mounting Foot for pitched roof applications is to provide a connection between the fixed pitched roof structure and the Mounting Bracket. In this embodiment, the adjustable Mounting Foot Assembly allows for height adjustment of the Mounting Bracket and therefore height adjustment of the solar panel. This Mounting Foot height adjustment will realize an increase or decrease in the dimension (normal to the roof plane) between the roof and the module face.

The Mounting Foot Assembly may include several molded, non-conductive, UV resistant and structural parts and corrosion-resistant metal hardware including the molded foot [410] which may be connected to the molded pivoting arm [406] through a metal pin [408]. The Mounting Bracket may be connected to the Mounting Foot Assembly through a corrosion-resistant bolt [402] or other connecting mechanism running through a compliant grommet interface [404] that allows the Mounting Bracket and the Mounting Foot Assembly to lie in different planes (as the plane of a roof and the plane of exposed courses of roof shingles vary due to the overlapping of shingle courses.) The Mounting Foot Assembly [404 through 414] are designed for composite shingle, pitched roof applications, but the molded foot [410] can be modified to support other pitched roof applications including but not limited to corregated metal roofing, standing seam metal roofing, concrete tile roofing, slate or shake roofing.

The Mounting Foot Assembly has a height adjustment which is employed in this embodiment through the turning of a metal adjustment screw [412]. This adjustment mechanism allows the height above the roof of the Mounting Bracket [400) and the Solar Panel (not shown) to be adjusted and locked in place.

Intentionally hidden for illustrative clarity is the solar panel that would be attached to the Mounting Bracket [400] in an installed system.

FIG. 39 Section of Mounting Bracket and adjustable Mounting Foot Assembly for pitched roof applications

In FIG. 39, a section of molded Mounting Bracket [400] is shown with the adjustable Mounting Foot Assembly for pitched roof applications. The Mounting Foot Assembly may include several molded plastic parts and metal hardware including a molded foot [410] that is connected to a molded pivoting arm [406] through a metal pin [408].

The Mounting Bracket is connected to the Mounting Foot Assembly for pitched roof applications through a corrosion-resistant bolt [402] running through a compliant grommet interface [404] that allows the Mounting Bracket and the Mounting Foot Assembly to lie in different planes (e.g., as the plane of a roof and the plane of exposed courses of roof shingles vary due to the overlapping of shingle courses.) The function of this Mounting Foot Assembly is to allow for height adjustment of the Mounting Bracket and therefore height adjustment of the solar panel.

The Mounting Foot Assembly [404 through 414] may be manufactured in certain embodiments with a majority or plurality of non-conductive, UV resistant and structural molded materials and corrosion-resistant metal connectors, pins, and screws. The Mounting Foot Assembly [404 through 414] may be designed for composite shingle, pitched roof applications, but the molded foot [410] can be modified to support other pitched roof applications including but not limited to corregated metal roofing, standing seam metal roofing, concrete tile roofing, slate or shake roofing.

As the corrosion-resistant metal adjustment screw [412] lowers the short end of the molded pivoting arm, the longer end of the pivoting arm is raised (thus raising the Mounting Bracket and the attached solar panel.) The through-hole sealant [414] is shown below the formed holes [411] in the Mounting Foot molded foot [410]. The Mounting Bracket is connected to the Mounting Foot Assembly through a bolt [402], or other connecting mechanism running through a compliant rubber grommet interface [404]. Intentionally hidden for clarity is the solar panel that would be attached to the top of the Mounting Bracket [400]. Also, intentionally hidden in FIG. 38 is the flashing and roof structure which would both reside below the molded foot [410].

FIG. 40 schematically illustrates an example interlocking mounting system for solar panel modules with configurable mounting brackets (Back View) in accordance with certain embodiments.

The Interlocking Mounting System integrates the Solar Panel [472], Mounting Brackets, Bases, Female Connector Tabs [502] and detachable Male Connector Tabs [504] [500], Mounting Feet, Panel Tracks [464] and various accessories to create an Interlocking Module.

The function of this Interlocking Mounting System for Solar Panels with configurable Mounting Brackets draws on same or similar functionality as described in FIG. 35 and provides a flexible configuration of Mounting Brackets due to each Mounting Bracket having a detachable Female Connector Tab [502] and detachable Male Connector Tab [504]. With respect to interconnecting and interlocking Solar Panels together, the functionality of the detachable Female Connector Tab [502] and detachable Male Connector Tab [504] may be identical or similar to the a Female Connector Tab [420] and Male Connector Tab [440]. Like in FIG. 35, a number of accessories can be attached to the interlocking Mounting System, including the, the track-installed inverter [506], the wind deflector [508], the cable tray [468] and the transition box [510].

Each Mounting Bracket Base [500] may be attached to a Solar Panel [472] and may have a detachable Female Connector Tab [502] and a Male Connector Tab [504] that interconnect and interlock with corresponding Connector Tabs on adjacent Interlocking Modules. This interlocking of adjacent Interlocking Modules occurs without separate or additional hardware. The Panel Tracks [464], Mounting Bracket Bases [500], detachable Female Connector Tab [502] and a detachable Male Connector Tab [504] are all manufactured from non-conductive, UV resistant and structural materials using an extruded, molded or stamped process. These parts may contain components or assemblies of corrosion-resistant metal.

A preliminary configuration step for this Interlocking Mounting System for Solar Panels may be performed in a controlled, manufacturing environment involving use of a chemical adhesive to attach a set of four (4) Mounting Bracket Bases [500], and Panel Tracks [464] to the back of a Solar Panel [472]. A secondary configuration step may involve attaching detachable Female Connector Tabs [502], detachable Male Connector Tabs [504] and Mounting Feet to Mounting Bracket Bases [500] and attaching accessories to the Panel Track [464]. This secondary configuration step can be performed in a controlled, manufacturing environment or on the project site or both.

One or more accessories can be attached to the Panel Track [464] as follows:

a) Cable Trays [468] which can be clipped on to the Panel Tracks and be moved along the Panel Track.

b) Track-installed inverter [506] which can be attached to the Panel Track.

One or more accessories can be attached to the Mounting Bracket Base [500] as follows:

a) A transition box [510] can be attached to the Mounting Bracket base and/or to inside of the wind deflector [508].

b) A set of wind deflectors [508] can be connected directly to each Mounting Bracket Base [500] on each perimeter side of an array.

FIG. 41 illustrates a back or bottom view of an Interlocking Mounting System for Solar Panels—with configurable Mounting Bracket components in use.

The attachment of Mounting Bracket Base-attached components may include attachment of a detachable Female Connector Tab [502] and a detachable Male Connector Tab [504] that may be locked into the Mounting Bracket Base [500]. In addition, the wind deflectors [508] and the Transition Box [510] can be connected directly to each Mounting Bracket Base [500]. The Panel Tracks [464], Mounting Bracket Bases [500], detachable Female Connector Tab [502] and a detachable Male Connector Tab [504] are all manufactured from non-conductive, UV resistant and structural materials using an extruded, molded or stamped process. These parts may contain components or assemblies of corrosion-resistant metal.

A preliminary configuration step for this Interlocking Mounting System for Solar Panels may be performed in a controlled, manufacturing environment involving use of a chemical adhesive to attach a set of four (4) Mounting Bracket Bases [500], and Panel Tracks [464] to the back of a Solar Panel [472]. A secondary configuration step may include attaching detachable Female Connector Tabs [502], detachable Male Connector Tabs [504] and Mounting Feet to Mounting Bracket Bases [500] and attaching accessories to the Panel Track [464]. This secondary configuration step can be performed in a controlled, manufacturing environment or on the project site or both.

Accessories can be attached to the Panel Track [464]:

a) Cable Trays [468] which can be clipped on to the Panel Tracks and be moved along the Panel Track.

b) Track-installed inverter [506] which can be attached to the Panel Track.

Accessories can be attached to the Mounting Bracket Base [500] as required:

a) Transition box [510] which can be attached to the Mounting Bracket base and or attached to inside of the wind deflector [508].

b) A set of wind deflectors [508] can be connected directly to each Mounting Bracket Base [500] on each perimeter side of an array.

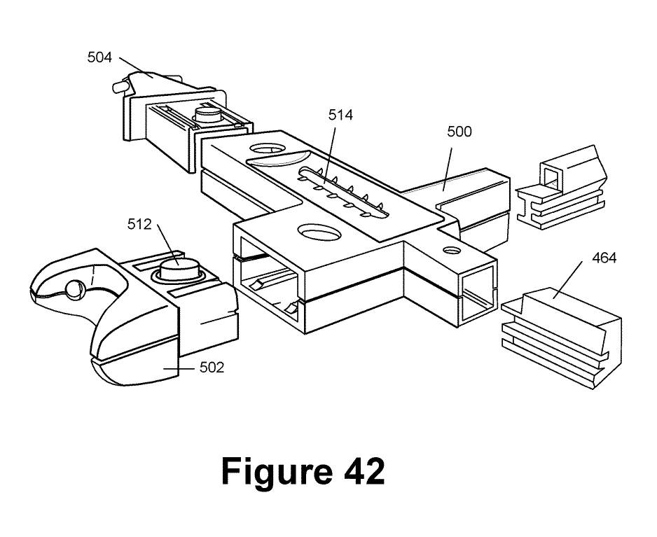

FIG. 42 illustrates a further embodiment or second embodiment including an example Configurable Mounting Bracket Assembly in an exploded view.

The Configurable Mounting Bracket in this further embodiment includes a detachable Female Connector Tab [502] and detachable Male Connector Tab [504]. With respect to interconnecting and interlocking Solar Panels together, the functionality of the detachable Female Connector Tab [502] and detachable Male Connector Tab [504] are identical to the a Female Connector Tab [420] and Male Connector Tab [440] in that they allow for two adjacent Solar Panels to interconnect and interlock without separate hardware. In addition each detachable Female Connector Tab [502] and detachable Male Connector Tab [504] includes a sprung pin [512] mechanism that holds them secure to the Mounting Bracket Base [500], yet allows workers in the field to easily detach or attach the Connector Tabs [502, 504]. The Mounting Bracket Base [500] can accept and connect to various compatible Mounting Feet designed for different mounting applications, several of which are described in this application.

The Mounting Bracket Base [500] may include or couple to or be configured to integrate with a detachable Female Connector Tab [502] and a detachable Male Connector Tab [504], e.g., as illustrated in the example of FIG. 42, which are manufactured from non-conductive, UV resistant and structural materials using an extruded, molded or stamped process. These parts may contain components or assemblies of corrosion-resistant metal or non-conductive, UV resistant and structural materials.

The Female Connector Tab [502] and detachable Male Connector Tab [504] have a sprung pin [512] which secures these Connector Tabs to the Mounting Bracket Base [500]. The Panel Tracks [464] also connect to the Mounting Bracket Base [500] at two locations to bridge between Mounting Bracket Bases and support the Solar Panel [472] which is not shown in FIG. 42. The Mounting Bracket Base [500] includes a special connector slot [514] to support an adjustable Mounting Foot connection and a compliant material of various Mounting Feet. These parts can be assembled in a controlled, manufacturing environment or in the field.

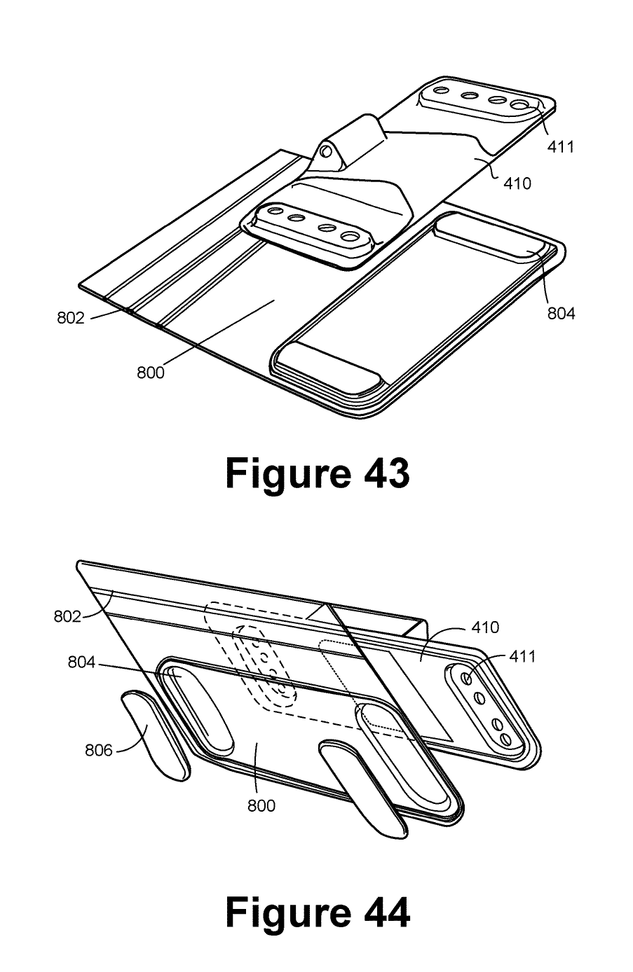

FIG. 43 Adjustable Mounting Foot Assembly and Flashing for pitched roof applications.

FIG. 43 details the adjustable Mounting Foot Assembly and Flashing for pitched roof applications.

FIG. 43 adds details of the molded foot [410] at the bottom of the adjustable Mounting Foot Assembly and the Fitted Flashing [800] which aligns to the bottom of the molded foot [410]. As roofing shingle exposed courses vary in size from approximately 4 inches to 8 inches, the Fitted Flashing [800] may have break off tabs [802] on the up slope edge of the flashing, allowing workers to adjust the size of the Fitted Flashing [800] to fit under the shingle course above the exposed course where the molded foot [410] will be installed. In addition, the Fitted Flashing may have raised areas [804] that align with the bottom of the molded foot [410] and prevent water runoff down the flashing to infiltrate the penetrations.

The Fitted Flashing [800] may be manufactured using sheet metal die stampings, in stainless or aluminum or galvanized metal. The Fitted Flashing [800] may have break off tabs [802] on the up slope edge of the flashing. In addition, the Fitted Flashing may have raised areas [804] that align with the bottom of the molded foot [410]. The molded foot [410] will have attachment points or formed holes [411] in the unit to accept standard screw anchors or self-drilling wood anchors.

The Fitted Flashing [800] will be placed on the pitched roof under composition shingle courses immediately above the attachment point where a Mounting Foot Assembly will be attached to the roof. After the Fitted Flashing [800] is installed on the roof, the molded foot [410] would be placed on top of the raised areas [804] of the Fitted Flashing [800]. Then a standard screw anchors or self-drilling wood anchors may be driven through the attachment points or formed holes [411] and through the Fitted Flashing [800].

FIG. 44 schematically illustrates a bottom view of an example adjustable Mounting Foot Assembly and Flashing for pitched roof applications.

FIG. 44 details the bottom view of adjustable Mounting Foot Assembly and Flashing for pitched roof applications.

FIG. 43 details the molded foot [410] at the bottom of the adjustable Mounting Foot Assembly and the Fitted Flashing [800] which aligns to the bottom of the molded foot [410]. This FIG. 44 details the bottom of the Fitted Flashing [800] which shows a volume of waterproofing material [806] placed below each of the raised areas [804] of the Fitted Flashing [800]. This waterproofing material [806] will serve as an additional barrier to water infiltration for any anchors installed through the attachment points or formed holes [411] in the molded foot [410].

Also, a little bead may be provided around the perimeter for an added layer of protection to prevent micro wicking.

Refer to FIG. 43 for composition of the Fitted Flashing [800]. FIG. 44 illustrates waterproofing material [806] which may be a natural or synthetic rubber, butyl rubber, EPDM rubber, elastomer or other waterproofing material in a liquid, tape, pad or other form.

Referring to FIG. 43 for configuration of The Fitted Flashing [800] with the Mounting Foot Assembly molded foot [410], in the installation of an adjustable Mounting Foot Assembly, standard screw anchors or self-drilling wood anchors will be driven through the attachment points or formed holes [411], through the Fitted Flashing [800] and through the waterproofing material [806]. The waterproofing material [806] will coat each anchor and provide a seal against the pitched roofing material.

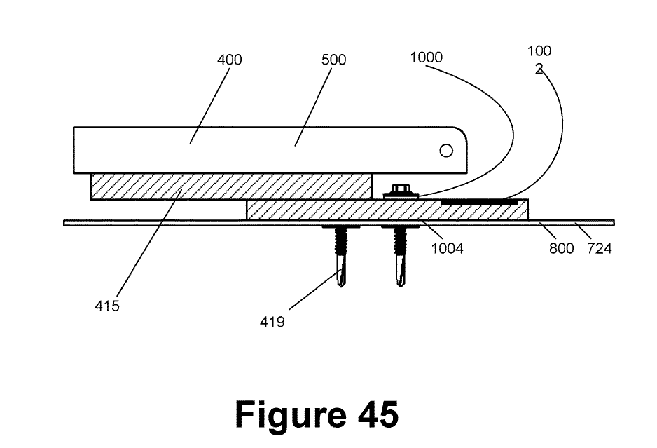

FIG. 45 shows the details of the optional integral sensors and transmitter at mounting feet for validating compression of mounting feet indicative of secure integrated module installation.

FUNCTION:

FIGS. 38, 39, 43, and 44 describe example embodiments of the Mounting Foot [415] designed for composite shingle applications and connects to the Mounting Bracket [400] or Mounting Bracket Base [500]. U.S. patent application Ser. No. 14/521,245, which is incorporated by reference, describes several example embodiments of self-drilling wood anchors that may be used to secure the Mounting Foot [415]. FIG. 45 describes the sensors and transmitters that may be integrated into the wood anchors and or the Mounting Foot to allow for electronic validation of the anchoring of the Mounting Foot [415]. The compressive sensor (in location A [1000] or location B [1004] will validate that the anchors were properly installed and are providing the minimum mechanical compressive pressure to meet or exceed the waterproofing and structural loading specifications. With a minimum compressive pressure at each anchor point, waterproofing and structural attachment are provided. The Mounting Foot [415] may contain a radio frequency transmitter [1002] that can be read by a remote mobile device.

COMPOSITION: The Mounting Foot assembly may contain a pressure sensor either in location A, a ring around the screw anchor [1000], or location B, integrated into the bottom of the mounting foot [1004]. The pressure sensors [1000 or 1004] may be attached adjacent to the anchor point where an anchor is driven through the mounting foot [415], into the flashing [724] or Fitted Flashing [800], roofing material (not shown) and into the roofing substrate (not shown). The anchor [419] exerts force against the mounting foot which in turn exerts force against the integral waterproofing ring and roof flashing. The pressure sensors [1000 or 1004] measure the compressive pressure between the mounting foot and the roof flashing [1004] or screw anchor head and the mounting foot [1000] to confirm the compliance to the waterproofing and structural anchor installation specifications.

The Mounting Foot [415] may contain a radio frequency transmitter [1002] located on the top or near the top of the Mounting Foot [415] that would communicate with a remote mobile device using one communication protocol or a plurality of communication protocols including but not limited to high frequency (HF), ultra-high frequency (UHF) or Bluetooth standards. These transmitters may be either passive (having no internal power source and not sending a signal on regular intervals) or active (having their own internal power source and sending a signal on regular intervals. A similar system of sensors and transmitters may be employed at other connection points including the mounting bracket to mounting bracket or the mounting bracket to mounting foot connections.

A mobile electronic device (such as a mobile phone, tablet or specialty radio frequency reader) can read signals originating from each transmitter [1002] and confirm the compressive pressure meets a minimum value for the specific application.

The software code or application on the mobile device may collect one or more of user entered information, photographic images, the longitudinal and latitudinal location from the mobile device global positioning system sensor, the radio frequency transmitter signals including compressive pressure compliance, a unique identifier for each transmitter and any other relevant information. The information collected by the mobile device may be communicated to remote computing devices and machines using Internet protocols—either in real-time (if a network signal exists on the mobile device) or at a later time (when the network signal is available or when the mobile device is connected to an Internet connected computer).

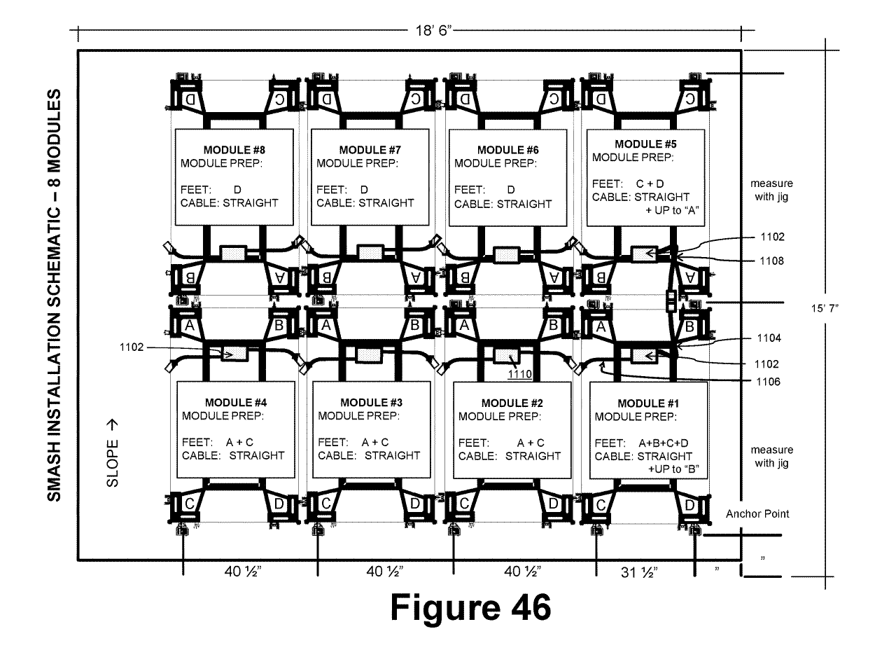

FIG. 46 schematically illustrates an embodiment including eight installed solar panels coupled together in 4×2 arrangement. Two rows of four solar modules are shown in the example of FIG. 46. Modules 1-4 are higher on the roof than modules 5-8. Various numbers of modules can be installed, including a single module or any number of multiple modules that may each be stand alone or coupled together in groups of two or more. Each preassembled solar module in accordance with certain embodiments can be coupled to another preassembled solar module at either or both long sides and/or at either or both short sides. Thus, for example, a 3×3 arrangement may be installed, where a center module is coupled to an adjacent solar module at each of its four sides.

In the example of FIG. 46, module 1 is installed to the roof by coupling each of its four preassembled mounting brackets to one or four mounting feet. The mounting feet may be coupled to the mounting brackets in preassembly or at the site prior to coupling the solar module to the roof. In another embodiment, one or more mounting feet may be coupled to the roof prior to coupling with a mounting bracket of a solar module that is being installed.

An electrical box 1102 is included with the solar module 1. The electrical box 1102 has cables 1104 and 1106 coupled electrically thereto and extending each toward an adjacent solar module. In FIG. 46, cable 1104 is turned so that it can connect to cable 1108 of module 5, while cable 1106 is a straight cable that connects to cable 1110 of module 2. Cable 1108 is also turned to connect with cable 1104, as modules 1 and 5 are end modules in the example arrangement of FIG. 46. The cables of modules 2-4 and 6-8 are each straight like cable 1106 of module 1.

The electrical box 1102 of module 1 is coupled to one of the two short tracks (among the four tracks that are arranged to form a smaller rectangular shape than the solar panels themselves: two of the four tracks are long and the other two tracks are short, the two rectangular shapes being approximately in proportion in FIG. 46). Similar electrical boxes are similarly disposed in each of modules 2-4, i.e., coupled to the short tracks that is lower on the roof than its counterpart. Similar electrical boxes are also disposed in each of modules 5-8, except these are coupled to the short track that is higher on the roof than its counterpart. In this way, the four electrical boxes of modules 1-4 are disposed each closer to adjacent electrical boxes of modules 5-8 than they would be if the electrical boxes included with modules 5-8 were coupled to the other short track that is lower on the roof than its counterpart.

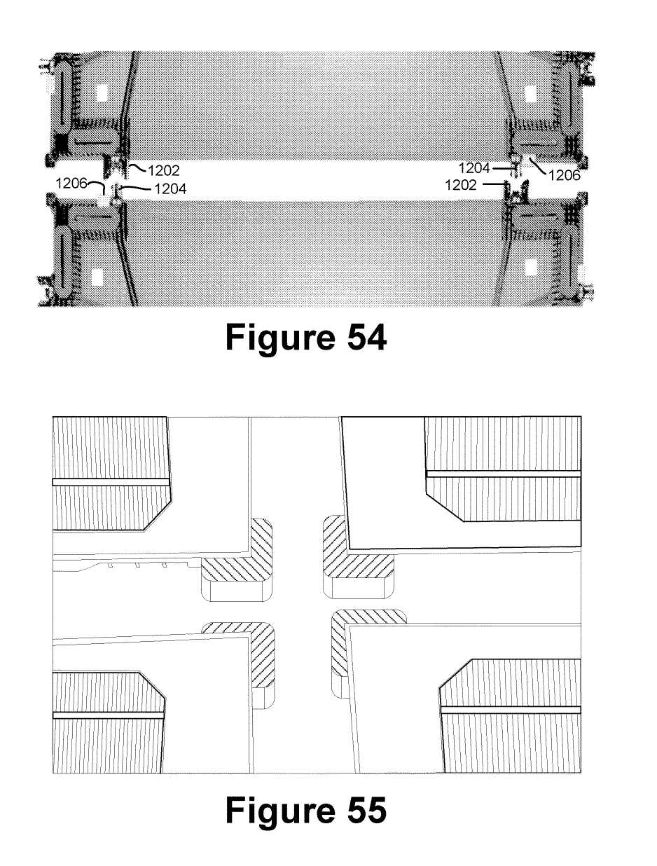

Each solar module illustrated in the example of FIG. 46 has four corners labeled as A, B, C and D, wherein the electrical boxes are disposed closer to corners A and B than to corners C and D. The preassembled bracket at each of corners A, B, C and D of module 1 is coupled to a mounting foot. Only the preassembled brackets at corners A and C of modules 2-4 are coupled to mounting feet, and only the preassembled brackets at corners C and D of module 5, and only the preassembled brackets at corners D of modules 6-8 are coupled to mounting feet in preassembly either at the factory or at the site prior to being affixed, mounted, attached or otherwise connected mechanically to the roof. The mounting brackets that are not coupled to mounting feet, as just identified for the example of FIG. 54, are coupled directly to a mounting bracket of an adjacent solar module.

In the example of FIG. 46, each single mounting bracket that is not coupled to another mounting bracket is preassembled with a mounting foot. Thus, the mounting brackets at corner D of module 1, corner C of module 5, corner D of module 8 and at corner C of module 4 are coupled to mounting feet in preassembly are not coupled with any other mounting bracket in the example of FIG. 46. In addition, each of the mounting brackets at corners A and C of modules 2-4 are preassembled with mounting feet, while each of the mounting brackets B and D of modules 2-4 does not have a mounting feet coupled thereto in preassembly.

In installation, mounting brackets B and D of modules 2-4 are coupled to mounting brackets A and C of an adjacent module rather than directly to the roof via a mounting foot and flashing. Similarly, mounting brackets A and B of modules 5-8 do not have mounting feet coupled thereto in preassembly, and each couples to mounting brackets B and A, respectively, of adjacent modules 1-4. With regard to modules 5-8, module 5 has mounting brackets C and D coupled to mounting feet, while brackets A and B are instead coupled to adjacent brackets, and modules 6-8 are preassembled with mounting feet coupled only to the mounting brackets at corner D for directly coupling to the roof, while the mounting brackets at corners A-C of modules 6-8 are instead coupled to brackets of adjacent modules. In short, wherever two or four adjacent solar module corners couple together in the example of FIG. 46, one mounting bracket (of the two or four) is directly coupled to the roof via a preassembled mounting foot while the other one or three are instead coupled to adjacent mounting brackets. Among the three instances where four corners of four different solar modules meet in the example of FIG. 54, three mounting brackets at the corners A of modules 6-8 are not coupled either (i) to the roof directly via a mounting foot or (ii) to an adjacent mounting bracket that is itself coupled to the roof directly via a mounting foot.

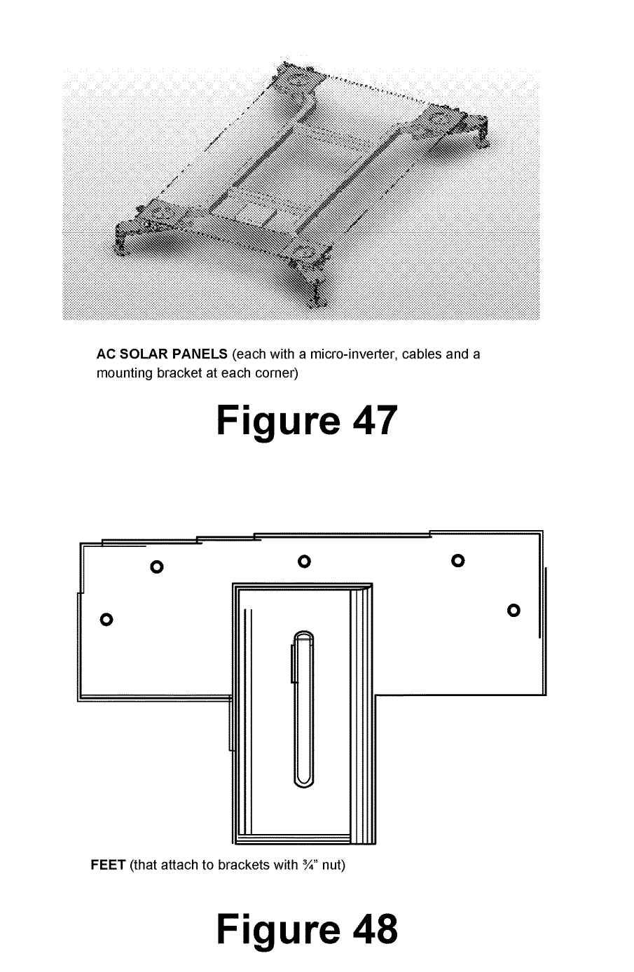

FIG. 47 schematically illustrates a preassembled solar panel including mounting brackets in accordance with certain embodiments.

FIG. 48 schematically illustrates a mounting foot in accordance with certain embodiments.

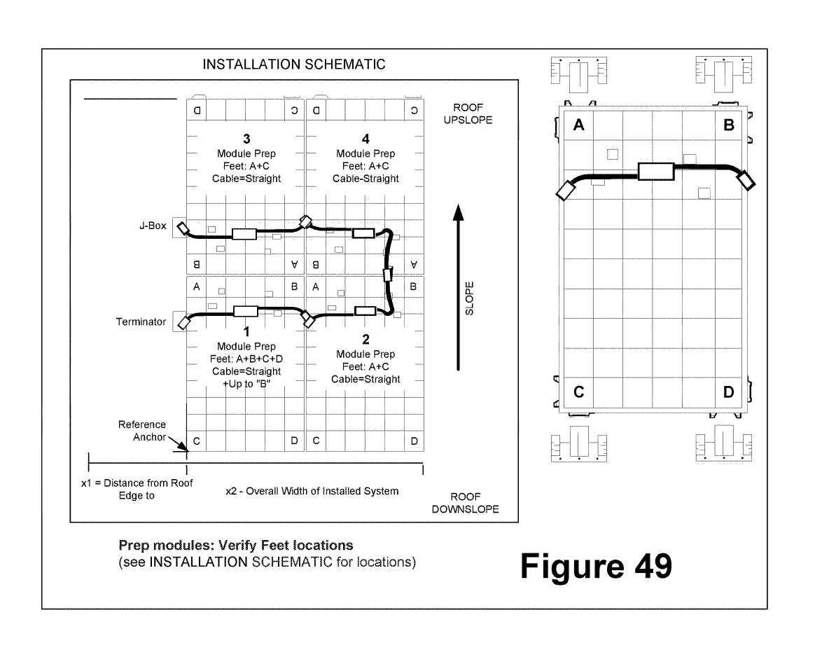

Referring to FIG. 49, Prep modules: Verify Feet locations, e.g., as described and illustrated with reference to FIG. 46.

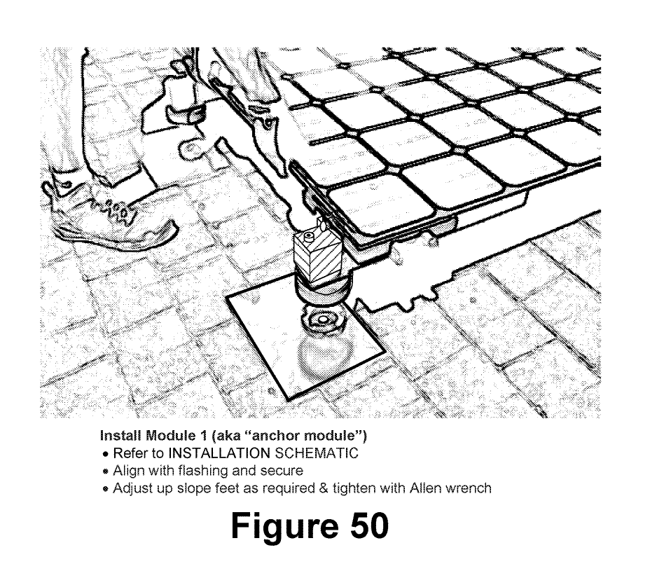

Referring to FIG. 50, Install Module 1 (aka “anchor module”). Align with flashing and secure. Adjust up slope feet as determined & tighten with allen wrench.

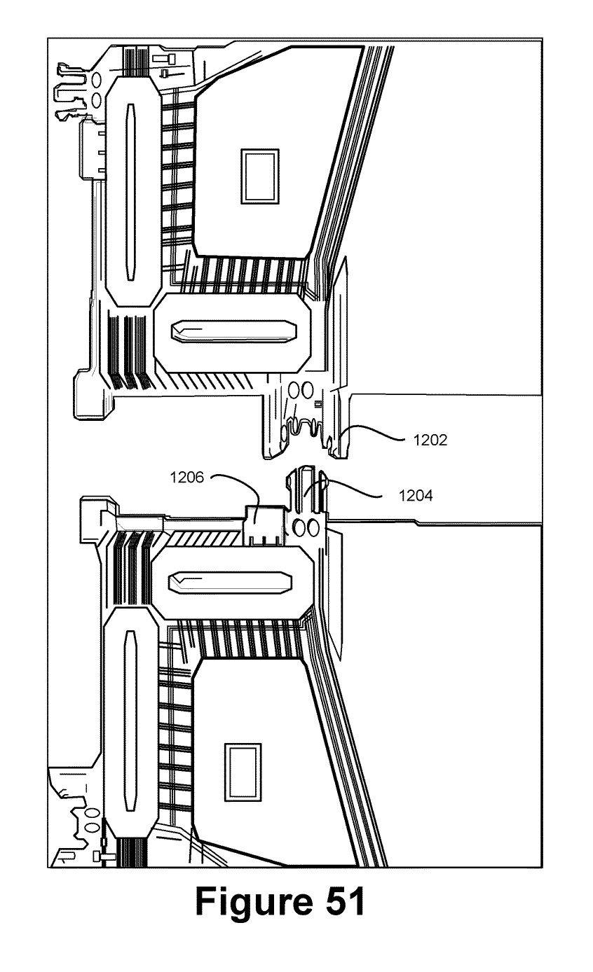

Figures FIG. 51 schematically illustrates a pair of uncoupled solar panel connectors in accordance with certain embodiments. A durable polymer may be used for the connectors, such that when coupling, certain components may bend and to permit a pair of male-female components, or protrusion-recess pairs, to couple together such as to snap into place at points of stable equilibrium where the protrusion just sets into the recess. When adjacent solar modules are brought together including adjacent mounting bracket connector pairs, the angular shapes of the four surfaces of the recess connector component allow imprecision that is compensated when complementary components of the protrusion connector component abut therewith to center to connectors in alignment for snapping together.

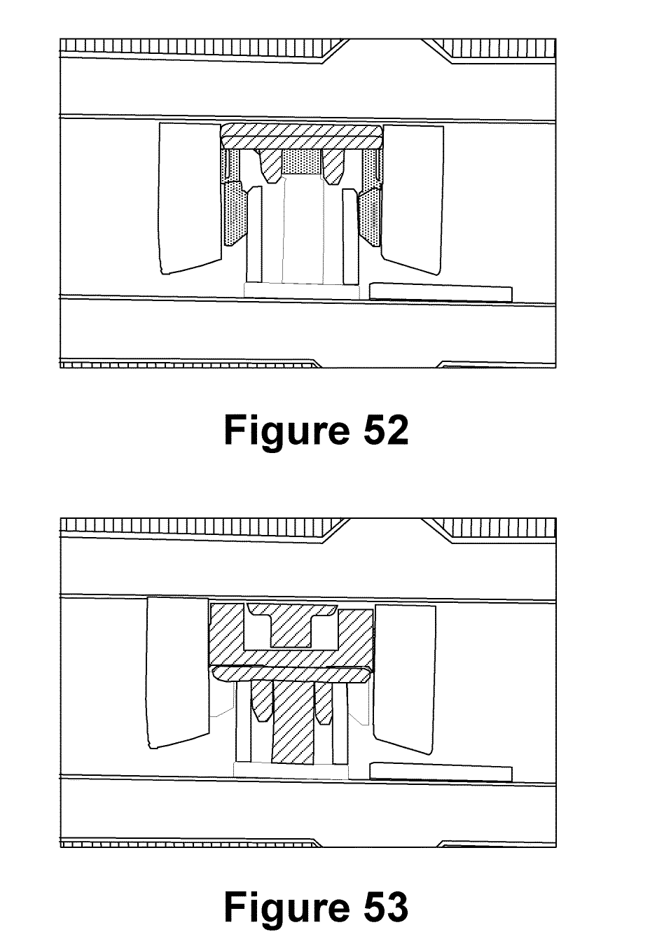

FIG. 52 schematically illustrates a pair of coupled and unlocked solar panel connectors in accordance with certain embodiments. A sliding locking latch is coupled to the recess connector component including a pair of spacer protrusions that are aligned with open spaces on the insides of the protrusion connector components (the protrusions face outward or away from each other in the example of FIGS. 51-53, but these can be reversed).

FIG. 53 schematically illustrates a pair of coupled and locked solar panel connectors in accordance with certain embodiments. After the protrusion and recess connector components are snapped into place, they are locked together securely when the sliding locking mechanism is actuated to bring the spacer protrusions in to fill the open spaces that are apparent in FIG. 52 on the insides of the protrusion connector components after they are snapped into place and thereby coupled with the complementary recess connector components. With the spaces being filled by the spacer protrusions, the protrusion connector components are unable to bend inwardly to uncoupled from the recess. In this way, the coupling of the adjacent mounting brackets is secured by actuating the locking mechanism.

FIG. 54 schematically illustrates a pair of adjacent preassembled solar panel module including two pairs of complementary bracket connectors 1202, 1204 that are not yet coupled together. Each side of a preassembled solar module includes two bracket connectors for coupling with two bracket connectors of an adjacent preassembled solar panel module. The two bracket connectors shown along each side of the two solar panel modules illustrated at FIG. 54 include one of each complementary bracket connectors 1202 and 1204. In alternative embodiments, both can be the same on one side of one solar panel module as long as both connectors on the adjacent solar panel module are also the same and the bracket connectors that are to be coupled together, one from each adjacent solar panel module, comprise a pair of complementary bracket connectors 1202, 1204. Just to the outside of bracket connector 1204 is an alignment bumper 1206 upon which one of the outside segments of bracket connector 1202 can rest as coupling is being performed while preventing contact with the edge of the solar panel.

FIG. 55 schematically illustrates four solar panel corners installed as a 2×2 array or subarray that each include a corner bumper that overlaps in two dimensions. These bumper protect the solar panels from striking the ground along its edges and corners during transport and assembly. In another embodiment, the bumpers overlap the corners both above and below the solar panel, so that preassembled solar panels can be stacked without any components contacting the solar panel surface.

### Example Solar Panel Module System

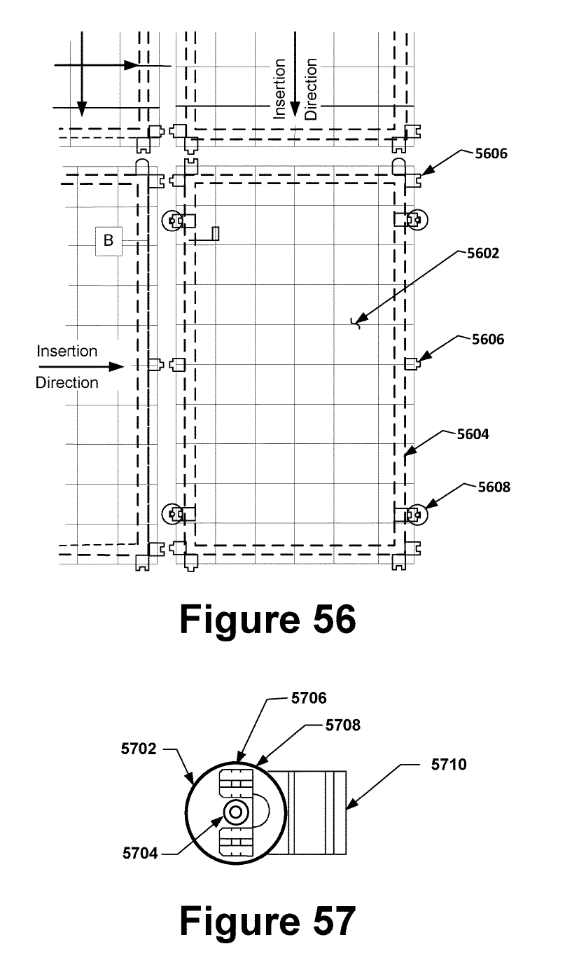

Some embodiments consist of specially designed and fabricated frameless PV modules (5602) assembled with tracks (5604) and connectors (5606) adhered to the back face of the modules (see FIG. 56). The module tracks (5604) tie to existing roof sheathing via feet (5608) pre-assembled with the module tracks before lifting and anchoring to the roof. The feet (5608) consist of a rigid clamping connection (5710) at the top of the foot to the track (5604), and a foot base (5702) with a hinge or pinned connection (5706) (see FIG. 57). A corrosion-resistant sheathing anchor (5704) connects the foot base to the roof sheathing (either plywood or oriented strand board—OSB). This sheathing anchor (5704) extends through the foot base, flashing integrated with the foot base, existing composition or wood shingles, and roof sheathing, with the sheathing anchor engaging the underside of the sheathing.

In these embodiments, the solar modules (5602) measure approximately 39″×65″, and fit together at the corners via male and female-snap connectors (5606), allowing for rapid installation. Snap connectors (5606) may also occur mid-length along the long edges of the modules. The modules (5602) may be set on the roof in “portrait” orientation, that is, with module long edges running upslope/downslope. Feet (are anchored to the track along the long edges of the modules, spaced approximately 48″ apart in the upslope/downslope direction. These embodiments including modules installed in portrait mode have a well-distributed pattern of anchor points, with approximately 40″ cross slope spacing and 48″ upslope spacing that create an average tributary area of 13.3 square feet.

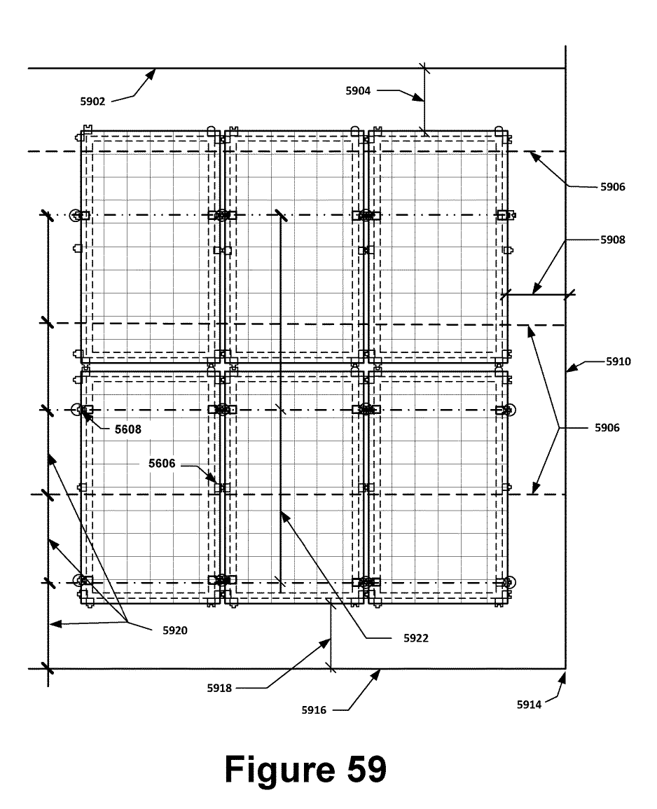

The FIGS. 56, 57 and 58 illustrate the assembly and nomenclature of the various parts of the embodiments. FIGS. 59, 60 and 61 illustrate the allowed module and feet layout patterns in these embodiments.

In FIG. 57, some embodiments of the foot in the system are shown including the foot base (5702), the sheathing anchor (5704), the pinned connection at the foot (5706) to reduce the moment on the foot, the stem of the foot that bridges above the foot base to the rail. Moment forces in mechanical connections can create high stresses in materials. Creating a pinned connection, using an actual pin or other embodiments such as compliant materials, hinged mechanisms, or other means would serve to reduce the moment load at that foot connection.

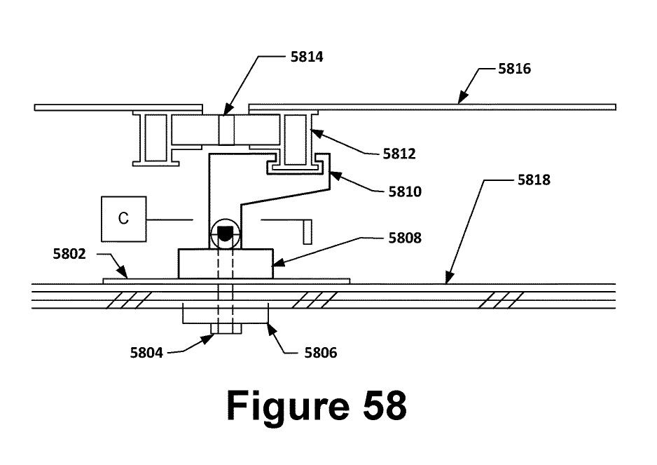

In FIG. 58, we see more embodiments showing a side view of the foot assembly including the foot base (5808), foot leg (5810) that is pinned to the foot base (either with a rigid pin or a compliant material providing flexibility at that point of connection, the track (5812), side snap connections (5814), flashing (5802) and the sheathing anchor (5806)—the blind nut and the hex bolt (5804) mounting the system to the sheathing (5818) and the solar module (5816).

In FIG. 59, we share a drawing of a partial solar panel array as it would be laid out on rooftop. FIG. 59 shows the roof ridge at the top (5902), the ridge edge distance (5904) to top edge of the array, the plywood butt joint at the long edge (5906), the gable edge distance (5908), the gable end (5910), lower corner of the roof (5914), the roof eave (5916), eave edge distance, (5918) and feet locations, The locations of feet are determined by the starting point of the sheathing and the starting point of the first row of modules (characterized by the distance the first row of modules is to the eave edge). In these embodiments, the feet are placed 24″+/−2″ from plywood long edge butt joint. Note: unless otherwise noted, foot spacing up slope shall average 4′-0″. If first foot spacing is slightly less than 4′-0″ then the second spacing shall be slightly more than 4′-0″.

### Mounting Feet Layout

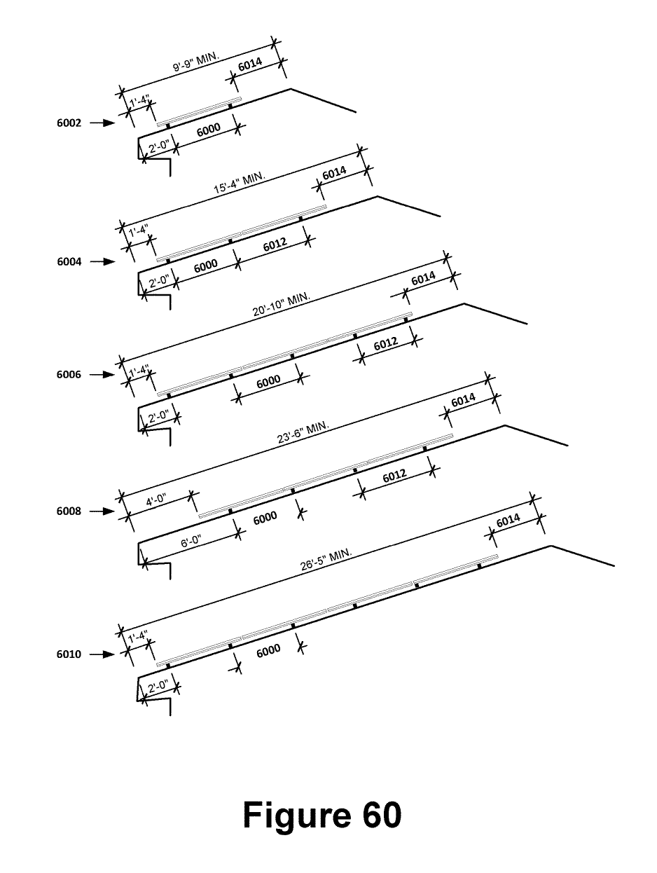

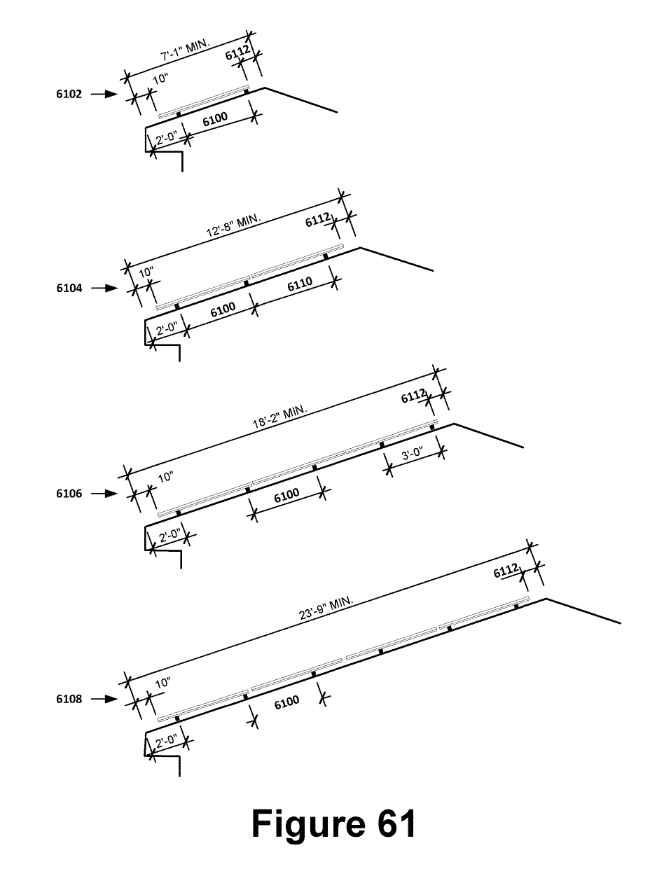

In FIGS. 60 and 61, we explore our embodiments for attaching a pre-assembled solar power mounting system to a sheathing system. Our embodiments allow two roof edge configurations (“Edge16” and “Edge10”) with different distances from the eave (either 16″ or 10″). Under each roof edge configuration, areas of viability differ according to regional framing lumber and sheathing nail size.

In FIG. 60, we explore the Edge16 layout configuration. “Edge16” means that the first row of modules starts with 16″ distance from eave to first module row. Also a 16″ minimum distance from array to gable ends (roof side edge). 36″ minimum distance to array from roof ridge (top edge of roof). In this FIG. 60, we will explore multiple array sizes (e.g. 1 row, 2 rows, 3 rows, etc.)

First we review the Edge16 case with 1 row (6002). In this case, the array begins 16″ from the eave, with the first feet 2′-0″ from the eave edge and the two rows of feet at 4′-0″+/−2″ apart (6000).

Next, we have the Edge16 case with 2 rows of modules (6004). In this case, the array begins 16″ from the eave, with the first feet 2′-0″ from the eave edge and the first row follows exactly the same layout as the first row of 6002, namely two rows of feet at 4′-0″+/−2″ apart (6000). However, the second row's feet are spaced at an exception distance of 4′-6″ apart (6012). This additional spacing is used to reduce the cantilever of the second row of modules.

Third, we have the Edge16 case with 3 rows of modules (6006). In this case, the array begins 16″ from the eave, with the first feet 2′-0″ from the eave edge and the first two rows of modules follow the 4′-0″+/−2″ (6000) spacing. However, the third row's feet are spaced at an exception distance of 3′-4″ apart (6012).

Fourth, we have Edge16 case with 3 rows of modules (6008). In this case, the array begins at 4′-0″ from the eave edge. The first and second rows follow our standard of feet spaced at 4′-0″+/−2″ apart (6000). However, the third row's feet are spaced at 4′-6″ apart (6012). This additional spacing is used to reduce the cantilever of the second row of modules.

Fifth, we have Edge16 case with 4 rows of modules (60010). In this case, the array begins at 16″ from the eave edge. All rows follow our standard of feet spaced at 4′-0″+/−2″ apart (6000). No foot spacing exceptions exist for this case.

In FIG. 61, we explore the Edge10 case, which is similar to the Edge16 case, but the array has a 10″ set distance form bottom edge of array to roof eave (bottom edge of roof). The Edge10 case has 10″ minimum from array to ridge and gable ends.

First we review the Edge10 case with 1 row (6102). In this case, the array begins 10″ from the eave edge, with the two rows of feet at 4′-0″+/−2″ apart (6100).

Next, we have the Edge10 case with 2 rows of modules (6104). In this case, the array begins 10″ from the eave edge, with the first row following exactly the same layout as the first row of 6102, namely two rows of feet at 4′-0″+/−2″ apart (6100). However, the second row's feet are spaced at an exception distance of 4′-8″ apart (6110). This additional spacing is used to reduce the cantilever of the second row of modules.

Third, we have the Edge10 case with 3 rows of modules (6106). In this case, the array begins 10″ from the eave edge and the first two rows of modules follow the 4′-0″+/−2″ (6100) spacing. However, the third row's feet are spaced at an exception distance of 3′-0″ apart (6110).

Fourth, we have Edge10 case with 4 rows of modules (6108). In this case, the array begins 10″ from the eave edge. All rows follow our standard of feet spaced at 4′-0″+/−2″ apart (6100).

### Sheathing Anchorage Test Summary

Unlike conventional PV support systems that anchor to roof rafters with lag screws first, the embodiments proposed include array feet (also known as stand-offs, mounts, or supports) fastened to roof sheathing with sheathing anchors. Under wind uplift, the feet pull up on the sheathing, which in turn pull up on the sheathing nails that fasten into the roof rafters. The tests below determine the ultimate and allowable loads of this sheathing anchorage as a function of the location of the feet in relation to sheathing edges and underlying rafters.

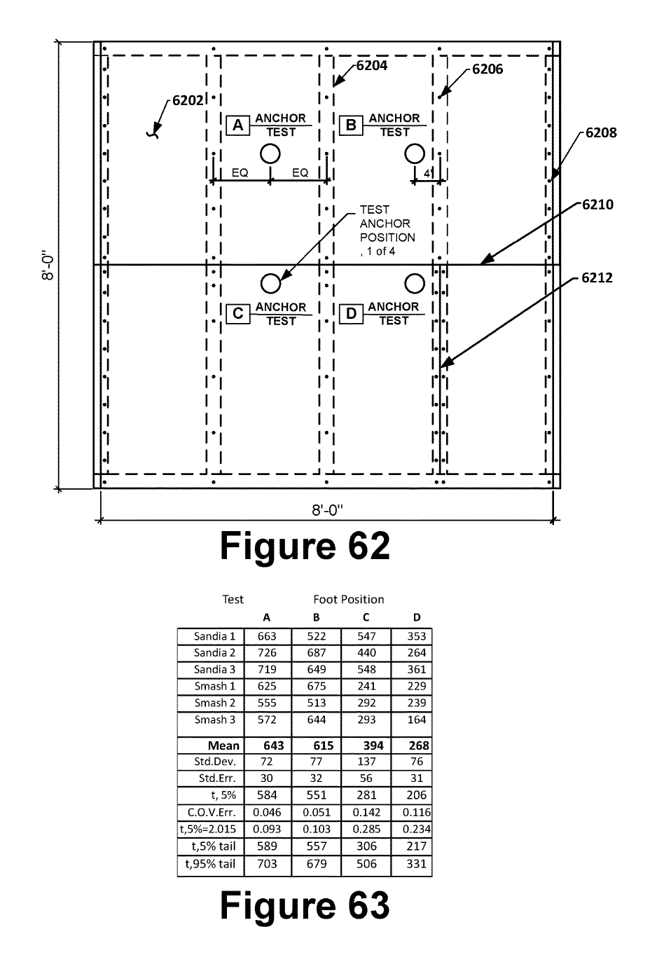

The following tests provide evidence that bands of strength exist in standard roof sheathing systems. Sheathing anchorage tests were conducted both at Smash Solar's test lab in Richmond, Calif., and independently by Sandia National Laboratory in Albuquerque, N. Mex. FIG. 62 shows the test beds built and tested by both labs.

In FIG. 62, we describe the test platforms used in the sheathing capacity study. We built test platforms 8′×8′ using code-compliant material listed below. The sheathing was attached in a manner consistent with a typical roof complying with current and historic code minima for roof nailing and sheathing.

The test beds had the following characteristics:
Rafters at 24 inches on center (6204)
15/32″ oriented strand board (OSB) sheathing (6202)
Unblocked sheathing with panel long edges perpendicular to rafters (6210)
8 d box nails (0.131″×2.50″)
Panel Edge Nailing: 8 d box nails (0.131″×2.50″) at 6″ on center (6208)
Field Nailing: 8 d box at 12″ on center (6206)
2×6 Douglas Fir rafters with a moisture content less than 19%.

We established four tested foot positions that are labeled A, B, C and D, and are located as shown in FIG. 62 and described as follows:
Position A=midway between long edge of panel and midway between rafters,
Position B=midway between long edge of panel and 4″ from center of nearest rafter,
Position C=4″ from long edge of panel and midway between rafters,
Position D=4″ from long edge of panel and 4″ from short edge of panel.

To ensure that sheathing nails-to-rafter withdrawal always occurred before the feet sheathing anchors pulled through the sheathing, the feet were anchored with two sheathing anchors.

The feet were pulled upward by a DMD force measurement system that stood on a stiff timber bridge that spanned over the test beds. Per ASTM D7147-11, ICC AC-13 and IAPMO ES-2, feet were pulled up at a load deformation rate of 0.10 inches per minute. Because the DMD tester's ¾″ threaded rod puller has ten threads per inch, a deformation rate of 0.10 inches per minute corresponds to one revolution per minute. Load-deformation curves were recorded.

### Test Results

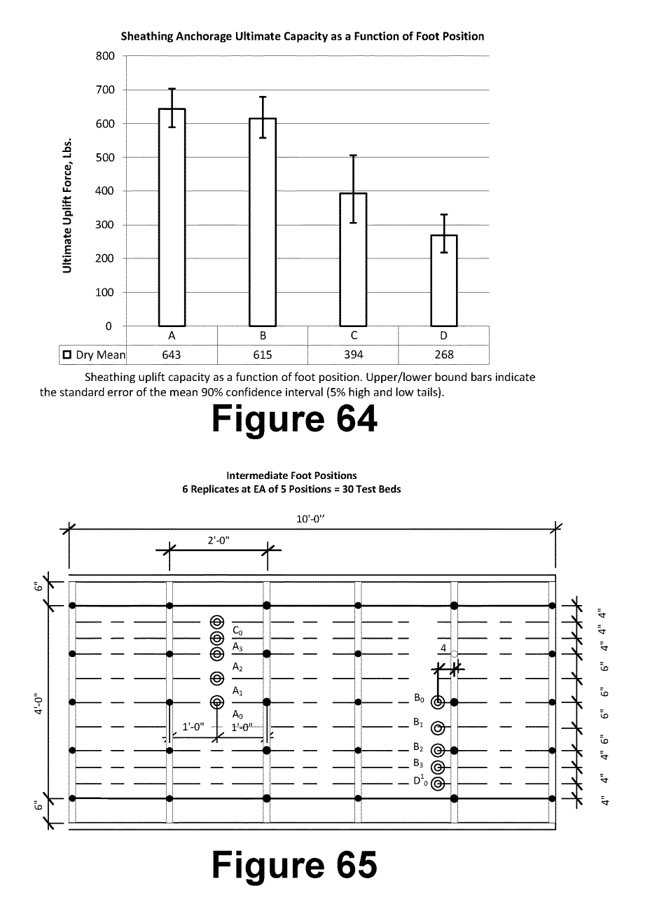

The average ultimate uplift capacity is shown in FIG. 63 and FIG. 64. The results shown are the average of three Smash Solar lab tests and three Sandia National Laboratory lab tests (six total). As expected, Position A, midway between long edges and midway between rafters, is the strongest position, while Position D, at the panel corner, is weakest. Position A is more than twice as strong as Position D.

The embodiments proposed are designed to ensure that feet are located only in Positions A and B, not in Positions C or D. The reliable ultimate capacity is therefore defined by Position B (615 lbs). Some embodiments could be subject to wind and other loads that create demand of approximately 150 to 200 lbs per sheathing anchor. So the positions A and B have sufficient capacity to resist loads encountered by the embodiments presented.

### Intermediate Positions

Smash Solar has also conducted in-house tests of intermediate positions. The results show that anchor capacity is high and constant along a “band of sheathing strength” at least 12″ wide centered along the panel's long midline.

FIG. 65: Test protocol to determine the uplift load capacity of intermediate foot positions.

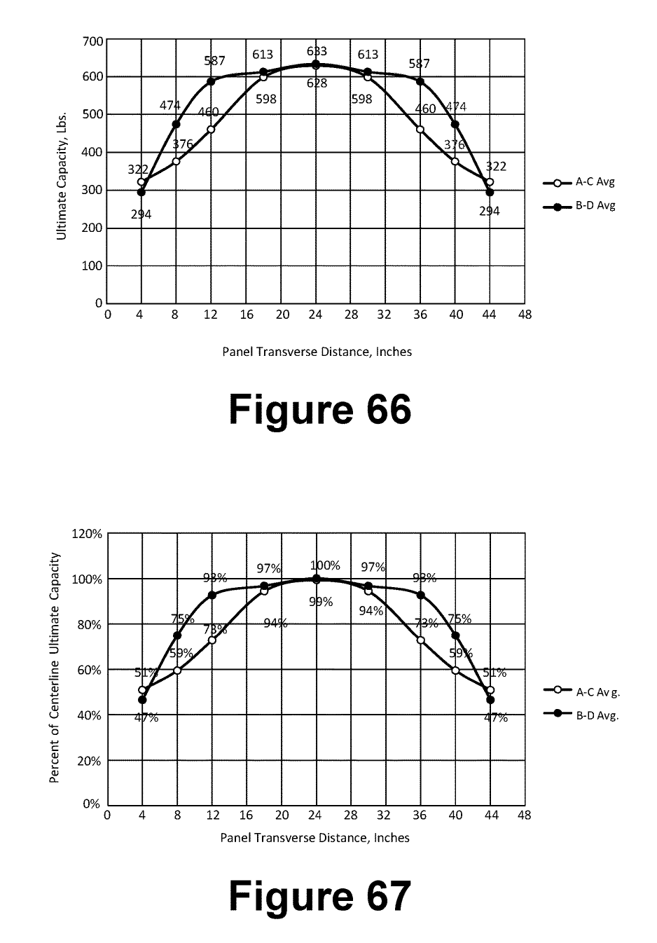

FIG. 66: Ultimate uplift capacity of foot as a function of position along the panel's transverse axis. The center and edge positions are the average of 9 replicates (6 at Smash Solar's in-house lab, 3 at Sandia National Laboratory) while the intermediate positions are the average of 3 replicates conducted at Smash Solar's in-house lab.

FIG. 67: Percentage of ultimate centerline uplift capacity of foot as a function of position along the panel's transverse axis, which can also be considered as a reduction factor as a function of foot position.

### Example Embodiments of Track and Feet

When installing solar modules that are preassembled with mounting system in accordance with certain embodiments, one may have a means to quickly attach and adjust feet that bridge from the module down to the roof. The coupling of feet to a module can happen anywhere along the length of a solar module. So, therefore adjustability is an advantageous characteristic of certain embodiments. In addition, various embodiments of adjustably-coupled mounting feet are provided that are configured to secure to sheathing strong points, the bands of structural strength running along the centerline of plywood sheathing, OSB sheathing and other forms of sheathing, typically installed in landscape orientation or horizontal to the roof slope.

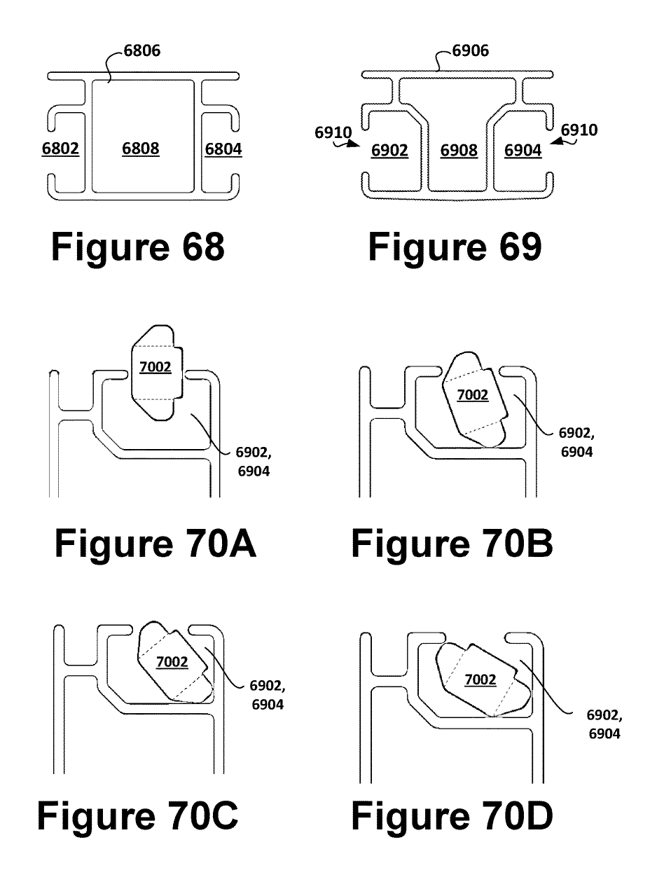

A track is pre-assembled on the module (in multiple embodiments) to both support the solar module and to provide a means of connecting feet with sheathing anchors. In FIG. 68, a track is shown with two channels (6802, 6804) identically dimensioned for easy manufacturing, one on each side of the track. The channels once assembled with the solar module may be orientated as one interior (6802) and one exterior (6804). In addition to the channels, the track has a flat bonding plate (6806) to act as a plate for appropriate adhesive or bonding materials to be affixed to the track. Finally, the track has an internal structural tube (6808) to provide mechanical capacity to resist mechanical loads on the system. This embodiment of the channels (6802, 6804) are designed to engage with multiple fasteners including standard hex bolt fasteners and T-bolt fasteners to connect snap connectors, feet and other accessories using the channels (6802, 6804) as a point of connection.

In another embodiment (FIG. 69), a track is shown with two channels (6902, 6904) as in FIG. 68, with similar utility and features as other embodiments. These features include a flat bonding plate (6906) to act as a plate for appropriate adhesive or bonding materials to be affixed to the track. Finally, the track has an internal structural tube (6908) to provide mechanical capacity to resist mechanical loads on the system. This embodiment of the channels (6902, 6904) is designed with a feature (6010) that aligns with threaded fasteners or threaded plates. In this FIG. 69 embodiment, the fasteners engage with the channels through the inserting of one or more threaded nuts instead of inserting t-bolts or other bolt fasteners. These fasteners would, in turn, connect snap connectors, feet and other accessories to the tracks using the channels (6902, 6904) as a point of connection.

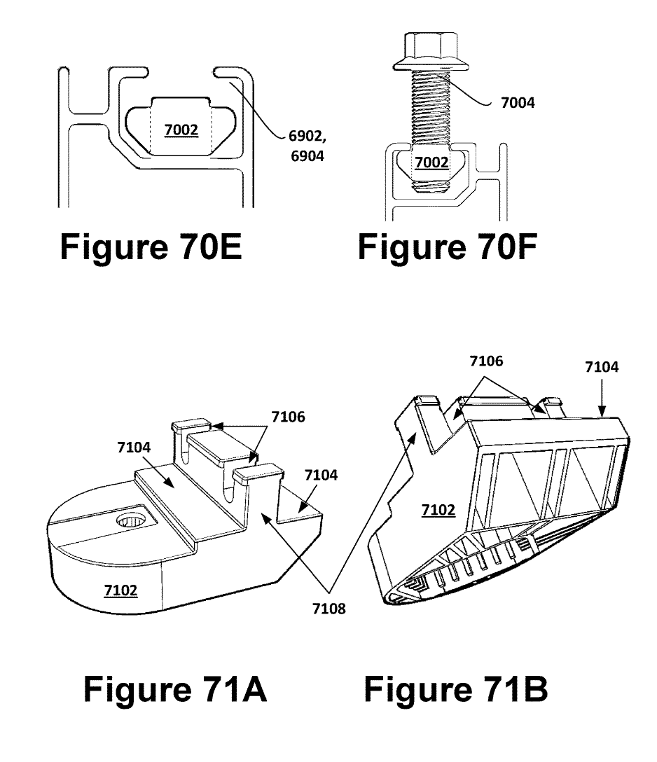

In FIG. 70, we see the method described above in which internally-threaded plates (7002) of the geometry shown are inserted into the channels (6902, 6904) and then a standard fastener (7004) is threaded onto the threaded plate. In each step, the threaded plate (7002), goes through the steps of insertion. First step (FIG. 70A), the threaded plate (7002) inserts into the channel (6902, 6904) perpendicular to the centerline of its threading. Next (FIG. 70B) the threaded plate (7002), rotates such that the channel feature (6910) will align with the matching face on the threaded plate (7002). The threaded plate (7002) continues to rotate in FIGS. 70C, 70D and 70E until it is aligned with the channel feature (6910). In FIG. 70F, the hex bolt or similar threaded anchor is inserted and rotated in the threaded plate (7002) to fix various accessories, feet and connectors to the Track.

In FIGS. 71A and 71B, we see one embodiment shown of a foot (7102) that attaches to the Track using the anchoring method described in FIGS. 69 and 70. In FIG. 71 A, the foot (7102) is shown from the top displaying the track bearing plates (7104) and the bolt slots (7106) and clamping wall (7108). FIG. 71B shows the foot (7102) from the bottom including the bolt slots (7106) and supports for the track bearing plates (7104).

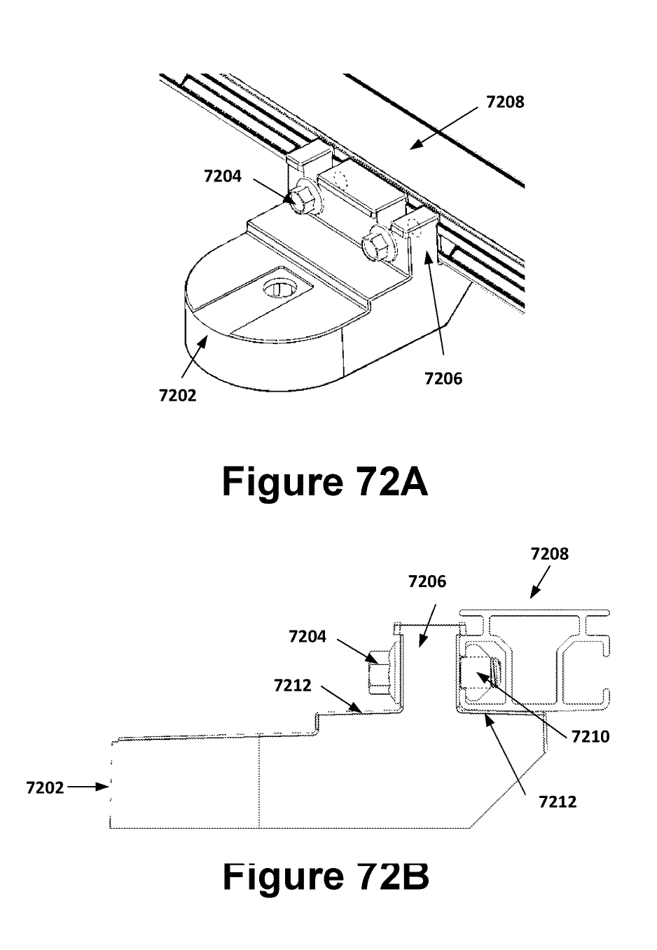

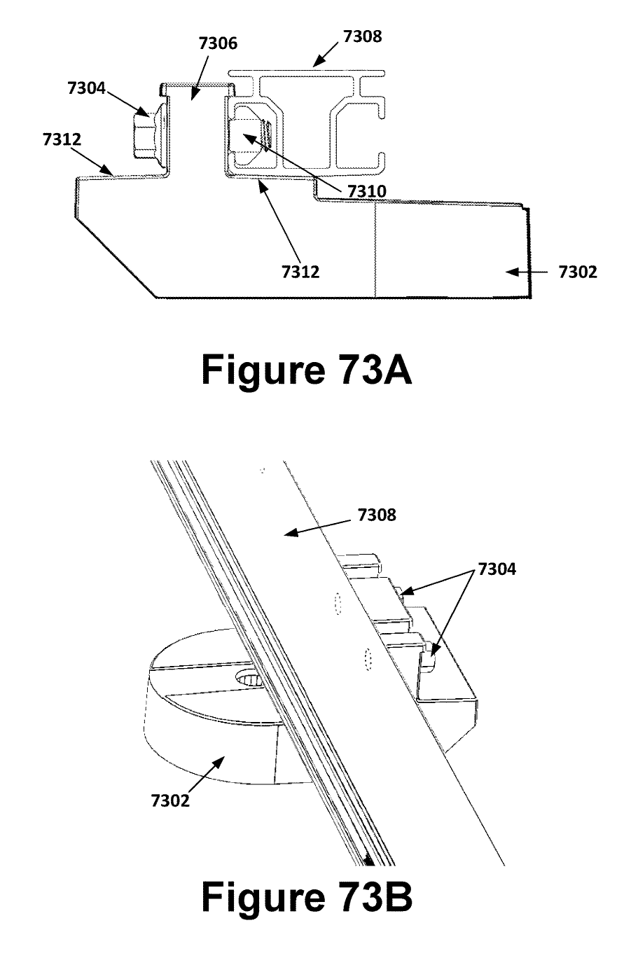

In FIG. 72A, the foot (7202) is shown attached in preassembly with the track (7208) in isometric view using two bolts (7204) through the clamping wall (7206). In FIG. 72 B, we see the foot (7202) in side view with a section of the track (7208). In addition, we see a side view of the clamping wall (7206) and bolts (7204) and threaded plate (7210) in the channel of the Track (7208). The track (7208) is laying on the one of the track bearing plates (7212), while the other (7212) remains empty—but will be used in the case the foot is selected to be reversed. In FIG. 72 B the foot (7202) is orientated in the standard configuration—out away from the track (7208) and the solar module above (not shown).

In FIG. 73A, we see the foot (7302) in side view with a section of the track (7308). In addition, we see a side view of the clamping wall (7306) and bolts (7304) and threaded plate (7310) in the channel of the Track (7308). The track (7308) is laying on the one of the track bearing plates (7312). In FIG. 73A, the foot (7302) is orientated in the reverse configuration under the track (7308) and the solar module above (not shown). The reverse configuration is used by installers of this system when they want the sheathing anchor to avoid hitting structural members such as rafters or joists that lie below the sheathing. In FIG. 73B, the foot (7302) is shown attached in reversed preassembly with the track (7308) in isometric view using two bolts (7304) through the clamping wall (7206).

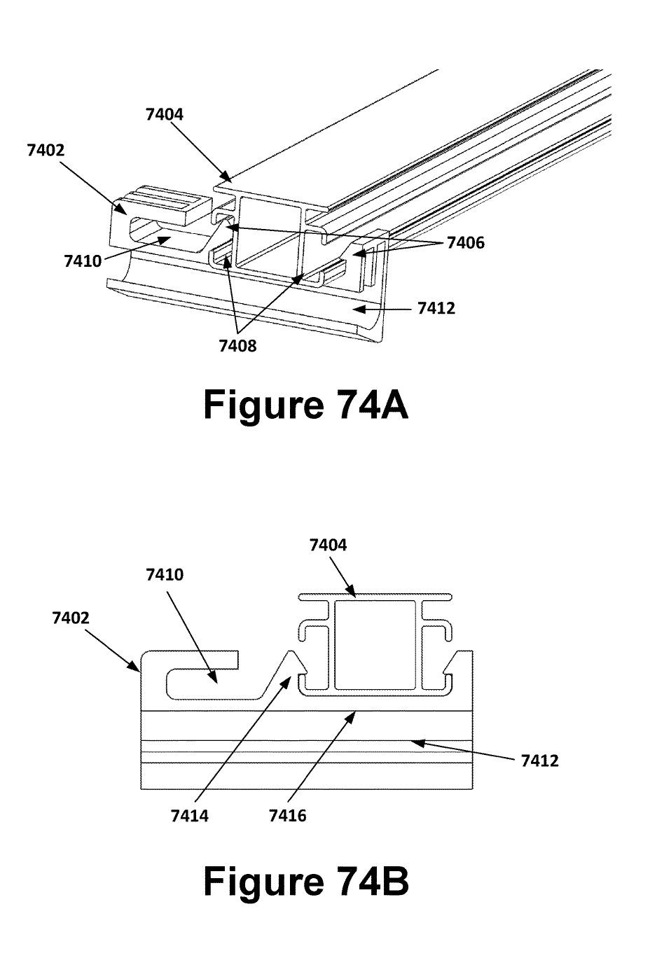

In FIG. 74A, we see an embodiment of a wire clip (7402) attached in preassembly to the track (7404). The wire clip (7402) attaches to the track (7404) by inserting clip members (7406) into each channel (7408). The wire clip offers flexibility in wire management through a parallel to track wire clamp (7410) and a perpendicular to track wire clamp (7412). This allows installers to use a single wire clip (7402) attached in preassembly with the Track (7404) for both wire running parallel and perpendicular to the Track (7404). The wire clip is specially designed to keep the wires off the track (7412) in order to maintain keep non-conducting components like the track (7404) from getting energized.

In FIG. 74B, we see an embodiment of a wire clip (7402) in a side view in preassembly with a track (7404) in cross section. The wire clip (7402) connects with channels of the Track (7404) as shown. This embodiment of wire clip has two special features: first the wire clip can hold wires running either parallel or perpendicular to the track. Second, the wire clamp is specially designed to keep the wires from touching the track in order to keep non-conducting components like the track (7404) from getting energized. This embodiment of a wire clip prevents wires from touching adjacent metal components by creating a physical barrier in the clip itself. To prevent wires running parallel to the track from touching the track, a parallel barrier (7414) exists along the track (7404) and a perpendicular barrier (7416) exists under the track (7404).

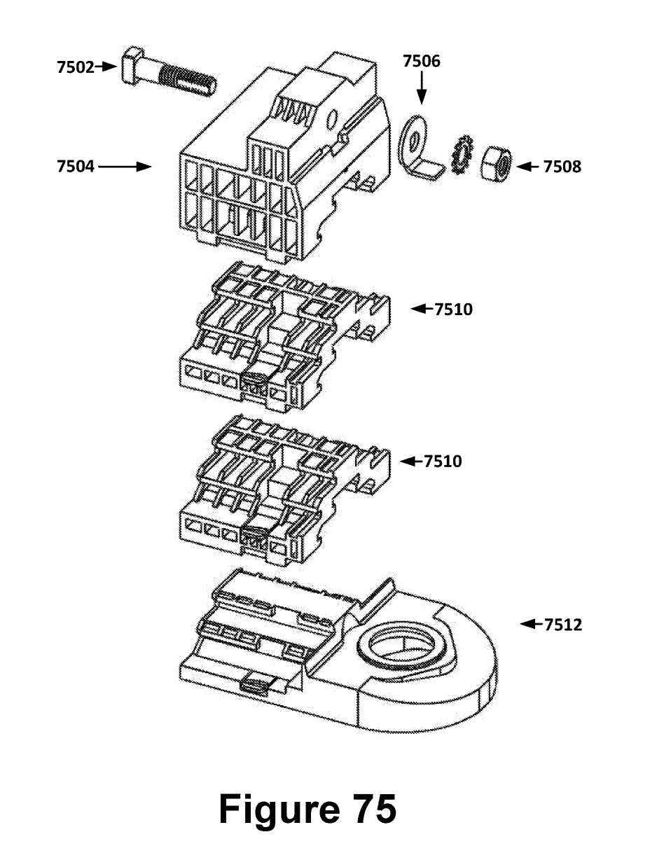

In one set of embodiments, feet that attach to a track are an assembly of multiple parts, as shown in FIG. 75. These parts aid in the anchoring and adjusting of the foot to the track and in the adjusting the foot base height in the case of an uneven roof or sheathing surface.

This foot assembly can be anchored to a track by inserting a single T-bolt (7502) into the track clamp (7504), pushing it into the track channel (not shown here) and securing with a nut and lock washer (7508). A T-bolt 7502 in accordance with certain embodiments is configured such that a user may rotate the T-bolt (7502) so that it will properly insert into the channel in the Track (not shown). The bolt handle (7506) allows users the ability to rotate the T-bolt (7502). This is accomplished by creating a flat surface on the T-bolt threads and punching the bolt handle (7506) with a hole shaped to fit securely around that bolt profile.

The track clamp (7504) can be assembled via a snap mechanism directly with the track clamp base (7512) or can have one or more inserts (7510) placed between the track clamp (7504) and track clamp base (7512) to raise the height of the foot. The track clamp base (7512) is then anchored to the sheathing using the appropriate sheathing anchors (not shown).

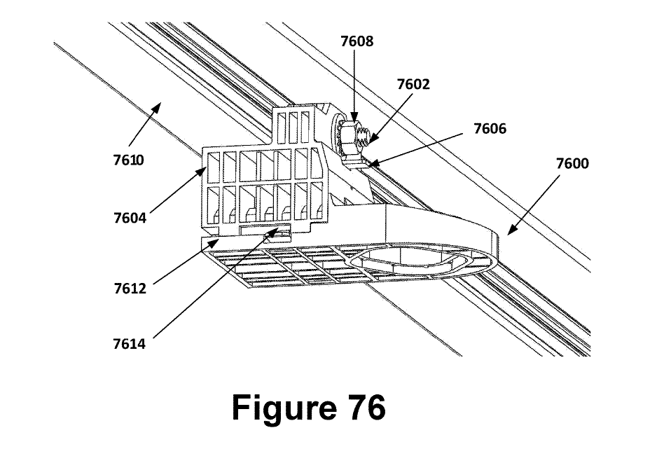

In FIG. 76, we see this embodiment's view from the bottom in isometric. In this embodiment, we see the foot assembly anchored to a track (7610) with a single T-bolt (7602) using a locknut and washer (7608) and a bolt handle (7606) that rotated the T-bolt (7602) into place during assembly. You can see the flat surface on the T-bolt threads (7602) that helps engage the bolt handle (7606) with a hole shaped to fit securely around that bolt profile.

In this embodiment, the track clamp (7604) is assembled via a snap mechanism (7614) directly with the track clamp base (7612) which is then anchored to the roof sheathing using the appropriate sheathing anchors (not shown).

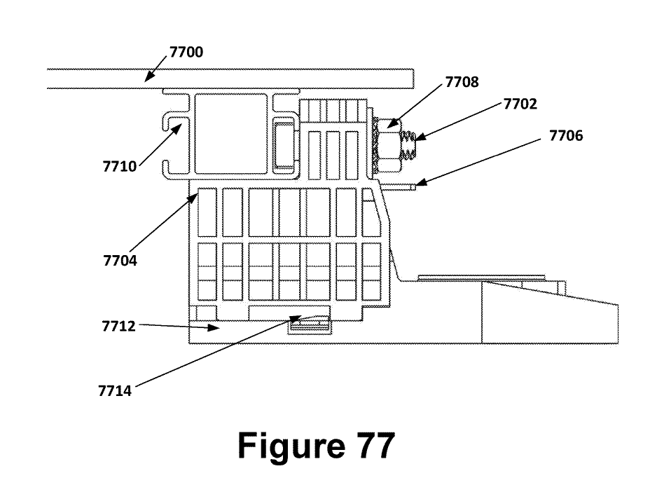

In FIG. 77, we see this embodiment's view of a foot in a basic side view. In this embodiment, we see the foot assembly anchored to a track with a single T-bolt (7702) using a locknut and washer (7708) and a bolt handle (7706) that rotated the T-bolt (7702) into place during assembly. You can see the flat surface cut into the threads on the T-bolt (7702) that helps engage the bolt handle (7706) with a hole shaped to fit securely around that bolt profile.

In this embodiment, the track clamp (7704) is assembled via a snap mechanism (7714) directly with the track clamp base (7712) which is then anchored to the roof sheathing using the appropriate sheathing anchors (not shown). The track clamp base (7712) is orientated in the standard configuration—out away from the track (7710) and the solar module above (7700).

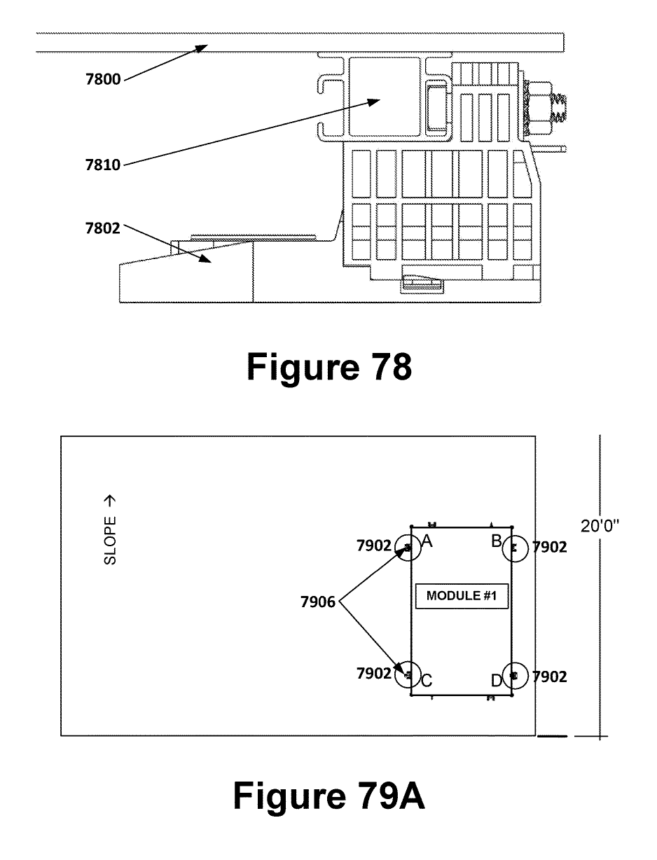

In FIG. 78, we see the same embodiments as described in FIG. 77 and FIG. 76 shown in a basic side view. In FIG. 78, the track clamp base (7802) is orientated in the reverse configuration under the track (7810) and the solar module above (7800). Note: the track clamp (78xx) remains in the same orientation as the standard. The reverse configuration is used by installers of this system when they want the sheathing anchor to avoid hitting structural members such as rafters or joists that lie below the sheathing.

In some embodiments, the installer will want to attach their sheathing anchors in the bands of sheathing strength that the inventors have discovered through comprehensive research in the area of sheathing capacity and reliability. In order to reliably attach the feet to the track on the ground (before installers lift the modules to the roof), we have a two-step method incorporating Step 1 approximating feet locations on the ground and Step 2 adjusting feet locations on the roof.

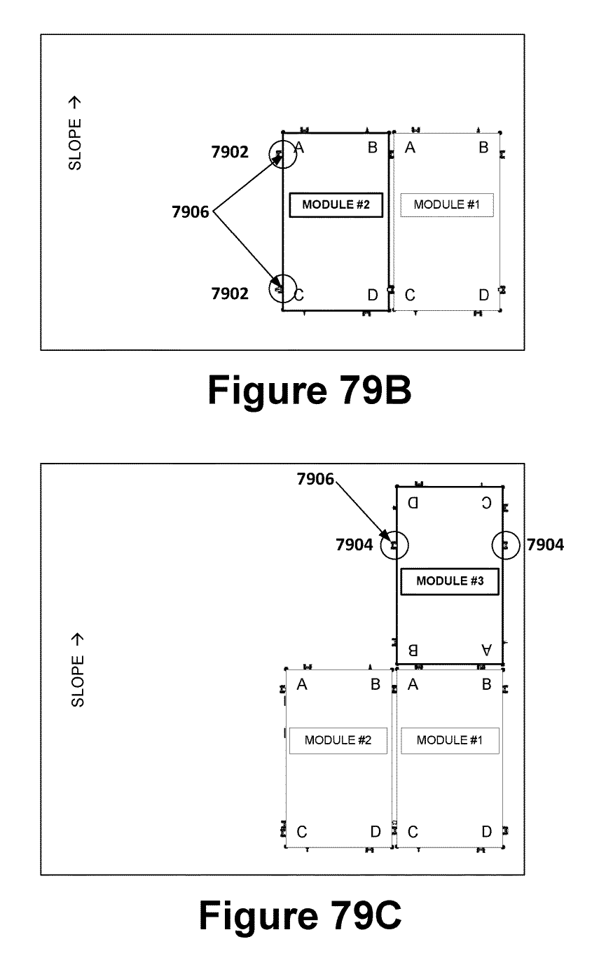

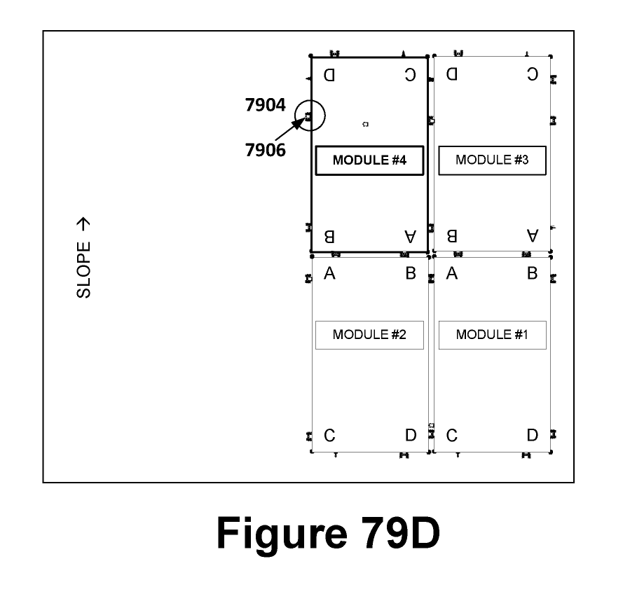

A method of approximating foot locations in accordance with certain embodiments includes identifying the zones to which mounting feet may be anchored to the module track. FIGS. 79A, 79B, 79C and 79D show one embodiment of this method. In FIGS. 79A and 79B, installers will identify zone A (7902) to locate and attach feet (7906) to the track for the first row of the installation. In FIGS. 79C and 79D, installers will identify zone B (7904) to locate and attach feet (7906) to the track for the second row of modules.

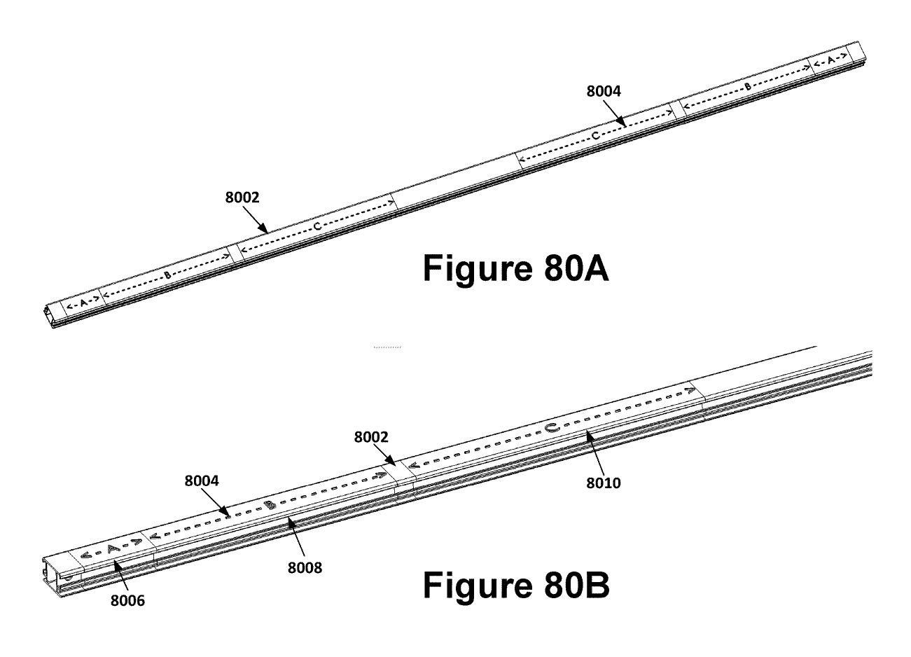

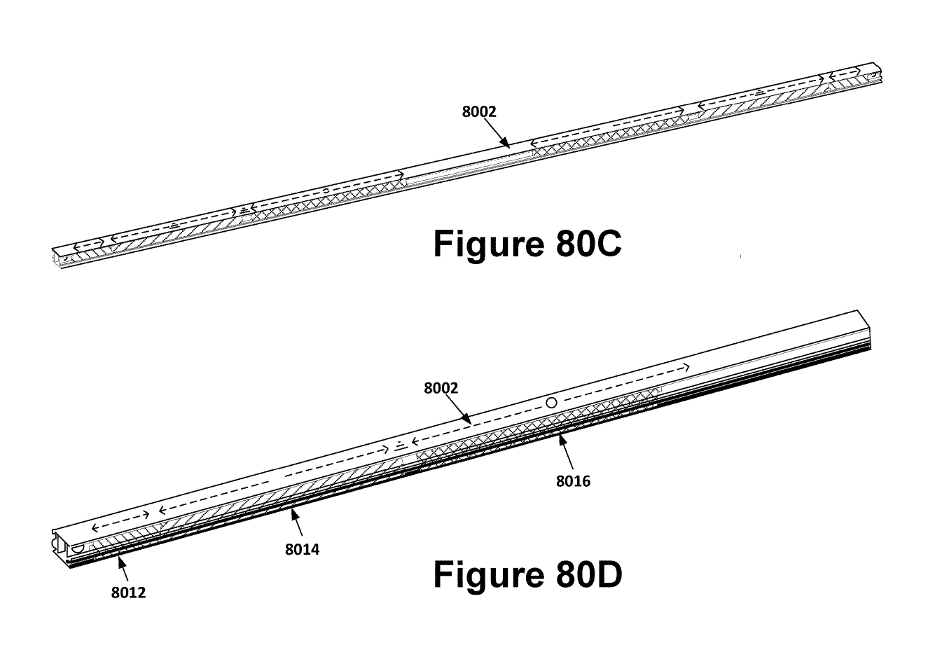

In the embodiments shown in FIGS. 80A and 80B, we define visual cues (8004) using lettering and raised marks on the track (8002) to identify the foot attachment zones. In FIG. 80B, we see Zone A (8006), Zone B (8008) and Zone C (8010) all marked on the track (8002). In the embodiments shown in FIGS. 80 C and 80 D, we define visual cues (8008) using colors either painted on or in colors marked in the one or more channels in the track (8002) to identify the foot attachment zones. In FIG. 80 D, we see Zone A (8012), Zone B (8014) and Zone C (8016) all marked on the track (8002).

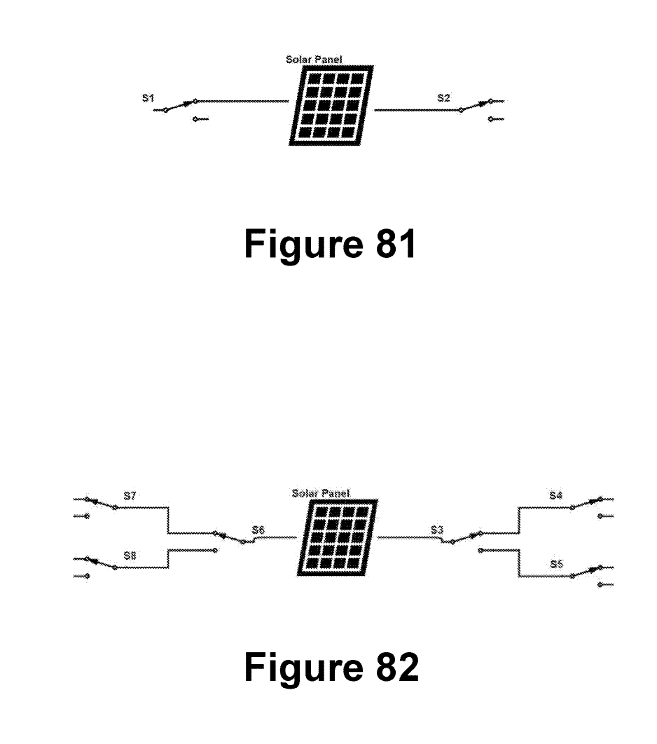

In FIG. 81, one embodiment of a modular DC wire connection routes the DC conductors to the preassembled snap connectors (S1, S2) on the module. These snap connectors S1, S2 may include an adjacent pair of coupled mounting brackets 7, 8 of FIGS. 21-24 in certain embodiments. The snap connectors S1, S2 may function as a switch in certain embodiments. When two solar panel modules are interconnected during installation, the switch will be closed.

In FIG. 82, another embodiment of a modular DC wire connection routes the DC conductors to a switch (either S6 or S3) which routes the circuit to one of the snap connectors S1, S2, including, e.g., coupled mounting brackets 7, 8 of FIGS. 21-24, on the long side of the module (S7 or S4) or the short side of the module (S8 or S5). The snap connectors S1, S2 may function as a switch in certain embodiments. When two solar panel modules are interconnected during installation, e.g., by snap coupling brackets 7, 8 of FIGS. 21-24, the switch will be closed.

Several solar panel modules may be coupled together in similar manner as the examples schematically illustrated at one or more of FIGS. 21-24 and 81-82. Electrical current generated by solar radiation impinging upon the solar panels of the solar panel modules array and being converted to electrical energy may be passed from module to module until a power storage component is reached or until a circuit for powering lights, appliances or other electronically powered equipment is reached or until an outside power line is reached for transmitting the electrical power to the grid.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Thus, for example, it will be appreciated by those of ordinary skill in the art that the diagrams, schematics, illustrations, and the such as represent conceptual views or processes illustrating systems and methods in accordance with particular embodiments. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

What is claimed is:

1. An integrated preassembled solar panel module, comprising
a solar panel configured for receiving and converting solar radiation to produce electrical power;
multiple integrated brackets coupled to the solar panel in preassembly and configured for coupling to brackets of adjacent solar panel modules of a solar module array;
at least one elongated track coupled to the solar panel;
multiple mounting feet adjustably coupled each to a selected location along the at least one track; and
one or more sheathing anchors configured for coupling said mounting feet each within one or more bands of sheathing strength each overlapping a centerline of roof sheathing length and not overlapping roof rafters.

2. The integrated preassembled solar panel module of claim 1, wherein said at least one track has a length that is more than half of a dimension of said solar panel such that said selected location is adjustable to be anywhere within an area more than half overlapping an area of said solar panel.

3. An integrated preassembled solar panel module as in any of the above claims, wherein said band of sheathing strength runs horizontally across the roof.

4. An integrated preassembled solar panel module as in any of the above claims, wherein said at least one track has an elongated cavity defined therein for bolting said multiple mounting feet each at said selected location along said at least one track.

5. An integrated preassembled solar panel module as in any of the above claims, wherein said at least one track has a pair of elongated cavities defined therein for bolting said multiple mounting feet each at said selected location along said at least one track and on a selected side of said track.

6. An integrated preassembled solar panel module as in any of the above claims, wherein said at least one track has an elongated cavity defined therein by a flexible material shaped for snap-coupling said multiple mounting feet each at a selected location along said at least one track.

7. An integrated preassembled solar panel module as in any of the above claims, wherein said band of sheathing strength is not more than 16″ wide.

8. An integrated preassembled solar panel module as in any of the above claims, wherein said band of sheathing is aligned with exposed courses of roof structure.

9. The integrated preassembled solar panel module of claim 8, wherein said exposed courses of roof structure comprise shingle courses.

10. An integrated preassembled solar panel module as in any of the above claims, wherein said one or more sheathing anchors each comprise a rotatably-attached, elongated washer for piercing said sheathing in a first position and rotating to a second position securing the sheathing anchor after said piercing of said sheathing.

11. An integrated preassembled solar panel module as in any of the above claims, wherein said one or more sheathing anchors are each configured to pierce said sheathing defining a sheathing cavity of first shape and to adjust to a second shape of increased size in at least one dimension for securing said sheathing anchor behind the sheathing material after said piercing.

12. An integrated preassembled solar panel module as in any of the above claims, wherein said solar panel comprises a frameless solar panel.

13. The integrated preassembled solar panel of claim 12, wherein said frameless solar panel is strengthened by said track being configured to stiffen said solar panel.

14. The integrated preassembled solar panel as in any of the above claims, comprising one or more fixed mounting feet coupled in preassembly to said solar panel, and wherein length or width dimensions or a shape of said solar panel, or combinations thereof, is/are selected to align said one or more fixed mounting feet with said bands of sheathing strength or locations of said roof rafters, or combinations thereof.

15. The integrated preassembled solar panel of claim 14, wherein said one or more fixed mounting feet are coupled in preassembly into one or more of said brackets.

16. An integrated preassembled solar panel module as in any of the above claims, wherein said track includes multiple zones of attachment for placement of said adjustably-coupled mounting feet in preassembly for further later adjustment.

17. An integrated preassembled solar panel module as in any of the above claims, wherein said adjustably-coupled mounting feet and said track are configured such that said adjustably-coupled mounting feet are attachable to said track in a standard or reverse orientation on said track, respectively, with the feet pointing away from the module or pointing toward the middle of the module.

18. A solar panel module array, comprising multiple integrated preassembled solar panel modules as in any of the above claims, wherein adjacent solar panel modules are coupled together bracket to bracket.

19. A method of installing a solar panel module array as in any of the above claims, comprising determining a location and dimension of each of said one or more bands, and coupling said mounting feet to locations along said at least one track to overlap said mounting feet with the one or more determined bands of sheathing strength.
